(19) United States
(12) Patent Application Publication
(10) Pub. No.: US 2005/0201715 A1
(43) Pub. Date: Sep. 15, 2005

(54) SYSTEM, METHOD, AND COMPUTER PROGRAM PRODUCT FOR MAGNETO-OPTIC DEVICE DISPLAY

(75) Inventor: Sutherland C. Ellwood JR., Clinton Corners, NY (US)

Correspondence Address: PANORAMA FLAT;C/O PATENT LAW OFFICES OF MICHAEL E. WOODS, 112 BARN ROAD, TIBURON, CA, 94920, US

(73) Assignee: Panorama FLAT Ltd., Perth (AU)

(21) Appl. No.: 10/906,304

(22) Filed: Feb. 14, 2005

Related U.S. Application Data
(63) Continuation-in-part of application No. 10/812,294, filed on Mar. 29, 2004.
(63) Continuation-in-part of application No. 10/811,782, filed on Mar. 29, 2004.
(63) Continuation-in-part of application No. 10/812,295, filed on Mar. 29, 2004.
(63) Continuation-in-part of application No. 11/011,761, filed on Dec. 14, 2004.
(63) Continuation-in-part of application No. 11/011,751, filed on Dec. 14, 2004.
(63) Continuation-in-part of application No. 11/011,496, filed on Dec. 14, 2004.
(63) Continuation-in-part of application No. 11/011,762, filed on Dec. 14, 2004.
(63) Continuation-in-part of application No. 11/011,770, filed on Dec. 14, 2004.
(63) Continuation-in-part of application No. 10/906,220, filed on Feb. 9, 2005.
(63) Continuation-in-part of application No. 10/906,221, filed on Feb. 9, 2005.
(63) Continuation-in-part of application No. 10/906,222, filed on Feb. 9, 2005.
(63) Continuation-in-part of application No. 10/906,223, filed on Feb. 9, 2005.
(63) Continuation-in-part of application No. 10/906,224, filed on Feb. 9, 2005.
(63) Continuation-in-part of application No. 10/906,225, filed on Feb. 9, 2005.
(63) Continuation-in-part of application No. 10/906,226, filed on Feb. 9, 2005.
(63) Continuation-in-part of application No. 10/906,255, filed on Feb. 11, 2005.
(63) Continuation-in-part of application No. 10/812,294, filed on Mar. 29, 2004.
(63) Continuation-in-part of application No. 10/811,782, filed on Mar. 29, 2004.
(63) Continuation-in-part of application No. 10/812,295, filed on Mar. 29, 2004.
(63) Continuation-in-part of application No. 11/011,761, filed on Dec. 14, 2004.
(63) Continuation-in-part of application No. 11/011,751, filed on Dec. 14, 2004.
(63) Continuation-in-part of application No. 11/011,496, filed on Dec. 14, 2004.
(63) Continuation-in-part of application No. 11/011,762, filed on Dec. 14, 2004.
(63) Continuation-in-part of application No. 11/011,770, filed on Dec. 14, 2004.
(63) Continuation-in-part of application No. 10/906,220, filed on Feb. 9, 2005.
(63) Continuation-in-part of application No. 10/906,221, filed on Feb. 9, 2005.
(63) Continuation-in-part of application No. 10/906,222, filed on Feb. 9, 2005.
(63) Continuation-in-part of application No. 10/906,223, filed on Feb. 9, 2005.
(63) Continuation-in-part of application No. 10/906,224, filed on Feb. 9, 2005.
(63) Continuation-in-part of application No. 10/906,225, filed on Feb. 9, 2005.
(63) Continuation-in-part of application No. 10/906,226, filed on Feb. 9, 2005.
(63) Continuation-in-part of application No. 10/906,256, filed on Feb. 11, 2005.
(63) Continuation-in-part of application No. 10/812,294, filed on Mar. 29, 2004.
(63) Continuation-in-part of application No. 10/811,782, filed on Mar. 29, 2004.
(63) Continuation-in-part of application No. 10/812,295, filed on Mar. 29, 2004.
(63) Continuation-in-part of application No. 11/011,761, filed on Dec. 14, 2004.
(63) Continuation-in-part of application No. 11/011,751, filed on Dec. 14, 2004.
(63) Continuation-in-part of application No. 11/011,496, filed on Dec. 14, 2004.
(63) Continuation-in-part of application No. 11/011,762, filed on Dec. 14, 2004.
(63) Continuation-in-part of application No. 11/011,770, filed on Dec. 14, 2004.
(63) Continuation-in-part of application No. 10/906,220, filed on Feb. 9, 2005.
(63) Continuation-in-part of application No. 10/906,221, filed on Feb. 9, 2005.
(63) Continuation-in-part of application No. 10/906,222, filed on Feb. 9, 2005.
(63) Continuation-in-part of application No. 10/906,223, filed on Feb. 9, 2005.
(63) Continuation-in-part of application No. 10/906,224, filed on Feb. 9, 2005.
(63) Continuation-in-part of application No. 10/906,225, filed on Feb. 9, 2005.
(63) Continuation-in-part of application No. 10/906,226, filed on Feb. 9, 2005.
(63) Continuation-in-part of application No. 10/906,257, filed on Feb. 11, 2005.
(63) Continuation-in-part of application No. 10/812,294, filed on Mar. 29, 2004.
(63) Continuation-in-part of application No. 10/811,782, filed on Mar. 29, 2004.
(63) Continuation-in-part of application No. 10/812,295, filed on Mar. 29, 2004.
(63) Continuation-in-part of application No. 11/011,761, filed on Dec. 14, 2004.
(63) Continuation-in-part of application No. 11/011,751, filed on Dec. 14, 2004.
(63) Continuation-in-part of application No. 11/011,496, filed on Dec. 14, 2004.
(63) Continuation-in-part of application No. 11/011,762, filed on Dec. 14, 2004.
(63) Continuation-in-part of application No. 11/011,770, filed on Dec. 14, 2004.
(63) Continuation-in-part of application No. 10/906,220, filed on Feb. 9, 2005.
(63) Continuation-in-part of application No. 10/906,221, filed on Feb. 9, 2005.
(63) Continuation-in-part of application No. 10/906,222, filed on Feb. 9, 2005.
(63) Continuation-in-part of application No. 10/906,223, filed on Feb. 9, 2005.
(63) Continuation-in-part of application No. 10/906,224, filed on Feb. 9, 2005.
(63) Continuation-in-part of application No. 10/906,225, filed on Feb. 9, 2005.
(63) Continuation-in-part of application No. 10/906,226, filed on Feb. 9, 2005.
(63) Continuation-in-part of application No. 10/906,258, filed on Feb. 11, 2005.
(63) Continuation-in-part of application No. 10/812,294, filed on Mar. 29, 2004.
(63) Continuation-in-part of application No. 10/811,782, filed on Mar. 29, 2004.
(63) Continuation-in-part of application No. 10/812,295, filed on Mar. 29, 2004.
(63) Continuation-in-part of application No. 11/011,761, filed on Dec. 14, 2004.
(63) Continuation-in-part of application No. 11/011,751, filed on Dec. 14, 2004.
(63) Continuation-in-part of application No. 11/011,496, filed on Dec. 14, 2004.
(63) Continuation-in-part of application No. 11/011,762, filed on Dec. 14, 2004.
(63) Continuation-in-part of application No. 11/011,770, filed on Dec. 14, 2004.
(63) Continuation-in-part of application No. 10/906,220, filed on Feb. 9, 2005.
(63) Continuation-in-part of application No. 10/906,221, filed on Feb. 9, 2005.
(63) Continuation-in-part of application No. 10/906,222, filed on Feb. 9, 2005.
(63) Continuation-in-part of application No. 10/906,223, filed on Feb. 9, 2005.
(63) Continuation-in-part of application No. 10/906,224, filed on Feb. 9, 2005.
(63) Continuation-in-part of application No. 10/906,225, filed on Feb. 9, 2005.
(63) Continuation-in-part of application No. 10/906,226, filed on Feb. 9, 2005.
(63) Continuation-in-part of application No. 10/906,259, filed on Feb. 11, 2005.
(63) Continuation-in-part of application No. 10/812,294, filed on Mar. 29, 2004.
(63) Continuation-in-part of application No. 10/811,782, filed on Mar. 29, 2004.
(63) Continuation-in-part of application No. 10/812,295, filed on Mar. 29, 2004.
(63) Continuation-in-part of application No. 11/011,761, filed on Dec. 14, 2004.
(63) Continuation-in-part of application No. 11/011,751, filed on Dec. 14, 2004.
(63) Continuation-in-part of application No. 11/011,496, filed on Dec. 14, 2004.
(63) Continuation-in-part of application No. 11/011,762, filed on Dec. 14, 2004.
(63) Continuation-in-part of application No. 11/011,770, filed on Dec. 14, 2004.
(63) Continuation-in-part of application No. 10/906,220, filed on Feb. 9, 2005.
(63) Continuation-in-part of application No. 10/906,221, filed on Feb. 9, 2005.
(63) Continuation-in-part of application No. 10/906,222, filed on Feb. 9, 2005.
(63) Continuation-in-part of application No. 10/906,223, filed on Feb. 9, 2005.
(63) Continuation-in-part of application No. 10/906,224, filed on Feb. 9, 2005.
(63) Continuation-in-part of application No. 10/906,225, filed on Feb. 9, 2005.
(63) Continuation-in-part of application No. 10/906,226, filed on Feb. 9, 2005.
(63) Continuation-in-part of application No. 10/906,260, filed on Feb. 11, 2005.
(63) Continuation-in-part of application No. 10/812,294, filed on Mar. 29, 2004.
(63) Continuation-in-part of application No. 10/811,782, filed on Mar. 29, 2004.
(63) Continuation-in-part of application No. 10/812,295, filed on Mar. 29, 2004.
(63) Continuation-in-part of application No. 11/011,761, filed on Dec. 14, 2004.
(63) Continuation-in-part of application No. 11/011,751, filed on Dec. 14, 2004.
(63) Continuation-in-part of application No. 11/011,496, filed on Dec. 14, 2004.
(63) Continuation-in-part of application No. 11/011,762, filed on Dec. 14, 2004.
(63) Continuation-in-part of application No. 11/011,770, filed on Dec. 14, 2004.
(63) Continuation-in-part of application No. 10/906,220, filed on Feb. 9, 2005.
(63) Continuation-in-part of application No. 10/906,221, filed on Feb. 9, 2005.
(63) Continuation-in-part of application No. 10/906,222, filed on Feb. 9, 2005.
(63) Continuation-in-part of application No. 10/906,223, filed on Feb. 9, 2005.
(63) Continuation-in-part of application No. 10/906,224, filed on Feb. 9, 2005.
(63) Continuation-in-part of application No. 10/906,225, filed on Feb. 9, 2005.
(63) Continuation-in-part of application No. 10/906,226, filed on Feb. 9, 2005.
(63) Continuation-in-part of application No. 10/906,262, filed on Feb. 11, 2005.
(63) Continuation-in-part of application No. 10/812,294, filed on Mar. 29, 2004.
(63) Continuation-in-part of application No. 10/811,782, filed on Mar. 29, 2004.
(63) Continuation-in-part of application No. 10/812,295, filed on Mar. 29, 2004.
(63) Continuation-in-part of application No. 11/011,761, filed on Dec. 14, 2004.
(63) Continuation-in-part of application No. 11/011,751, filed on Dec. 14, 2004.
(63) Continuation-in-part of application No. 11/011,496, filed on Dec. 14, 2004.
(63) Continuation-in-part of application No. 11/011,762, filed on Dec. 14, 2004.
(63) Continuation-in-part of application No. 11/011,770, filed on Dec. 14, 2004.
(63) Continuation-in-part of application No. 10/906,220, filed on Feb. 9, 2005.
(63) Continuation-in-part of application No. 10/906,221, filed on Feb. 9, 2005.
(63) Continuation-in-part of application No. 10/906,222, filed on Feb. 9, 2005.
(63) Continuation-in-part of application No. 10/906,223, filed on Feb. 9, 2005.
(63) Continuation-in-part of application No. 10/906,224, filed on Feb. 9, 2005.
(63) Continuation-in-part of application No. 10/906,225, filed on Feb. 9, 2005.
(63) Continuation-in-part of application No. 10/906,226, filed on Feb. 9, 2005.
(63) Continuation-in-part of application No. 10/906,261, filed on Feb. 11, 2005.
(63) Continuation-in-part of application No. 10/812,294, filed on Mar. 29, 2004.
(63) Continuation-in-part of application No. 10/811,782, filed on Mar. 29, 2004.
(63) Continuation-in-part of application No. 10/812,295, filed on Mar. 29, 2004.
(63) Continuation-in-part of application No. 11/011,761, filed on Dec. 14, 2004.
(63) Continuation-in-part of application No. 11/011,751, filed on Dec. 14, 2004.
(63) Continuation-in-part of application No. 11/011,496, filed on Dec. 14, 2004.
(63) Continuation-in-part of application No. 11/011,762, filed on Dec. 14, 2004.
(63) Continuation-in-part of application No. 11/011,770, filed on Dec. 14, 2004.
(63) Continuation-in-part of application No. 10/906,220, filed on Feb. 9, 2005.
(63) Continuation-in-part of application No. 10/906,221, filed on Feb. 9, 2005.
(63) Continuation-in-part of application No. 10/906,222, filed on Feb. 9, 2005.
(63) Continuation-in-part of application No. 10/906,223, filed on Feb. 9, 2005.
(63) Continuation-in-part of application No. 10/906,224, filed on Feb. 9, 2005.
(63) Continuation-in-part of application No. 10/906,225, filed on Feb. 9, 2005.
(63) Continuation-in-part of application No. 10/906,226, filed on Feb. 9, 2005.
(63) Continuation-in-part of application No. 10/906,263, filed on Feb. 11, 2005.
(63) Continuation-in-part of application No. 10/812,294, filed on Mar. 29, 2004.
(63) Continuation-in-part of application No. 10/811,782, filed on Mar. 29, 2004.
(63) Continuation-in-part of application No. 10/812,295, filed on Mar. 29, 2004.
(63) Continuation-in-part of application No. 11/011,761, filed on Dec. 14, 2004.
(63) Continuation-in-part of application No. 11/011,751, filed on Dec. 14, 2004.
(63) Continuation-in-part of application No. 11/011,496, filed on Dec. 14, 2004.
(63) Continuation-in-part of application No. 11/011,762, filed on Dec. 14, 2004.
(63) Continuation-in-part of application No. 11/011,770, filed on Dec. 14, 2004.
(63) Continuation-in-part of application No. 10/906,220, filed on Feb. 9, 2005.
(63) Continuation-in-part of application No. 10/812,294, filed on Mar. 29, 2004.
(63) Continuation-in-part of application No. 10/811,782, filed on Mar. 29, 2004.
(63) Continuation-in-part of application No. 10/812,295, filed on Mar. 29, 2004.
(63) Continuation-in-part of application No. 11/011,761, filed on Dec. 14, 2004.
(63) Continuation-in-part of application No. 11/011,751, filed on Dec. 14, 2004.
(63) Continuation-in-part of application No. 11/011,496, filed on Dec. 14, 2004.
(63) Continuation-in-part of application No. 11/011,762, filed on Dec. 14, 2004.
(63) Continuation-in-part of application No. 11/011,770, filed on Dec. 14, 2004.
Application No. 10/906,263 is a continuation-in-part of application No. 10/906,221, filed on Feb. 9, 2005.
Application No. 10/906,263 is a continuation-in-part of application No. 10/812,294, filed on Mar. 29, 2004.
Application No. 10/906,263 is a continuation-in-part of application No. 10/811,782, filed on Mar. 29, 2004.
Application No. 10/906,263 is a continuation-in-part of application No. 10/812,295, filed on Mar. 29, 2004.
Application No. 10/906,263 is a continuation-in-part of application No. 11/011,761, filed on Dec. 14, 2004.
Application No. 10/906,263 is a continuation-in-part of application No. 11/011,751, filed on Dec. 14, 2004.
Application No. 10/906,263 is a continuation-in-part of application No. 11/011,496, filed on Dec. 14, 2004.
Application No. 10/906,263 is a continuation-in-part of application No. 11/011,762, filed on Dec. 14, 2004.
Application No. 10/906,263 is a continuation-in-part of application No. 11/011,770, filed on Dec. 14, 2004.
Application No. 10/906,263 is a continuation-in-part of application No. 10/906,222, filed on Feb. 9, 2005.
Application No. 10/906,263 is a continuation-in-part of application No. 10/812,294, filed on Mar. 29, 2004.
Application No. 10/906,263 is a continuation-in-part of application No. 10/811,782, filed on Mar. 29, 2004.
Application No. 10/906,263 is a continuation-in-part of application No. 10/812,295, filed on Mar. 29, 2004.
Application No. 10/906,263 is a continuation-in-part of application No. 11/011,761, filed on Dec. 14, 2004.
Application No. 10/906,263 is a continuation-in-part of application No. 11/011,751, filed on Dec. 14, 2004.
Application No. 10/906,263 is a continuation-in-part of application No. 11/011,496, filed on Dec. 14, 2004.
Application No. 10/906,263 is a continuation-in-part of application No. 11/011,762, filed on Dec. 14, 2004.
Application No. 10/906,263 is a continuation-in-part of application No. 11/011,770, filed on Dec. 14, 2004.
Application No. 10/906,263 is a continuation-in-part of application No. 10/906,223, filed on Feb. 9, 2005.
Application No. 10/906,263 is a continuation-in-part of application No. 10/812,294, filed on Mar. 29, 2004.
Application No. 10/906,263 is a continuation-in-part of application No. 10/811,782, filed on Mar. 29, 2004.
Application No. 10/906,263 is a continuation-in-part of application No. 10/812,295, filed on Mar. 29, 2004.
Application No. 10/906,263 is a continuation-in-part of application No. 11/011,761, filed on Dec. 14, 2004.
Application No. 10/906,263 is a continuation-in-part of application No. 11/011,751, filed on Dec. 14, 2004.
Application No. 10/906,263 is a continuation-in-part of application No. 11/011,496, filed on Dec. 14, 2004.
Application No. 10/906,263 is a continuation-in-part of application No. 11/011,762, filed on Dec. 14, 2004.
Application No. 10/906,263 is a continuation-in-part of application No. 11/011,770, filed on Dec. 14, 2004.
Application No. 10/906,263 is a continuation-in-part of application No. 10/906,224, filed on Feb. 9, 2005.
Application No. 10/906,263 is a continuation-in-part of application No. 10/812,294, filed on Mar. 29, 2004.
Application No. 10/906,263 is a continuation-in-part of application No. 10/811,782, filed on Mar. 29, 2004.
Application No. 10/906,263 is a continuation-in-part of application No. 10/812,295, filed on Mar. 29, 2004.
Application No. 10/906,263 is a continuation-in-part of application No. 11/011,761, filed on Dec. 14, 2004.
Application No. 10/906,263 is a continuation-in-part of application No. 11/011,751, filed on Dec. 14, 2004.
Application No. 10/906,263 is a continuation-in-part of application No. 11/011,496, filed on Dec. 14, 2004.
Application No. 10/906,263 is a continuation-in-part of application No. 11/011,762, filed on Dec. 14, 2004.
Application No. 10/906,263 is a continuation-in-part of application No. 11/011,770, filed on Dec. 14, 2004.
Application No. 10/906,263 is a continuation-in-part of application No. 10/906,225, filed on Feb. 9, 2005.
Application No. 10/906,263 is a continuation-in-part of application No. 10/812,294, filed on Mar. 29, 2004.
Application No. 10/906,263 is a continuation-in-part of application No. 10/811,782, filed on Mar. 29, 2004.
Application No. 10/906,263 is a continuation-in-part of application No. 10/812,295, filed on Mar. 29, 2004.
Application No. 10/906,263 is a continuation-in-part of application No. 11/011,761, filed on Dec. 14, 2004.
Application No. 10/906,263 is a continuation-in-part of application No. 11/011,751, filed on Dec. 14, 2004.
Application No. 10/906,263 is a continuation-in-part of application No. 11/011,496, filed on Dec. 14, 2004.
Application No. 10/906,263 is a continuation-in-part of application No. 11/011,762, filed on Dec. 14, 2004.
Application No. 10/906,263 is a continuation-in-part of application No. 11/011,770, filed on Dec. 14, 2004.
Application No. 10/906,263 is a continuation-in-part of application No. 10/906,226, filed on Feb. 9, 2005.
Application No. 10/906,263 is a continuation-in-part of application No. 10/812,294, filed on Mar. 29, 2004.
Application No. 10/906,263 is a continuation-in-part of application No. 10/811,782, filed on Mar. 29, 2004.
Application No. 10/906,263 is a continuation-in-part of application No. 10/812,295, filed on Mar. 29, 2004.
Application No. 10/906,263 is a continuation-in-part of application No. 11/011,761, filed on Dec. 14, 2004.
Application No. 10/906,263 is a continuation-in-part of application No. 10/812,294, filed on Mar. 29, 2004.
Application No. 10/906,263 is a continuation-in-part of application No. 10/811,782, filed on Mar. 29, 2004.
Application No. 10/906,263 is a continuation-in-part of application No. 10/812,295, filed on Mar. 29, 2004.
Application No. 10/906,226 is a continuation-in-part of application No. 11/011,751, filed on Dec. 14, 2004.
Application No. 10/906,226 is a continuation-in-part of application No. 10/812,294, filed on Mar. 29, 2004.
Application No. 10/906,226 is a continuation-in-part of application No. 10/811,782, filed on Mar. 29, 2004.
Application No. 10/906,226 is a continuation-in-part of application No. 10/812,295, filed on Mar. 29, 2004.
Application No. 10/906,226 is a continuation-in-part of application No. 11/011,496, filed on Dec. 14, 2004.
Application No. 10/906,226 is a continuation-in-part of application No. 10/812,294, filed on Mar. 29, 2004.
Application No. 10/906,226 is a continuation-in-part of application No. 10/811,782, filed on Mar. 29, 2004.
Application No. 10/906,226 is a continuation-in-part of application No. 10/812,295, filed on Mar. 29, 2004.
Application No. 10/906,226 is a continuation-in-part of application No. 11/011,762, filed on Dec. 14, 2004.
Application No. 10/906,226 is a continuation-in-part of application No. 10/812,294, filed on Mar. 29, 2004.
Application No. 10/906,226 is a continuation-in-part of application No. 10/811,782, filed on Mar. 29, 2004.
Application No. 10/906,226 is a continuation-in-part of application No. 10/812,295, filed on Mar. 29, 2004.
Application No. 10/906,226 is a continuation-in-part of application No. 11/011,770, filed on Dec. 14, 2004.
Application No. 10/906,226 is a continuation-in-part of application No. 10/812,294, filed on Mar. 29, 2004.
Application No. 11/011,770 is a continuation-in-part of application No. 10/811,782, filed on Mar. 29, 2004.
Application No. 11/011,770 is a continuation-in-part of application No. 10/812,295, filed on Mar. 29, 2004.
(60) Provisional application No. 60/544,591, filed on Feb. 12, 2004.
(60) Provisional application No. 60/544,591, filed on Feb. 12, 2004.
(60) Provisional application No. 60/544,591, filed on Feb. 12, 2004.
(60) Provisional application No. 60/544,591, filed on Feb. 12, 2004.
(60) Provisional application No. 60/544,591, filed on Feb. 12, 2004.
(60) Provisional application No. 60/544,591, filed on Feb. 12, 2004.
(60) Provisional application No. 60/544,591, filed on Feb. 12, 2004.
(60) Provisional application No. 60/544,591, filed on Feb. 12, 2004.
(60) Provisional application No. 60/544,591, filed on Feb. 12, 2004.
(60) Provisional application No. 60/544,591, filed on Feb. 12, 2004.
(60) Provisional application No. 60/544,591, filed on Feb. 12, 2004.
(60) Provisional application No. 60/544,591, filed on Feb. 12, 2004.
(60) Provisional application No. 60/544,591, filed on Feb. 12, 2004.
(60) Provisional application No. 60/544,591, filed on Feb. 12, 2004.
(60) Provisional application No. 60/544,591, filed on Feb. 12, 2004.
(60) Provisional application No. 60/544,591, filed on Feb. 12, 2004.
(60) Provisional application No. 60/544,591, filed on Feb. 12, 2004.
(60) Provisional application No. 60/544,591, filed on Feb. 12, 2004.
(60) Provisional application No. 60/544,591, filed on Feb. 12, 2004.
(60) Provisional application No. 60/544,591, filed on Feb. 12, 2004.
(60) Provisional application No. 60/544,591, filed on Feb. 12, 2004.
(60) Provisional application No. 60/544,591, filed on Feb. 12, 2004.
(60) Provisional application No. 60/544,591, filed on Feb. 12, 2004.
(60) Provisional application No. 60/544,591, filed on Feb. 12, 2004.
(60) Provisional application No. 60/544,591, filed on Feb. 12, 2004.

(51) Int. Cl. G02B 6/00

(52) U.S. Cl. 385/147

(57) ABSTRACT

An apparatus and method for a radiation switching array, including a first radiation wave modulator and a second radiation wave modulator proximate the first modulator, each the modulator having a transport for receiving a wave component, the transport including a waveguide having a guiding region and one or more bounding regions; and a plurality of constituents disposed in the waveguide for enhancing an influencer response in the waveguide; and an influencer, operatively coupled to the transport and responsive to a control signal, for affecting a radiation-amplitude-controlling property of the wave component by inducing the influencer response in the waveguide as the wave component travels through the transport; and a controller, coupled to the modulators, for selectively asserting each the control signal to independently control the amplitude-controlling property of each the modulator. A switching method including (a) receiving a wave component at each of a plurality of transports proximate each other, each transport including a waveguide having a guiding region and one or more bounding regions with a plurality of constituents disposed in the waveguide for enhancing an influencer response in the waveguide; and (b) affecting independently a radiation-amplitude-controlling property of each the wave component as it travels through each the waveguide.

### CROSS REFERENCE TO RELATED APPLICATIONS

This application claims benefit of U.S. Provisional Application No. 60/544,591 filed 12 Feb. 2004, and is a Continuation-In-Part of each of the following U.S. patent application Ser. Nos. 10/812,294, 10/811,782, and 10/812,295 (each filed 29 Mar. 2004); and U.S. patent application Ser. Nos. 11/011,761, 11/011,751, 11/011,496, 11/011,762, and 11/011,770 (each filed 14 Dec. 2004); and U.S. patent application Ser. Nos. 10/906,220, 10/906,221, 10/906,222, 10/906,223, 10/906,224, 10/906,226, and 10/906,226 (each filed 9 Feb. 2005); and U.S. patent application Ser. Nos. 10/906,255, 10/906,256, 10/906,257, 10/906,258, 10/906,259, 10/906,260, 10/906,261, 10/906,262, and 10/906,263 (each filed 11 Feb. 2005). The disclosures of which are each incorporated by reference in their entireties for all purposes.

### BACKGROUND OF THE INVENTION

The present invention relates generally to a transport for propagating radiation, and more specifically to a waveguide having a guiding channel that includes optically-active constituents that enhance a responsiveness of a radiation-influencing property of the waveguide to an outside influence.

The Faraday Effect is a phenomenon wherein a plane of polarization of linearly polarized light rotates when the light is propagated through a transparent medium placed in a magnetic field and in parallel with the magnetic field. An effectiveness of the magnitude of polarization rotation varies with the strength of the magnetic field, the Verdet constant inherent to the medium and the light path length. The empirical angle of rotation is given by:
β=VBd, (Eq. 1)
where V is called the Verdet constant (and has units of arc minutes cm-1 Gauss-1), B is the magnetic field and d is the propagation distance subject to the field. In the quantum mechanical description, Faraday rotation is believed to occur because imposition of a magnetic field alters the energy levels.

It is known to use discrete materials (e.g., iron-containing garnet crystals) having a high Verdet constant for measurement of magnetic fields (such as those caused by electric current as a way of evaluating the strength of the current) or as a Faraday rotator used in an optical isolator. An optical isolator includes a Faraday rotator to rotate by 45° the plane of polarization, a magnet for application of magnetic field, a polarizer, and an analyzer. Conventional optical isolators have been of the bulk type wherein no waveguide (e.g., optical fiber) is used.

In conventional optics, magneto-optical modulators have been produced from discrete crystals containing paramagnetic and ferromagnetic materials, particularly garnets (yttrium/iron garnet for example). Devices such as these require considerable magnetic control fields. The magneto-optical effects are also used in thin-layer technology, particularly for producing non-reciprocal devices, such as non-reciprocal junctions. Devices such as these are based on a conversion of modes by Faraday Effect or by Cotton-Moutton effect.

A further drawback to using paramagnetic and ferromagnetic materials in magneto-optic devices is that these materials may adversely affect properties of the radiation other than polarization angle, such as for example amplitude, phase, and/or frequency.

The prior art has known the use of discrete magneto-optical bulk devices (e.g., crystals) for collectively defining a display device. These prior art displays have several drawbacks, including a relatively high cost per picture element (pixel), high operating costs for controlling individual pixels, increasing control complexity that does not scale well for relatively large display devices.

FIG. 1 (consisting of FIG. 1A, FIG. 1B, and FIG. 1C) is an illustration of a conventional discrete component Faraday rotator and attenuator device 100 used in fiber communications systems. FIG. 1A is side view of device 100, FIG. 1B is a top view of device 100, and FIG. 1C is a perspective view of device 100 as further described below. Device 100 includes an optical fiber 105 transmitting an input beam 110 to a coupling lens 115, then to a first polarizer 120 to form a beam of polarized light 125. Polarized beam 125 is input to an optically active discrete crystal 130 surrounded by a permanent magnet 135 having a winding 140. A polarization-rotation beam 145 is produced from crystal 130 with a polarization-rotation differing from that of beam 125 based upon a current through winding 140. Beam 145 is then directed to an analyzer polarizer 150, then into a coupling lens 155 to fiber optic 160 to produce an output beam 165. An amplitude of output beam 165 depends upon a relative polarization angle between beam 145 and polarizer 150: as crystal 130 varies the angle of rotation of the polarization of beam 145 (typically only a few degrees though Faraday isolators will vary the polarization rotation by a fixed amount equal to 45 degrees).

Conventional imaging systems may be roughly divided into two categories: (a) flat panel displays (FPDs), and (b) projection systems (which include cathode ray tubes (CRTs) as emissive displays). Generally speaking, the dominant technologies for the two types of systems are not the same, although there are exceptions. These two categories have distinct challenges for any prospective technology, and existing technologies have yet to satisfactorily conquer these challenges.

A main challenge confronting existing FPD technology is cost, as compared with the dominant cathode ray tube (CRT) technology (‘flat panel’ means ‘flat’ or ‘thin’ compared to a CRT display, whose standard depth is nearly equal to the width of the display area).

To achieve a given set of imaging standards, including resolution, brightness, and contrast, FPD technology is roughly three to four times more expensive than CRT technology. However, the bulkiness and weight of CRT technology, particularly as a display area is scaled larger, is a major drawback. Quests for a thin display have driven the development of a number of technologies in the FPD arena.

High costs of FPD are largely due to the use of delicate component materials in the dominant liquid crystal diode (LCD) technology, or in the less-prevalent gas plasma technology. Irregularities in the nematic materials used in LCDs result in relatively high defect rates; an array of LCD elements in which an individual cell is defective often results in the rejection of an entire display, or a costly substitution of the defective element.

For both LCD and gas-plasma display technology, the inherent difficulty of controlling liquids or gasses in the manufacturing of such displays is a fundamental technical and cost limitation.

An additional source of high cost is the demand for relatively high switching voltages at each light valve/emission element in the existing technologies. Whether for rotating the nematic materials of an LCD display, which in turn changes a polarization of light transmitted through the liquid cell, or excitation of gas cells in a gas plasma display, relatively high voltages are required to achieve rapid switching speeds at the imaging element. For LCDs, an ‘active matrix,’ in which individual transistor elements are assigned to each imaging location, is a high-cost solution.

As image quality standards increase, for high-definition television (HDTV) or beyond, existing FPD technologies cannot now deliver image quality at a cost that is competitive with CRT's. The cost differential at this end of the quality range is most pronounced. And delivering 35 mm film-quality resolution, while technically feasible, is expected to entail a cost that puts it out of the realm of consumer electronics, whether for televisions or computer displays.

For projection systems, there are two basic subclasses: television (or computer) displays, and theatrical motion picture projection systems. Relative cost is a major issue in the context of competition with traditional 35 mm film projection equipment. However, for HDTV, projection systems represent the low-cost solution, when compared against conventional CRTs, LCD FPDs, or gas-plasma FPDs.

Current projection system technologies face other challenges. HDTV projection systems face the dual challenge of minimizing a depth of the display, while maintaining uniform image quality within the constraints of a relatively short throw-distance to the display surface. This balancing typically results in a less-than-satisfactory compromise at the price of relatively lower cost.

A technically-demanding frontier for projection systems, however, is in the domain of the movie theater. Motion-picture screen installations are an emerging application area for projection systems, and in this application, issues regarding console depth versus uniform image quality typically do not apply. Instead, the challenge is in equaling (at minimum) the quality of traditional 35 mm film projectors, at a competitive cost. Existing technologies, including direct Drive Image Light Amplifier (‘D-ILA’), digital light processing (‘DLP’), and grating-light-valve (‘GLV’)-based systems, while recently equaling the quality of traditional film projection equipment, have significant cost disparities as compared to traditional film projectors.

Direct Drive Image Light Amplifier is a reflective liquid crystal light valve device developed by JVC Projectors. A driving integrated circuit (‘IC’) writes an image directly onto a CMOS based light valve. Liquid crystals change the reflectivity in proportion to a signal level. These vertically aligned (homeoptropic) crystals achieve very fast response times with a rise plus fall time less than 16 milliseconds. Light from a xenon or ultra high performance (‘UHP’) metal halide lamp travels through a polarized beam splitter, reflects off the D-ILA device, and is projected onto a screen.

At the heart of a DLP™ projection system is an optical semiconductor known as a Digital Micromirror Device, or DMD chip, which was pioneered by Dr. Larry Hornbeck of Texas Instruments in 1987. The DMD chip is a sophisticated light switch. It contains a rectangular array of up to 1.3 million hinge-mounted microscopic mirrors; each of these micromirrors measures less than one-fifth the width of a human hair, and corresponds to one pixel in a projected image. When a DMD chip is coordinated with a digital video or graphic signal, a light source, and a projection lens, its mirrors reflect an all-digital image onto a screen or other surface. The DMD and the sophisticated electronics that surround it are called Digital Light Processing™ technology.

A process called GLV (Grating-Light-Valve) is being developed. A prototype device based on the technology achieved a contrast ratio of 3000:1 (typical high-end projection displays today achieve only 1000:1). The device uses three lasers chosen at specific wavelengths to deliver color. The three lasers are: red (642 nm), green (532 nm), and blue (457 nm). The process uses MEMS technology (MicroElectroMechanical) and consists of a microribbon array of 1,080 pixels on a line. Each pixel consists of six ribbons, three fixed and three which move up/down. When electrical energy is applied, the three mobile ribbons form a kind of diffraction grating which ‘filters’ out light.

Part of the cost disparity is due to the inherent difficulties those technologies face in achieving certain key image quality parameters at a low cost. Contrast, particularly in quality of ‘black,’ is difficult to achieve for micro-mirror DLP. GLV, while not facing this difficulty (achieving a pixel nullity, or black, through optical grating wave interference), instead faces the difficulty of achieving an effectively film-like intermittent image with a line-array scan source.

Existing technologies, either LCD or MEMS-based, are also constrained by the economics of producing devices with at least 1 K×1 K arrays of elements (micro-mirrors, liquid crystal on silicon (‘LCoS’), and the like). Defect rates are high in the chip-based systems when involving these numbers of elements, operating at the required technical standards.

It is known to use stepped-index optical fibers in cooperation with the Faraday Effect for various telecommunications uses. The telecommunications application of optical fibers is well-known, however there is an inherent conflict in applying the Faraday Effect to optical fibers because the telecommunications properties of conventional optical fibers relating to dispersion and other performance metrics are not optimized for, and in some cases are degraded by, optimizations for the Faraday Effect. In some conventional optical fiber applications, ninety-degree polarization rotation is achieved by application of a one hundred Oersted magnetic field over a path length of fifty-four meters. Placing the fiber inside a solenoid and creating the desired magnetic field by directing current through the solenoid applies the desired field. For telecommunications uses, the fifty-four meter path length is acceptable when considering that it is designed for use in systems having a total path length measured in kilometers.

Another conventional use for the Faraday Effect in the context of optical fibers is as a system to overlay a low-rate data transmission on top of conventional high-speed transmission of data through the fiber. The Faraday Effect is used to slowly modulate the high-speed data to provide out-of-band signaling or control. Again, this use is implemented with the telecommunications use as the predominate consideration.

In these conventional applications, the fiber is designed for telecommunications usage and any modification of the fiber properties for participation in the Faraday Effect is not permitted to degrade the telecommunications properties that typically include attenuation and dispersion performance metrics for kilometer+−length fiber channels.

Once acceptable levels were achieved for the performance metrics of optical fibers to permit use in telecommunications, optical fiber manufacturing techniques were developed and refined to permit efficient and cost-effective manufacturing of extremely long-lengths of optically pure and uniform fibers. A high-level overview of the basic manufacturing process for optical fibers includes manufacture of a perform glass cylinder, drawing fibers from the preform, and testing the fibers. Typically a perform blank is made using a modified chemical vapor deposition (MCVD) process that bubbles oxygen through silicon solutions having a requisite chemical composition necessary to produce the desired attributes (e.g., index of refraction, coefficient of expansion, melting point, etc.) of the final fiber. The gas vapors are conducted to an inside of a synthetic silica or quartz tube (cladding) in a special lathe. The lathe is turned and a torch moves along an outside of the tube. Heat from the torch causes the chemicals in the gases to react with oxygen and form silicon dioxide and germanium dioxide and these dioxides deposit on the inside of the tube and fuse together to form glass. The conclusion of this process produces the blank preform.

After the blank preform is made, cooled, and tested, it is placed inside a fiber drawing tower having the preform at a top near a graphite furnace. The furnace melts a tip of the preform resulting in a molten ‘glob’ that begins to fall due to gravity. As it falls, it cools and forms a strand of glass. This strand is threaded through a series of processing stations for applying desired coatings and curing the coatings and attached to a tractor that pulls the strand at a computer-monitored rate so that the strand has the desired thickness. Fibers are pulled at about a rate of thirty-three to sixty-six feet/second with the drawn strand wound onto a spool. It is not uncommon for these spools to contain more than one point four (1.4) miles of optical fiber.

This finished fiber is tested, including tests for the performance metrics. These performance metrics for telecommunications grade fibers include: tensile strength (100,000 pounds per square inch or greater), refractive index profile (numerical aperture and screen for optical defects), fiber geometry (core diameter, cladding dimensions and coating diameters), attenuation (degradation of light of various wavelengths over distance), bandwidth, chromatic dispersion, operating temperature/range, temperature dependence on attenuation, and ability to conduct light underwater.

In 1996, a variation of the above-described optical fibers was demonstrated that has since been termed photonic crystal fibers (PCFs). A PCF is an optical fiber/waveguiding structure that uses a microstructured arrangement of low-index material in a background material of higher refractive index. The background material is often undoped silica and the low index region is typically provided by air voids running along the length of the fiber. PCFs are divided into two general categories: (1) high index guiding fibers, and (2) low index guiding fibers.

Similar to conventional optic fibers described previously, high index guiding fibers are guiding light in a solid core by the Modified Total Internal Reflection (MTIR) principle. Total internal reflection is caused by the lower effective index in the microstructured air-filled region.

Low index guiding fibers guide light using a photonic bandgap (PBG) effect. Light is confined to the low index core as the PBG effect makes propagation in the microstructured cladding region impossible.

While the term ‘conventional waveguide structure’ is used to include the wide range of waveguiding structures and methods, the range of these structures may be modified as described herein to implement embodiments of the present invention. The characteristics of different fiber types aides are adapted for the many different applications for which they are used. Operating a fiber optic system properly relies on knowing what type of fiber is being used and why.

Conventional systems include single-mode, multimode, and PCF waveguides, and also include many sub-varieties as well. For example, multimode fibers include step-index and graded-index fibers, and single-mode fibers include step-index, matched clad, depressed clad and other exotic structures. Multimode fiber is best designed for shorter transmission distances, and is suited for use in LAN systems and video surveillance. Single-mode fiber are best designed for longer transmission distances, making it suitable for long-distance telephony and multichannel television broadcast systems. ‘Air-clad’ or evanescently-coupled waveguides include optical wire and optical nano-wire.

Stepped-index generally refers to provision of an abrupt change of an index of refraction for the waveguide—a core has an index of refraction greater than that of a cladding. Graded-index refers to structures providing a refractive index profile that gradually decreases farther from a center of the core (for example the core has a parabolic profile). Single-mode fibers have developed many different profiles tailored for particular applications (e.g., length and radiation frequency(ies) such as non dispersion-shifted fiber (NDSF), dispersion-shifted fiber (DSF) and non-zero-dispersion-shifted fiber (NZ-DSF)). An important variety of single-mode fiber has been developed referred to as polarization-maintaining (PM) fiber. All other single-mode fibers discussed so far have been capable of carrying randomly polarized light. PM fiber is designed to propagate only one polarization of the input light. PM fiber contains a feature not seen in other fiber types. Besides the core, there are additional (2) longitudinal regions called stress rods. As their name implies, these stress rods create stress in the core of the fiber such that the transmission of only one polarization plane of light is favored.

As discussed above, conventional magneto-optical systems, particularly Faraday rotators and isolators, have employed special magneto-optical materials that include rare earth doped garnet crystals and other specialty materials, commonly an yttrium-iron-garnet (YIG) or a bismuth-substituted YIG. A YIG single crystal is grown using a floating zone (FZ) method. In this method, Y₂O₃ and Fe₂O₃ are mixed to suit the stoichiometric composition of YIG, and then the mixture is sintered. The resultant sinter is set as a mother stick on one shaft in an FZ furnace, while a YIG seed crystal is set on the remaining shaft. The sintered material of a prescribed formulation is placed in the central area between the mother stick and the seed crystal in order to create the fluid needed to promote the deposition of YIG single crystal. Light from halogen lamps is focused on the central area, while the two shafts are rotated. The central area, when heated in an oxygenic atmosphere, forms a molten zone. Under this condition, the mother stick and the seed are moved at a constant speed and result in the movement of the molten zone along the mother stick, thus growing single crystals from the YIG sinter.

Since the FZ method grows crystal from a mother stick that is suspended in the air, contamination is precluded and a high-purity crystal is cultivated. The FZ method produces ingots measuring 012×120 mm.

Bi-substituted iron garnet thick films are grown by a liquid phase epitaxy (LPE) method that includes an LPE furnace. Crystal materials and a PbO—B₂O₃ flux are heated and made molten in a platinum crucible. Single crystal wafers, such as (GdCa)₂(GaMgZr)₅O₁₂, are soaked on the molten surface while rotated, which causes a Bi-substituted iron garnet thick film to be grown on the wafers. Thick films measuring as much as 3 inches in diameter can be grown.

To obtain 45° Faraday rotators, these films are ground to a certain thickness, applied with anti-reflective coating, and then cut into 1-2 mm squares to fit the isolators. Having a greater Faraday rotation capacity than YIG single crystals, Bi-substituted iron garnet thick films must be thinned in the order of 100 μm, so higher-precision processing is required.

Newer systems provide for the production and synthesis of Bismuth-substituted yttrium-iron-garnet (Bi—YIG) materials, thin-films and nanopowders. nGimat Co., at 5313 Peachtree Industrial Boulevard, Atlanta, Ga. 30341 uses a combustion chemical vapor deposition (CCVD) system for production of thin film coatings. In the CCVD process, precursors, which are the metal-bearing chemicals used to coat an object, are dissolved in a solution that typically is a combustible fuel. This solution is atomized to form microscopic droplets by means of a special nozzle. An oxygen stream then carries these droplets to a flame where they are combusted. A substrate (a material being coated) is coated by simply drawing it in front of the flame. Heat from the flame provides energy that is required to vaporize the droplets and for the precursors to react and deposit (condense) on the substrate.

Additionally, epitaxial liftoff has been used for achieving heterogeneous integration of many III-V and elemental semiconductor systems. However, it has been difficult using some processes to integrate devices of many other important material systems. A good example of this problem has been the integration of single-crystal transition metal oxides on semiconductor platforms, a system needed for on-chip thin film optical isolators. An implementation of epitaxial liftoff in magnetic garnets has been reported. Deep ion implantation is used to create a buried sacrificial layer in single-crystal yttrium iron garnet (YIG) and bismuth-substituted YIG (Bi—YIG) epitaxial layers grown on gadolinium gallium garnet (GGG). The damage generated by the implantation induces a large etch selectivity between the sacrificial layer and the rest of the garnet. Ten-micron-thick films have been lifted off from the original GGG substrates by etching in phosphoric acid. Millimeter-size pieces have been transferred to the silicon and gallium arsenide substrates.

Further, researchers have reported a multilayer structure they call a magneto-optical photonic crystal that displays one hundred forty percent (140%) greater Faraday rotation at 748 nm than a single-layer bismuth iron garnet film of the same thickness. Current Faraday rotators are generally single crystals or epitaxial films. The single-crystal devices, however, are rather large, making their use in applications such as integrated optics difficult. And even the films display thicknesses on the order of 500 μm, so alternative material systems are desirable. The use of stacked films of iron garnets, specifically bismuth and yttrium iron garnets has been investigated. Designed for use with 750-nm light, a stack featured four heteroepitaxial layers of 81-nm-thick yttrium iron garnet (YIG) atop 70-nm-thick bismuth iron garnet (BIG), a 279-nm-thick central layer of BIG, and four layers of BIG atop YIG. To fabricate the stack, a pulsed laser deposition using an LPX305i 248-nm KrF excimer laser was used.

As seen from the discussion above, the prior art employs specialty magneto-optic materials in most magneto-optic systems, but it has also been known to employ the Faraday Effect with less traditional magneto-optic materials such as the non-PCF optical fibers by creating the necessary magnetic field strength—as long as the telecommunications metrics are not compromised. In some cases, post-manufacturing methods are used in conjunction with pre-made optical fibers to provide certain specialty coatings for use in certain magneto-optical applications. The same is true for specialty magneto-optical crystals and other bulk implementations in that post-manufacture processing of the premade material is sometimes necessary to achieve various desired results. Such extra processing increases the final cost of the special fiber and introduces additional situations in which the fiber may fail to meet specifications. Since many magneto-applications typically include a small number (typically one or two) of magneto-optical components, the relatively high cost per unit is tolerable. However, as the number of desired magneto-optical components increases, the final costs (in terms of dollars and time) are magnified and in applications using hundreds or thousands of such components, it is imperative to greatly reduce unit cost.

What is needed is an alternative waveguide technology that offers advantages over the prior art to enhance a responsiveness of a radiation-influencing property of the waveguide to an outside influence while reducing unit cost and increasing manufacturability, reproducibility, uniformity, and reliability.

### BRIEF SUMMARY OF THE INVENTION

Disclosed is an apparatus and method for a radiation switching array, including a first radiation wave modulator and a second radiation wave modulator proximate the first modulator, each the modulator having a transport for receiving a wave component, the transport including a waveguide having a guiding region and one or more bounding regions; and a plurality of constituents disposed in the waveguide for enhancing an influencer response in the waveguide; and an influencer, operatively coupled to the transport and responsive to a control signal, for affecting a radiation-amplitude-controlling property of the wave component by inducing the influencer response in the waveguide as the wave component travels through the transport; and a controller, coupled to the modulators, for selectively asserting each the control signal to independently control the amplitude-controlling property of each the modulator. A switching method including (a) receiving a wave component at each of a plurality of transports proximate each other, each transport including a waveguide having a guiding region and one or more bounding regions with a plurality of constituents disposed in the waveguide for enhancing an influencer response in the waveguide; and (b) affecting independently a radiation-amplitude-controlling property of each the wave component as it travels through each the waveguide.

It is also a preferred embodiment of the present invention for a switching matrix manufacturing method, the method including: a) producing a plurality of transports, each transport including a waveguide having a waveguiding channel and one or more bounding regions associated with the waveguiding channel wherein the transports include a plurality of constituents disposed in the waveguide for enhancing an influencer response in the waveguide; and b) proximating a plurality of modulators, each modulator including one or more transports and one or more influencers coupled to the transports and responsive to one or more control signals, for affecting a radiation-amplitude-controlling property of the wave component by inducing the influencer response in the waveguide as the wave component propagates through the one or more transports, the plurality of modulators forming a collective information presentation system contributing information from each of the transports responsive to the one or more control signals from a control system.

The apparatus, method, computer program product and propagated signal of the present invention provide an advantage of using modified and mature waveguide manufacturing processes. In a preferred embodiment, waveguide are an optical transport, preferably an optical fiber or waveguide channel adapted to enhance short-length property influencing characteristics of the influencer by including optically-active constituents while preserving desired attributes of the radiation. In a preferred embodiment, the property of the radiation to be influenced includes a polarization state of the radiation and the influencer uses a Faraday Effect to control a polarization rotation angle using a controllable, variable magnetic field propagated parallel to a transmission axis of the optical transport. The optical transport is constructed to enable the polarization to be controlled quickly using low magnetic field strength over very short optical paths. Radiation is initially controlled to produce a wave component having one particular polarization; the polarization of that wave component is influenced so that a second polarizing filter modulates an amplitude of emitted radiation in response to the influencing effect. In the preferred embodiment, this modulation includes extinguishing the emitted radiation. The incorporated patent applications, the priority applications and related-applications, disclose Faraday structured waveguides, Faraday structured waveguide modulators, displays and other waveguide structures and methods that are cooperative with the present invention.

Leveraging the mature and efficient fiber optic waveguide manufacturing process as disclosed herein as part of the present invention for use in production of low-cost, uniform, efficient magneto-optic system elements provides an alternative waveguide technology that offers advantages over the prior art to enhance a responsiveness of a radiation-influencing property of the waveguide to an outside influence while reducing unit cost and increasing manufacturability, reproducibility, uniformity, and reliability.

### BRIEF DESCRIPTION OF THE DRAWINGS

FIG. 1A is side view of a conventional Faraday rotator device;

FIG. 1B is a top view of the device shown in FIG. 1A;

FIG. 1C is a perspective view of the device shown in FIG. 1A;

FIG. 2 is a basic diagram of a preferred embodiment of the present invention demonstrating a pixel system having three subpixels (R, G, and B for example) used to produce a single pixel structure:

FIG. 3 is an alternative preferred embodiment for a pixel system similar to the system shown in FIG. 2;

FIG. 4 is an alternative preferred embodiment for a pixel system similar to the system shown in FIG. 2 and the system shown in FIG. 3;

FIG. 5 is a general schematic diagram of a simplified unitary panel waveguide-based display according to the preferred embodiment;

FIG. 6 is a detailed schematic diagram of the display shown in FIG. 5;

FIG. 7 is a general schematic of a componentized display system according a preferred embodiment of the present invention;

FIG. 8 is a schematic diagram of a preferred embodiment for an implementation of a componentized display system as a specific implementation of the system shown in FIG. 7;

FIG. 9A is a preferred embodiment for a modulator that includes an optically active guiding core and one or more bounding regions for enhancing containment of radiation within the modulator as it propagates along a transmission axis;

FIG. 9B is an illustration pair of representative relationships for the modulator shown in FIG. 9A, including a view and a graph;

FIG. 9C is an illustration of a representative fiber/subpixel-implemented modulator in horizontal cross-section;

FIG. 10 is a generalized schematic diagram of a waveguide including a twisted fiber structure and coilform;

FIG. 11 is a schematic diagram of a first specific implementation of the system shown in FIG. 38 including a conductively coated preform and a superficial helical cut;

FIG. 12 is a schematic diagram of a second specific implementation of the system shown in FIG. 38 including a partially conductively coated preform without a superficial helical cut;

FIG. 13 is a schematic diagram of a third specific implementation of the system shown in FIG. 38 including a conductive element embedded/applied into/onto a preform;

FIG. 14 is a schematic diagram of a fourth specific implementation of the system shown in FIG. 38 including a thinfilm epitaxially wrapped around a waveguide channel;

FIG. 15 is a schematic diagram of a fifth specific implementation of the system shown in FIG. 38 including a disposition of a coilform on a waveguide channel using dip-pen nanolithography;

FIG. 16 is a schematic diagram of a sixth specific implementation of the system shown in FIG. 38 including a disposition of a conductive element on a waveguide channel using a wrapping procedure;

FIG. 17 is a schematic diagram of an ‘X’ ribbon structural fiber system according to a preferred embodiment of the present invention;

FIG. 18 is a schematic diagram of a ‘Y’ ribbon structural fiber system according to a preferred embodiment of the present invention;

FIG. 19 is a schematic three-dimensional representation of a textile matrix useable as a display, display element, logic device, logic element, or memory device and the like as described and suggested herein and in the incorporated patent applications;

FIG. 20A is view of channel 2000 perpendicular to a propagation axis adjacent to an integrated influencer (e.g., a coilform) structure;

FIG. 20B is a cross-section of the waveguide channel shown in FIG. 20A, in process, parallel to the propagation axis, after an initial diameter cut;

FIG. 20C is a cross-section of the waveguide preform shown in FIG. 20B, in process, parallel to the propagation axis, after an initial diameter cut and contact layer is deposited;

FIG. 21 is a schematic diagram of an alternate preferred embodiment of the present invention for a modulator;

FIG. 22 is a schematic diagram of a modulator including an alternate preferred embodiment for an excitation system using optical pumping;

FIG. 23 is a schematic diagram of a preferred embodiment for an implementation of the componentized display system shown in FIG. 7;

FIG. 24 is a schematic diagram of an addressing grid according to a preferred embodiment of the present invention;

FIG. 25 is a schematic diagram of a preferred embodiment for a modular switching matrix used in the display shown in FIG. 5 and FIG. 6;

FIG. 26 is a schematic diagram of a first alternate preferred embodiment for a modular switching matrix used in the display shown in FIG. 5 and FIG. 6;

FIG. 27 is a schematic diagram of a second alternate preferred embodiment for a modular switching matrix used in the display shown in FIG. 5 and FIG. 6;

FIG. 28 is a schematic diagram of a third preferred embodiment for a modular switching matrix used in the display shown in FIG. 5 and FIG. 6;

FIG. 29 is a schematic diagram of a preferred embodiment for an implementation of the componentized display system shown in FIG. 7 and FIG. 8;

FIG. 30 is an alternative preferred embodiment of a system in which an element of an excitation system is disposed within a core;

FIG. 31A is an exploded view of an array illustrating an arrangement of modulator strips;

FIG. 31B is a detailed schematic diagram of a portion of one modulator strip shown in FIG. 31A;

FIG. 32A is an alternate preferred embodiment for a display system implementing a semiconductor waveguide display/projector as a vertical solution using vertical waveguide channels in the semiconductor structure;

FIG. 32B is an illustration showing the two-layers that successively alternatingly constitute the ‘coilform’ pattern: a partial circle, defining a cylinder wall, on the first layer, the terminus connecting vertically in the same conductive material to a very thin second layer deposited above and used in FIG. 32A;

FIG. 33 is an alternate preferred embodiment for a display system implementing a semiconductor waveguide display/projector as a planar solution using planar waveguide channels in a semiconductor structure

FIG. 34A is a cross-section of a transport/influencer system integrated into the semiconductor structure for propagating a radiation signal, combined with a deflecting mechanism that re-directs light ‘valved’ by the waveguide/influencer from the horizontal plane to the vertical;

FIG. 34B illustrates a preferred embodiment for an optional implementation of a waveguide pathing structure in a system;

FIG. 35 is a schematic illustration of display system shown in FIG. 33 further illustrating three subpixel channels producing a single pixel;

FIG. 36 is a general schematic diagram of a transverse integrated modulator switch/junction system according to a preferred embodiment of the present invention;

FIG. 37 is a general schematic diagram of a series of fabrication steps for the transverse integrated modulator switch/junction shown in FIG. 36;

FIG. 38 is a schematic diagram of a generic waveguide processing system for producing conformed waveguides according to the various disclosed embodiments of the present invention;

FIG. 39 is a schematic diagram of a preferred embodiment of an alternate system for structuring and propagating multiple channels of controllable radiation to produce a pixel/sub-pixel;

FIG. 40 is an end view schematic of the system shown in FIG. 39 further illustrating the presence of an optional center core;

FIG. 41 is a schematic diagram of an alternate preferred embodiment for a modulator having multiple channels;

FIG. 42 is a front perspective view of a preferred embodiment for an electronic goggle system using substrated waveguide display systems;

FIG. 43 is a side perspective view of the electronic goggle system shown in FIG. 42.

FIG. 44 is a general schematic block diagram of a preferred embodiment of the present invention for a macroscopic component system;

FIG. 45 is a general schematic plan view of a preferred embodiment of the present invention;

FIG. 46 is a detailed schematic plan view of a specific implementation of the preferred embodiment shown in FIG. 45;

FIG. 47 is an end view of the preferred embodiment shown in FIG. 46;

FIG. 48 is a schematic block diagram of a preferred embodiment for a display assembly;

FIG. 49 is a view of one arrangement for output ports of the front panel shown in FIG. 48;

FIG. 50 is a schematic representation of a preferred embodiment of the present invention for a portion of the structured waveguide shown in FIG. 46;

FIG. 51 is a schematic block diagram of a representative waveguide manufacturing system for making a preferred embodiment of a waveguide preform of the present invention; and

FIG. 52 is a schematic diagram of a representative fiber drawing system for making a preferred embodiment of the present invention.

### DETAILED DESCRIPTION OF THE INVENTION

The present invention relates to an alternative waveguide technology that offers advantages over the prior art to enhance a responsiveness of a radiation-influencing property of the waveguide to an outside influence while reducing unit cost and increasing manufacturability, reproducibility, uniformity, and reliability. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

In the following description, three terms have particular meaning in the context of the present invention: (1) optical transport, (2) property influencer, and (3) extinguishing. For purposes of the present invention, an optical transport is a waveguide particularly adapted to enhance the property influencing characteristics of the influencer while preserving desired attributes of the radiation. In a preferred embodiment, the property of the radiation to be influenced includes its polarization rotation state and the influencer uses a Faraday Effect to control the polarization angle using a controllable, variable magnetic field propagated parallel to a transmission axis of the optical transport. The optical transport is constructed to enable the polarization to be controlled quickly using low magnetic field strength over very short optical paths. In some particular implementations, the optical transport includes optical fibers exhibiting high Verdet constants for the wavelengths of the transmitted radiation while concurrently preserving the waveguiding attributes of the fiber and otherwise providing for efficient construction of, and cooperative affectation of the radiation property(ies), by the property influencer.

The property influencer is a structure for implementing the property control of the radiation transmitted by the optical transport. In the preferred embodiment, the property influencer is operatively coupled to the optical transport, which in one implementation for an optical transport formed by an optical fiber having a core and one or more cladding layers, preferably the influencer is integrated into or on one or more of the cladding layers without significantly adversely altering the waveguiding attributes of the optical transport. In the preferred embodiment using the polarization property of transmitted radiation, the preferred implementation of the property influencer is a polarization influencing structure, such as a coil, coilform, or other structure capable of integration that supports/produces a Faraday Effect manifesting field in the optical transport (and thus affects the transmitted radiation) using one or more magnetic fields (one or more of which are controllable).

The structured waveguide of the present invention may serve in some embodiments as a transport in a modulator that controls an amplitude of propagated radiation. The radiation emitted by the modulator will have a maximum radiation amplitude and a minimum radiation amplitude, controlled by the interaction of the property influencer on the optical transport. Extinguishing simply refers to the minimum radiation amplitude being at a sufficiently low level (as appropriate for the particular embodiment) to be characterized as ‘off’ or ‘dark’ or other classification indicating an absence of radiation. In other words, in some applications a sufficiently low but detectable/discernable radiation amplitude may properly be identified as ‘extinguished’ when that level meets the parameters for the implementation or embodiment. The present invention improves the response of the waveguide to the influencer by use of optically active constituents disposed in the guiding region during waveguide manufacture.

The present invention includes preferred embodiments for various display devices using an array of modulators (also sometimes referred to herein as Faraday Attenuators based upon the preferred influencing mechanism) to produce a pixel/subpixel array that forms images through efficient and precise waveguiding processes and structures.

A major subclass of these embodiments of the present invention propose assembly and arrangement, as described more fully below, of an array of ‘Faraday Attenuators' functioning as variable-intensity light-valves on an array of light-channels, in the form of optical fibers, semiconductor waveguides, waveguiding holes, or other optical channels and the like, such an array terminating in a display or projection surface.

To repeat the definition provided earlier, waveguiding includes the confinement of light to controlled channels, typically by means of a difference in index of diffraction between a ‘core’ in which light travels and a ‘cladding’ which effectively reflects scattering light, at its boundary with the core, back into the core; but other mechanisms, including photonic band-gap coupling, may also be provided as a ‘waveguiding structure or method.’ Waveguiding, thus, is a process of controlling light, in which optical channels (including fibers such as standard solid-core and photonic crystal), semiconductor waveguides, and other light-channeling or light-confining structures or regions are implementing components, methods and mechanisms.

To many, a significance of implementing a magneto-optic display through waveguiding processes and structures may not be apparent. But the significance is fundamental and cannot be overemphasized. For it is akin to the development that optical communications went through when it passed from the basic concept of pulsed laser light, point-to-point, through free space and manipulated by various opto-electronic components in a physical sequence that implemented the crude concept of transmitting data optically—that is, un-waveguided, without controlling and channeling light through optical structures—to the implementation in systems based on and composed of practical waveguiding processes and components, such as optical fibers and semiconductor optical waveguides.

It is the systems based on and composed of waveguiding processes and structures that enabled transmission across great distances without attenuation and precision control and manipulation through the fundamental principle of guiding and controlling a path of light through solid-state integrated structures. Overall, it is an implementation through waveguiding that was a starting point in achieving a practical, lost cost, efficient implementation of a basic concept of pulsing coherent laser light from one point and receiving and transducing those pulses into electronic signals. Improving waveguiding is an ongoing process, and it defines a nature of photonics and electro-photonics and advances in the field, including the ultimate implementation of optical computing. Without a first step of waveguiding and practical, inventive solutions to the implementation of waveguiding as the mechanism to realizing a principle of pulsed-light optical communications, we would not have the optical communications systems as they exist today.

Systematic implementation of waveguiding versions of the basic concepts involved—whether in optical-communications and pulsed light as a mode of data transmission, or visual display devices based on the Faraday Effect as a light valve. Waveguiding, systematically implemented through further inventive solutions as disclosed herein, solves many of the problems of the prior art.

Such is the case with many of the embodiments of the present invention disclosed herein, a system of inventive solutions to the leap of implementing the Faraday-effect light-valve concept through integrated waveguiding processes and structures.

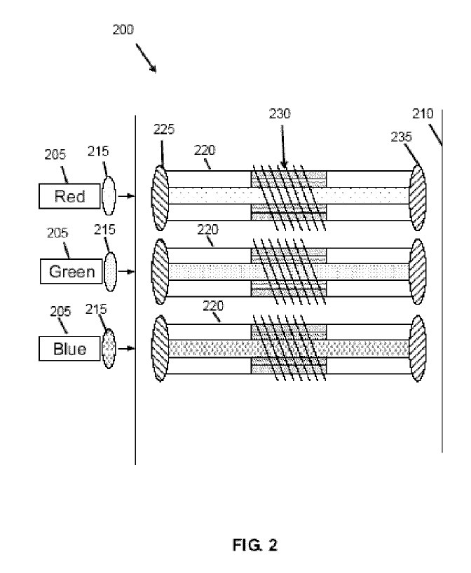

FIG. 2 is a basic diagram of a preferred embodiment of the present invention demonstrating a pixel system 200 having three subpixels (R, G, and B for example) 205 used to produce a single pixel structure 210. System 200 includes one or more sources of light 215, one or more waveguide channels 220, an initial polarizer 225, integrated influencer elements 230, and an analyzer polarizer 235.

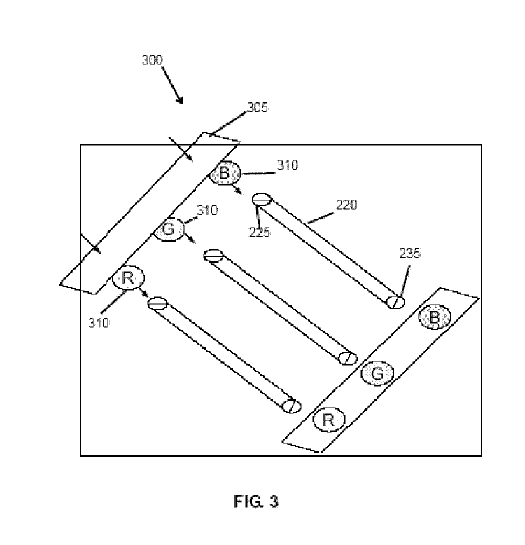

FIG. 3 is an alternative preferred embodiment for a pixel system 300 similar to system 200 shown in FIG. 2. System 300 uses a balanced white light source 305 that is decomposed into desired color frequencies using color filters 310. Color filters 310 may be discrete filtering systems or they may be integrated into waveguide channels 220.

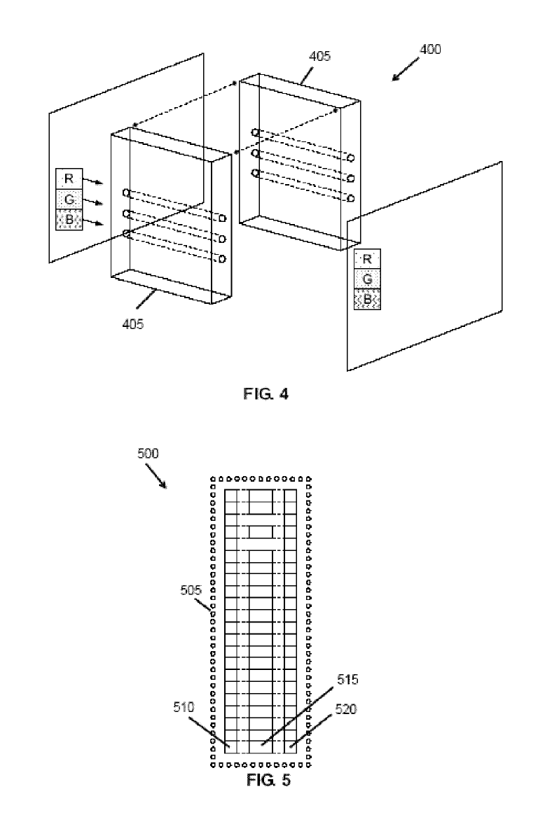

FIG. 4 is an alternative preferred embodiment for a pixel system 400 similar to system 200 shown in FIG. 2 and system 300 shown in FIG. 3. System 400 uses semiconductor ‘bulk’ or substrated waveguide channels fabricated in semiconductor structures 405 (vertical or planar) as further explained below.

Many of the preferred embodiments, regardless of their wide range of difference in detail, possess the following components and general schematic of one of the systems described above in connection with FIG. 2, FIG. 3 or FIG. 4.

Standard components and standard options include:

I. Light Source: Either unitary balanced-white or separate RGB/CMY tuned sources. Remote from input ends of light channels, adjacent input ends, or integral to the light channels.

II. Light Channels. The preferred embodiments include light channels in the form of waveguides such as optical fibers. But semiconductor waveguide, waveguiding holes, or other optical waveguiding channels, including channels or regions formed through material ‘in depth,’ are disclosed by embodiments of the present invention. These waveguiding elements are fundamental imaging structures of the display and incorporate, integrally, intensity modulation mechanisms and color selection systems.

III. Initial Polarization of Light Passing Into Light Channels. Various polarization implementations may also be employed that permit passage of light of a single polarization angle into the light channels; most typical will be a thinfilm deposited epitaxially on an ‘input’ end of the light channels. In regard to efficient input of all light from the light source(s), any illumination source may include a cavity, to allow repeated reflection of light of the ‘wrong’ initial polarization; thereby all light ultimately resolves into the admitted or ‘right’ polarization. Optionally, especially depending on the distance from an illumination source to the Faraday attenuators section of the waveguide structures, polarization-maintaining waveguides (fibers, semiconductor) may be employed.

IV. Optional Decomposition of Light Into Separate Polarization Components and Dual Light Channels for Each Polarization. Preferably such decomposition is performed through a fused-fiber polarization splitter, but other ways are known. According to this option, there are two channels carrying oppositely-polarized light for each subpixel or pixel. This may provide more energy and heat-efficient utilization of all light polarizations from source(s).

V. Integrated Color Selection. The preferred implementation of integrating color in the waveguide elements is via RGB (or CYM) dye-doping of the waveguide cores, but other convenient methods are known.

VI. Faraday-effect Attenuators, Integrated in Waveguides, Vary the Intensity of the Light, from fully ‘off’ to fully ‘on.’ When separate dye-doped fibers are employed, a Faraday Attenuator for each fiber is sufficient. Alternatively, a single fiber structure may be fabricated with multiple helical-superficial or other multiple color channels, each dye-doped. In all embodiments, drive circuit may employ capacitors.

VII. Structure and Assembly of Switching Matrix. There are a number of advantageous systems of construction and assembly of the switching ‘matrix’ that structurally combines and holds the waveguide elements, and electronically addresses each subpixel or pixel. In the case of optical fibers, inherent in the nature of a fiber component is the potential for an all-fiber, textile construction and addressing of the fiber elements. Flexible meshes or solid matrixes are alternative structures, with attendant assembly methods.

VII. Modification of the Output Ends of the Light Channels. The output ends of the waveguide structures, particularly optical fibers, may be heat-treated and pulled to form tapered ends or otherwise abraded, twisted, or shaped for enhanced light scattering at the output ends, thereby improving viewing angle at the display surface.

IX. ‘Analyzer’ or Offset-Polarizer Component. This is a ‘polarization filter’ element that is 90 degrees offset from the orientation of the first polarization ‘filter’ element. This is preferably a thin-film deposited epitaxially on either the optical glass or the output/display end of the waveguide array.

X. Optional Re-combination of differently polarized light channels. Groups of RGB light channels and optional white-light light channels, preferably two channels per color element (to carry the differently polarized light decomposed by the polarization-splitting element) may be recombined prior to terminating at the display or projector surface, depending on the requirements of varying embodiments for surface area of display or projector surface. Channels may be joined by fiber fusing, insertion, waveguide merger, and other methods.

XI. Display or Projector Surface. Light then passes from the output ends through the polarization system to the display or projector surface. This final surface element may be optical glass or other transparent optical material facing the polarization component.

XII. Geometry of Display or Projector Surface. The optical geometry of the display or projector surface may itself vary, as has been demonstrated in the prior art of fiber-optic faceplates, in which the fiber ends terminate to a curved surface, allowing additional focusing capacity in sequence with additional optical elements and lenses, of particular relevance to projection system embodiments.

The preferred Faraday Attenuators function by applying a variable drive circuit (preferably in pulse or digital form) to a field generating element—a coil or ‘coilform’ or strip or collar element surrounding a suitable material (for example, a doped fiber cladding or thin-film iron Garnet surrounding the channel), possessing a sufficiently high remnant flux between pulses. Such a variable field rotates the polarization angle of an incident beam of polarized light through a range of 90 degrees, from the black or ‘off’ position to the full intensity or ‘on’ position. Alternatively, one could reverse the default condition and have a pixel ‘on’ by default and require a signal to variably reduce it to zero; such an implementation is particularly relevant to some other applications of the same basic switched array.

In the case of optical fiber or semiconductor waveguide methods, the entire fiber or waveguide material may be doped with YIG, Tb, TGG or other elements to achieve a high Verdet constant. Given two rays of circularly polarized light, one with left-hand and the other with right-hand polarization, the one with the polarization in the same direction as the electricity of the magnetizing current travels with greater velocity. That is, the plane of linearly polarized light is rotated when a magnetic field is applied parallel to the propagation direction as described above in connection with Eq. 1 above.

Two-defect doping of fiber has also been shown to improve performance. The essence is to achieve high remnant flux following a pulse to reduce power consumption and achieve high switching speeds. (The recent employment of inert gases in a continuous flow with molten oxides has achieved the level of viscosity required for the pulling of optical fibers from oxide-doped silica). Permanent magnet elements may also be employed to magnetize the Faraday element in a direction perpendicular to the vector of the field generated by the variable Faraday rotation element, to saturate the element fully and thus reduce optical loss. Such permanent magnet elements, preferably dopants in a cladding layer, are preferably designed to have no effect on the angle of polarization directly, and thus would not compromise the display's contrast ratio.

The ‘attenuation curve’ associated with a particular use of materials and construction of the ‘Faraday-effect attenuator’ being a known quantity, the power-level for a given level of attenuation may be driven digitally in correspondingly (irregular or regular) increments to achieve a smooth attenuation curve for the device as a whole. In addition, when the original light is decomposed into separate polarizations, resulting in two light-channels per color, by choice of differing materials with differing curves for the separate polarizations provides another mechanism of smoothing the attenuation curve. Numbers of channels may be multiplied with differing materials, as needed, to achieve additional smoothing, when necessary or desirable.

Color selection is integrated into the intensity modulation system, by two primary classes of methods (those described below do not exhaust the possible methods covered by the invention):

First, in a class of methods utilizing optical fibers, separate dye-doped fibers (RGB or YCM) transmit light of a certain color to the display or projection face, and fiber segments are interrupted by Faraday Attenuator elements, which vary the intensity of the colored light passing through the dye-doped fibers, from the ‘off’ position through 90 degrees of Faraday rotation to the fully ‘on’ position. Also, fibers conveying balanced white light may be similarly configured with Faraday Attenuator elements. The ends of fiber(s) form pixel elements on the face of the display or projection surface.

This method further applies to an implementation in which fibers are doped with gas bubbles, as in the case of standard fiber that is doped and later heat-treated by established methods to form holes, thereby resulting in a cost-effectively manufactured PCF (photonic crystal fiber). Properly doped, rarified vapor gases are found in the resultant holes may be excited by optional electrodes in an implementation of the Faraday-Stark rotation, or optically pumped to achieve other non-linear Faraday rotation effects. Optionally, gas bubbles may be introduced in the fiber perform stage by pressure injection and methods known and established in glass fabrication.

In an embodiment integrating the illumination source with an optical fiber or semiconductor waveguide, gases in such holes may be also excited by RF transmitter(s) at varying frequencies, in a modification of RF-excited illumination devices. Multiple RF transmitters, at least one each for R, G, B or C, M, Y, cause gases to emit colored light (in non-dye-doped fiber) corresponding to the varying chemical composition of the gases contained in the bubbles or cavity. A sufficient length of fiber with a sufficient density of gas bubbles or length of cavity implements an integrated source illumination scheme into the fibers themselves, and further down the length of the fiber Faraday Attenuator elements adjust the intensity of the emitted light as described above.

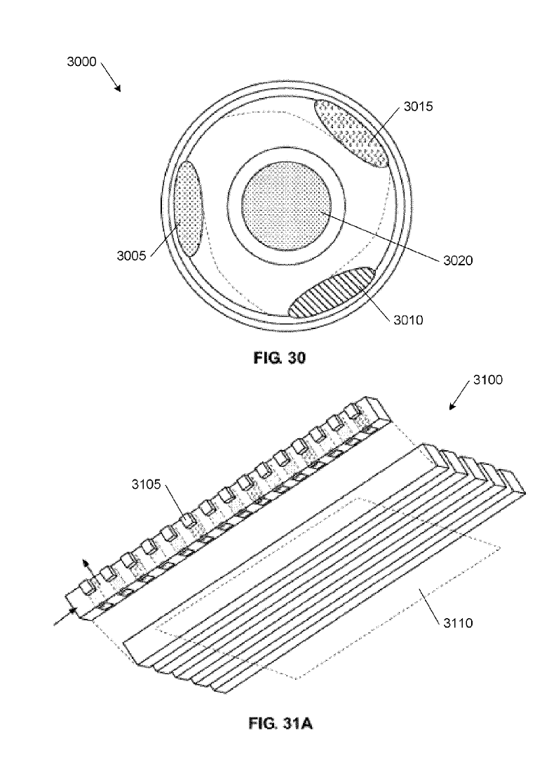

Second, there is another class of methods which combines multiple waveguiding light channels in one composite waveguide structure, such that three RGB channels are combined in one structure. See, for example, FIG. 30 below for a structure that may be implemented having three RGB channels combined in one structure.

It is an object of a preferred embodiment of the invention that it possesses an inherent flexibility, such that it encompasses and engenders a variety of implementations, including:

I. The source illumination means may be remote from the ‘Faraday Attenuator’ sequence, which may itself be remote from the display or projector surface, connected by optical fibers.

II. Light channels contain separate colors, which are intensity-modulated by Faraday-effect attenuators.

III. Light channels may be formed by optical fibers, semiconductor waveguides, or waveguiding holes formed through layered materials, each with different performance characteristics.

IV. Different forms of light channel may be combined to form the separate stages or components of different embodiments. Fiber (including PCF) may convey light from the illumination source(s) to an array of semiconductor waveguide strips or a photonic crystal array of optical channels in thin-film layers for Faraday-attenuation, and then via another array of fiber bundles to a display or projector surface.

The requirements of each general class of embodiments tend to result in slightly different configurations and choices of alternative components in the apparatus: As other classes or types of systems are developed or are needed, additional configurations and choices of components, methods, and computer programs may be implemented.

FIG. 5 is a general schematic diagram of a simplified unitary panel waveguide-based display 500 according to the preferred embodiment. Display 500 includes a casing 505 housing an illumination source 510, a switching matrix 515, and a display surface 520. Source 510 provides balanced white light or multiple channels of different colors/frequencies of a multicolor model (e.g., RGB sources). The preferred embodiment uses flexible waveguiding channels (e.g., optical fiber and the like) for source 510, matrix 515, and surface 520 integrated together as further explained below. Source 510 is either adjacent matrix 515 or faces matrix 515. When adjacent, fiber bundles convey radiation to an input side of matrix 515. Source 510 may include any of the radiation generation and characteristic/attribute control features set forth in the incorporated patent applications including polarization control.

Matrix 515 includes multiple waveguided channels for controlling an amplitude of radiation passing from its input proximate source 510 and an output proximate display surface 520. The options for the construction and function of matrix 515 are disclosed in detail herein and in the incorporated patent applications. Matrix 515 may include optional tunable filters as well as influencer elements, some of which are integrated in-line or stacked. These waveguided channels may include fibers, waveguides, or other channelized materials made from conventional materials or photonic crystal. Any necessary channel isolation features are used, including lateral offset (staggering channels in three-dimensional space to sufficiently distance the individual channels or use of shielding structures for example). Matrix 515 may include any of the radiation generation and characteristic/attribute control features set forth in the incorporated patent applications including polarization analyzers on the output. In some implementations, an overlay sheet with periodic polarizer analyzer structures is used.

Display surface 520 may simply be a continuation of the waveguide channels of matrix 515 or a separate structure. Surface 520 has a range of implementations set forth in the incorporated patent applications including faceplate formation and use and channel-end modification for example. Structures at an input and/or output of surface 520 may include any of the radiation generation and characteristic/attribute control features set forth in the incorporated patent applications including thinfilms, optical glass or other optical material or structure.

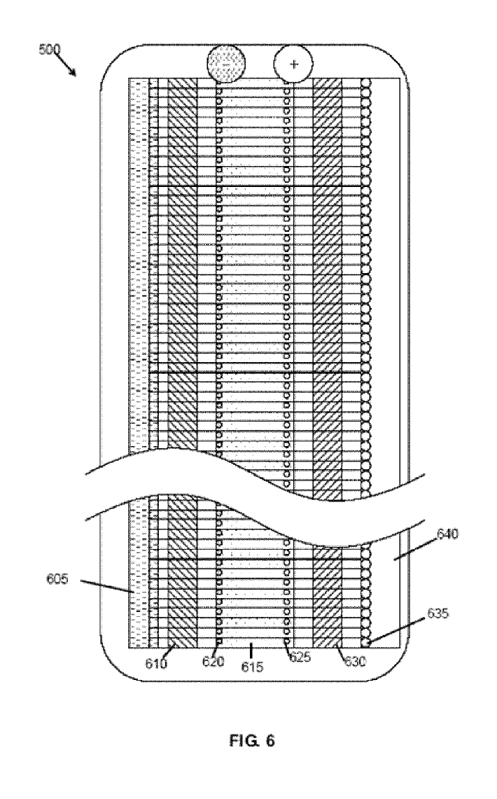

FIG. 6 is a detailed schematic diagram of display 500 shown in FIG. 5. Illumination source 510 includes a light source 605 and a polarization system 610. Matrix 515 includes an attenuator/modulator structure 615 having an integrated coilform with an input 620 and an output 625. Display surface 520 includes an analyzer 630, an optional modified channel output 635 and an optional display surface/protective coating 640.

The preferred embodiment of the Faraday Attenuator switching matrix for flat panel displays is an assembled array (e.g., textile-assembled) of integrated optical fiber attenuator devices, being in effect a form of large integrated-optics device, see for example FIG. 5 and FIG. 6.

Fiber doped with appropriate elements, combined with thin-film epitaxy of conductive material alongside or around the fiber, or the employment of conductive polymers in outer fiber cladding, and other integrated fiber fabrication methods outlined in the embodiments disclosed by the present invention, mean that the size and power consumption of fiber/component embodiments have decreased and is expected to continue to decrease further.

To reduce the impact of added diameter around the fiber or waveguide (that results from the E-M-generating element around the fiber or waveguide), as well as to reduce the amount of shielding material required between adjacent Faraday attenuator elements, adjacent fibers or waveguides may be staggered along the z-axis, so that no E-M/Faraday attenuator element is directly adjacent to another.

A class of embodiments of the present invention may be termed ‘Faraday Attenuator Array on a Chip.’ Waveguides may be formed in semiconductor material on the surface (‘superficial’) or in depth (‘monolithic’). A preferred embodiment of the present invention achieves Faraday rotation in very short distances along a waveguide, and those distances may decrease as materials performance improves. A Faraday Attenuator Array itself may, therefore, only be a few millimeters in depth.

An integrated-optics approach employing superficial waveguides may be accomplished by formation of fixed 45 degree reflection elements (or photonic crystal bends) at each pixel point. Thus, a section of extremely thin waveguide is formed in the semiconductor sandwich surface, which includes the Faraday Attenuator portion, addressed by the drive circuit, followed by the offset polarization method, and terminating in the reflection or bending means that deflects any light conveyed by the waveguide, traveling parallel to from the x-y surface of the semiconductor, to the z-axis. Thus, one semiconductor surface is fabricated and faces (is parallel to) the display or projection surface. The semiconductor is fabricated with multiple waveguides, arranged on the surface for optimal density, addressing a grid or array of 45 degree deflectors or bends that deflect light outward from the surface, forming an image.

A simple monolithic waveguide embodiment includes waveguides formed ‘in depth’ in varying regions of semiconductor material, with Faraday Attenuator components formed by semiconductor manufacturing techniques ‘in depth’ alongside the waveguide.

Single-chip embodiments will be practical for projection systems as well. In all of these semiconductor waveguide embodiments, optical fiber may be used to convey light to the waveguides from the illumination source(s), and optical fiber may be used to connect the Faraday Attenuator switching matrix (semiconductor waveguide) to the display or projector surface.

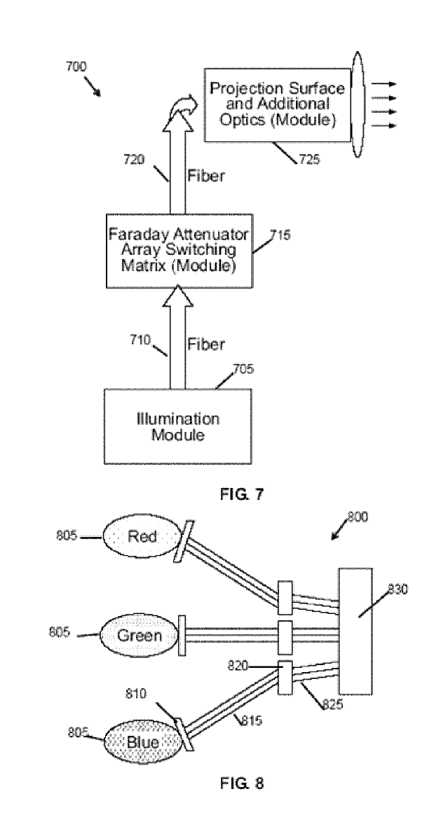

FIG. 7 is a general schematic of a componentized display system 700 according a preferred embodiment of the present invention. It is a benefit of the preferred embodiment of the present invention for the special transports, modulators, switching matrices, and other components described above and in the incorporated patent application that display system may be designed and implemented in a modular and/or component fashion. As used herein, modularity and/or componentization refers to two distinct aspects of the preferred embodiment. The first is a feature wherein elements of the system may be combined and packaged into discrete units that are inter-communicated to produce the final system. This permits greater flexibility in designing and implementing systems for the wide-range of potential uses. The second aspect refers to a feature in which the elements of the system are designed so that they are composed of nearly identical sub-elements with the element intra-communicating among the sub-elements. Of course, some systems may implement both aspects without departing from the present invention.

System 700 is an example of the first aspect having an illumination module 705 coupled by a first communicating system 710 to a modulator system 715 that, in turn, is coupled by a second communicating system 720 to an output system 725. In the present example, display system 700 is a projection system though the present invention is not so limited. Illumination module includes the radiation generating mechanisms for producing input wave_components having the desired characteristics. Illumination module 705 may include one or more radiation generating elements for producing uniform or multi-frequency wave_components. For example, illumination module 705 may produce balanced ‘white’ light or it may produce one or more sets of primary colors.

First communicating system 710 propagates the input wave_components and preferably system 710 is a simple conduit maintaining the desired characteristics of the input wave_components from illumination module 705 to modulator system 715. In some implementations, communicating system 710 may participate in producing the desired characteristics for the input wave_components at an input into modulator system 715 (e.g., amplitude, frequency, polarization type, and polarization orientation may be processed). In the preferred embodiment, communicating system 710 includes a plurality of waveguiding channels such as optical fibers for example that permit isolation and/or separation of modulator system 715 and illumination module 705. In some embodiments, radiation characteristics particular to individual wave_components do not require preservation during transit meaning that there may be a greater or fewer number of channels in communicating system 710 as compared to the resolution of picture elements (pixels) or sub-pixels of the modulating channels of modulator module 715.

Modulator system 715 receives the input wave_component(s) and modulates them as described above and in the incorporated patent applications. In the preferred embodiment, modulator system 715 generates successive series of image units (e.g., video frames) from individually controlling each of a plurality of pixels and sub-pixels. The input wave_components are mapped to appropriate ones of the modulation channels so that an amplitude of the input wave_component(s) are processed to produce varying amplitudes for a plurality of output wave_components.

Second communicating system 720 propagates the output wave_components and preferably system 720 is a simple conduit maintaining the produced characteristics of the output wave_components from modulator system 715 to display system 725. In some implementations, communicating system 720 may participate in producing the desired characteristics for the output wave_components at an input into display system 725 (e.g., amplitude and frequency may be processed). In the preferred embodiment, communicating system 720 includes a plurality of waveguiding channels such as optical fibers for example that permit isolation and/or separation of modulator system 715 and display system 725. Radiation characteristics particular to individual output wave_components require preservation during transit. Additionally, each output wave_component channel is mapped to a specific location of a final display location and communicating system 720 does not disrupt this mapping.

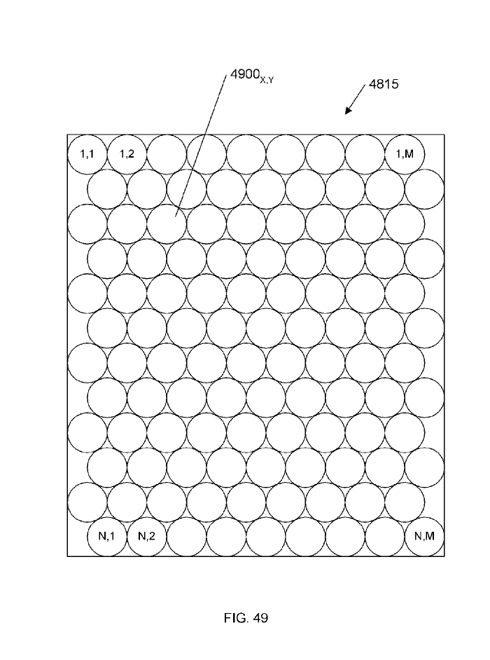

Display system 725 may be adapted for direct viewing implementations or for projection implementations in which the viewing is indirect, such as a reflected/transmitted image relative to a screen. Display system 725 processes (e.g., converts and arranges) the output wave_components into the desired output arrangement by assembling them into the desired output pattern. This output pattern is typically a matrix having a plurality of rows and columns as shown in FIG. 49). Display system 725 may include optics and other elements to additionally shape, focus, and filter the propagating radiation.

The componentization and use of the communicating systems permits separation and isolation of the other elements. Besides the increased benefits to packaging and arranging the elements into a greater range of form factors, the benefits to isolation are important in some implementations. In such embodiments, illumination module 705, modulator system 715 (e.g., a Faraday Attenuator switching matrix), and display system (e.g., a projection surface) may benefit from being housed in distinct modules or units, at some distance from each other.

Considering illumination module 705, in some embodiments it is advantageous to separate it from modulator system 715 due to heat produced by high-intensity light that is typically required to illuminate a large theatrical screen or produce an image in daylight hours or other bright locations. Even when multiple radiation sources are used, distributing the heat output otherwise concentrated in, for instance, a single Xenon lamp, the heat output may still be large enough that the separation from the switching and display elements may be desirable. The radiation source(s) thus would be housed in an insulated case with a heat sink and other cooling elements. Communicating system 710 would then convey the light from the separate or unitary source.

The separation of the switching module from the projection/display surface may have its own advantages. Placing the illumination and switching modules in a projection system base (the same would hold true for an FPD) may reduce the depth of a projection TV cabinet. Or, the projection surface may be contained in a compact ball at the top of a thin lamp-like pole or hanging from the ceiling from a cable, in front projection systems employing a reflective fabric screen.

For theatrical projection, the potential to convey the image formed by the Faraday switching matrix module, by means of optical cables from a unit on the floor, up to a compact final-optics unit at the projection window area, suggests a space-utilization strategy to accommodate both a traditional film projector and a new FLAT projector in the same projection room, among other potential advantages and configurations. The Faraday Attenuator switching matrix in projection systems may utilize any of the embodiments described herein.

A monolithic construction of waveguide strips, each with multiple thousands of waveguides on a strip, arranged or adhered side by side, may accomplish hi-definition imaging. However, ‘bulk’ fiber optic component construction may also accomplish the requisite small projection surface area. Single-mode fibers (especially without the durability performance requirements of external telecommunications cable) have a small enough diameter that the cross-sectional area of a fiber Faraday array is quite small. In addition, integrated optics manufacturing techniques are expected to improve so that Faraday-attenuator arrays may be accomplished in the fabrication of a single semiconductor substrate or chip, massively monolithic or superficial.

In a fused-fiber projection surface, the fused-fiber surface may be then ground to achieve a curvature for the purpose of focusing an image into an optical array; alternatively, fiber-ends that are joined with adhesive or otherwise bound may have shaped tips and may be arranged at their terminus in a shaped matrix to achieve a curved surface, if necessary.

For projection televisions or other non-theatrical projection applications, the option of separating the illumination and switching modules from the projector surface suggests novel ways of achieving less-bulky projection television cabinet construction.

FIG. 8 is a schematic diagram of a preferred embodiment for an implementation of a componentized display system 800 as a specific implementation of system 700 shown in FIG. 7. System 800 includes three component illumination sources (e.g., RGB sources) identified as source 805_{R}, source 805_{G}, and source 805_{B} as module 705. The first communicating system of system 800 includes an input mechanism 810 (e.g., a fiber-optic faceplate or the like appropriate to the communicating medium/channel) and a bundle of individual optical channels 815 for each color. System 800 includes a modulating assembly 820 for each color, each corresponding to modulator system 715. A second communicating system 825 includes a second plurality of individual optical channels carrying final imaging information, a bundle of such optical elements for each color. System 800 includes a final projection/display optics assembly 830 that merges the collective imaging information from the three bundles of second communicating system 825.

The preferred embodiment of the present invention includes a novel class of magneto-optic displays, implemented through optical-waveguiding structures in the form of integrated Faraday-attenuator pixel elements. The preferred embodiment of the present invention also includes a system of inventive components, and which are fabricated individually and assembled as a novel display structure through a number of novel manufacturing processes, and that the system itself incorporates novel methods of display operation.

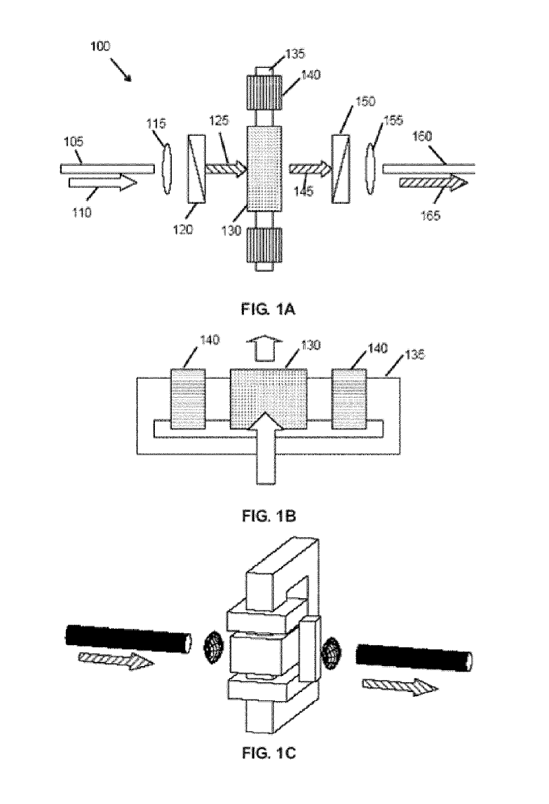

In the prior art of Faraday rotators, attenuators, isolators, circulators, and other variations of components employing the Faraday Effect for optical communications involving optical fiber, the devices are typically systems of discrete non-waveguide components that are interposed between extended optical fiber connections connecting nodes of optical communication networks (See, for example, FIG. 1C). They typically consist of crystals as the optically-active material, fabricated either as pieces of solid-growth crystal, or thin-film crystals or stacks of thinfilm crystals. Various solutions are employed to more effectively join the components to the extended optical fibers or waveguide structures in general, including involving the employment of micro-lenses and better bonding and assembling methods.

By contrast, the preferred embodiments of the present invention implements a magneto-optic display through integrated waveguiding processes and components, and includes embodiments of Faraday attenuators and Faraday attenuator processes combined with other wave manipulation processes that are realized as integrated elements of complex optical fibers.

In the prior art of Faraday rotators, attenuators, isolators, circulators and other variations of components employing the Faraday Effect for optical communications and optical switching implemented through semiconductor fabrication processes, semiconductor waveguides are the starting point for optical switching, but these structures do not suit the needs of magneto-optic displays. Therefore, the preferred embodiment implements semiconductor optical waveguide fabrication techniques in novel ways to realize novel structures that effectively realize practical semiconductor optical waveguide-based magneto-optic displays. The degree of integration achieved, as well, in these novel semiconductor optical waveguide-based Faraday devices, including implementing a Faraday attenuator device in semiconductor waveguide form, are aspects of the preferred embodiment.

Some solutions of the prior art in magneto-optic displays made attempts to implement a Faraday Rotator as an electronic semiconductor structure. This is in contrast to a realization of a paradigm shift of beginning with the waveguiding structure and implementing integration methods, including semiconductor doping, photonic crystal methods involving structural manipulation, and maximum exploitation of methods such as quantum well intermixing (QWI), to control and modulate light through the powerful method of waveguiding.

Some embodiments of the present invention, through a principle of implementing Faraday-effect based devices in integrated optical fiber and semiconductor waveguide structures, include novel combinations of both methods in single embodiments.

A ‘Unitary’ flat panel optical fiber-based display system is a preferred embodiment of the present invention. Magneto-optic displays, as ‘transmissive’ displays, incorporate a ‘source illumination unit,’ a ‘switching mechanism,’ and a ‘display surface’ where the display image is formed or projected.

This simple schematic view condenses a complex system of many components, which includes fabrication and/or an assembly process to construct any single embodiment. Referencing FIG. 5 and taking the components of the overall system in structural order, from the source illumination to the display surface, then:

I. For the ‘source illumination,’ this preferred embodiment employs a standard flat-panel display balanced white light illumination system (typically fluorescent tubes) disposed parallel to a display surface, at the relative ‘back’ of the display. But xenon, RGB lasers and any other unitary or combinatory white color-balanced source may be employed.

II. Polarization mechanisms by epitaxy of thin-film polarizer. Between the ‘input ends’ of the fibers and the illumination system is a polarization mechanism, for example:

A thinfilm polarizer is deposited epitaxially either on a sheet of optical glass between the illumination source and the switching matrix, or on the surface of the switching matrix, the fabrication and structure of which is disclosed below. Alternatively, a film coating may be applied to the ‘input ends’ of the optical fiber elements, disclosed following.

III, Optical fiber elements, integrating color selection and Faraday-attenuator variable-intensity subpixel switching, serve as the subpixel waveguide structures of the device, with the ‘input ends’ of the optical fiber elements facing the illumination system. The fibers therefore are arranged on-end, perpendicular to the light source at the relative rear and to the display surface at the relative front of the device. Thus, a display surface being formed from ‘output’ ends of the optical fiber elements.

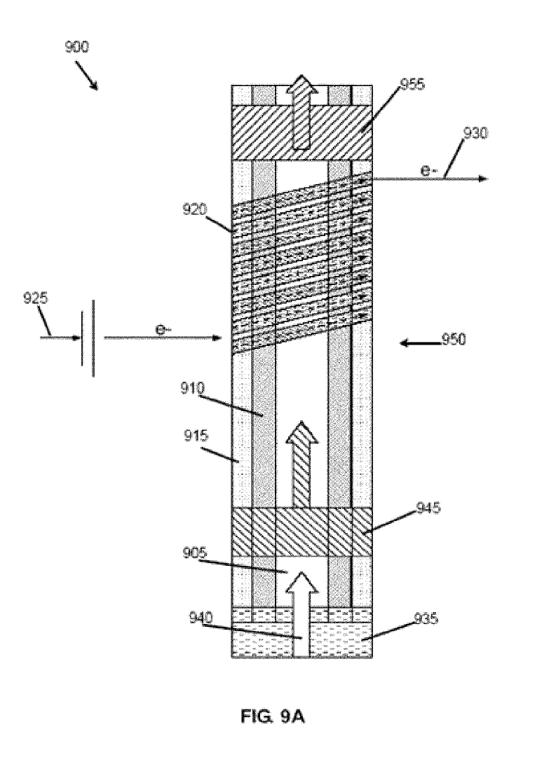

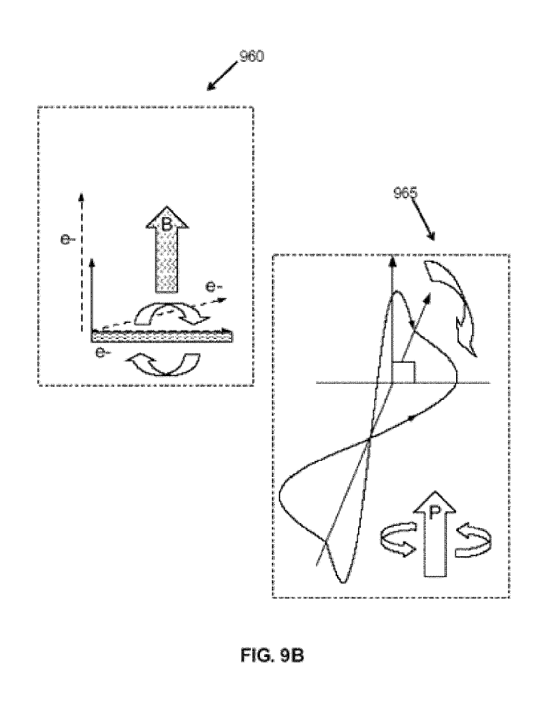

IV. Integrated Optical Fiber for the Waveguiding Structure. In this preferred embodiment, each individual optical fiber element preferably includes the integrated structure or equivalent function shown in FIG. 9A.

FIG. 9 (including FIG. 9A, FIG. 9B, and FIG. 9C) is a general schematic of a modulator 900 according to a preferred embodiment of the present invention. FIG. 9A is a preferred embodiment for a modulator 900 that includes an optically active guiding core 905 and one or more bounding regions for enhancing containment of radiation within modulator 900 as it propagates along a transmission axis. The bounding regions include a first cladding 910 and a second cladding 915 for operation as described in the incorporated patent applications. Modulator 900 further includes a coilform 920 energized by a control signal/current (shown as a signal passing from 925 to 930 through coilform 920). The energized coilform produces an influencing magnetic field for controlling a polarization rotational angle of radiation propagating through modulator 900.

Modulator 900 includes an integrated illumination source 935 in a portion of guiding region 905 and typically in one or more of the bounding regions as well. Source 935 produces a white-balanced light in response to radiofreqency stimulation of fluorescent gas microbubbles as described in the incorporated patent applications. Source 935 produces radiation 940 that is propagated through guiding region 905. A polarization system 945, also integrated into guiding region 905 and one or more of the bounding regions, converts/filters radiation 940 into a predetermined polarization type having a predetermined initial polarization angle. As the polarized radiation from polarizer 945 passes through a portion 950 influenced by the influence (e.g., the magnetic field) of coilform 920, the polarization angle is controllably set to desired angles during operation. This radiation having these desired angles produces output radiation that has an amplitude that may be modulated as the angle changes relative to a transmission axis of a second polarizer 955 near an output portion of modulator 900. FIG. 9B is an illustration pair of representative relationships for modulator 900 shown in FIG. 9A, including a view 960 and a graph 965. View 960 illustrates a close-up of a field-generating structure (e.g., a coilform) producing a field component parallel to a propagation axis of a waveguide (which is also parallel to the direction of propagation of the radiation signal (e.g., the light). Graph 965 illustrates rotation of a polarization angle 90 degrees in response to the coilform signal producing a variable magnetic field. FIG. 9C is an illustration of a representative fiber/subpixel 970 in horizontal cross-section. A first layer 975 and a second layer 980 are arbitrary sections through fiber 970. Pixel 970 includes a core, one or more bounding regions (e.g., a cladding) with at least a portion of an influencer (e.g., a coilform) integrated therein. Pathway 985 illustrates a control signal flow through the influencer to generate the requisite field with the desired characteristics.

Elements of modulator 900 thus include:

I. A fiber core, containing the following dopants added by standard fiber manufacturing variants on the vacuum deposition method: i. color dye dopant, making the fiber element effectively a color filter alight from the source illumination system, ii. an optically-active dopant, such as YIG or Tb or TGG or other best-performing dopant, which increases the Verdet constant of the core to achieve efficient Faraday rotation in the presence of an activating magnetic field. Holes or irregularities in the core structure are added by heating or stressing in the fiber manufacturing for further increasing the Verdet constant and adding non-linear effects.

Since silica optical fiber is manufactured with high levels of dopants relative to the silica percentage itself, as high as 50% dopants, and since requisite dopant concentrations have been demonstrated in silica structures of other kinds to achieve 90 degree rotation in tens of microns or less; and given improvements in increasing dopant concentrations (e.g., fibers commercially available from JDS Uniphase) and improvements in controlling dopant profiles (e.g. fibers, commercially available from Corning Incorporated), there is currently no problem of achieving sufficiently high and controlled concentrations of optically-active dopant to achieve rotation with low power in micron-scale distances.

II. An optional fiber cladding 1, doped by standard methods with ferro-magnetic single-molecule magnets, which become permanently magnetized when exposed to a strong magnetic field. Magnetization of this cladding may take place prior to the addition of the cladding to the core or pre-form, or after the fiber, complete with core, cladding and coating(s), is drawn. Therefore, either the preform or the drawn fiber passes through a strong permanent magnet field 90 degree offset from the axis of the fiber core, implemented by an electromagnetic disposed as an element of the fiber pulling apparatus. This cladding with permanent magnetic properties acts to saturate the magnetic domains of the optically-active core, but does not change the angle of rotation of the incident light passing through the fiber, since the direction of the field is at right-angles to the direction of propagation. See below for a method to optimize the orientation of a doped ferromagnetic cladding by pulverization of non-optimal nuclei in a crystalline structure.

As single-molecule magnets (SMMs) are discovered which can be magnetized at relative high temperatures, these will be preferable as dopants, allowing for superior doping concentrations and dopant profile control. Examples of commercially available single-molecule magnets and methods are available from ZettaCore.

III. An optical fiber cladding 2, doped by standard methods with an optimal ferrimagnetic or ferromagnetic material, characterized by an appropriate hysteresis curve. A ‘short’ curve, that is also ‘wide’ and ‘flat,’ would be preferred for the field-generating element. When this cladding is saturated by a magnetic field generated by an adjacent field-generating element, itself driven by a pulse from the switching matrix drive circuit, it quickly reaches a degree of magnetization appropriate to the degree of rotation required for that subpixel or pixel element for that video frame, and remains magnetized at that level until a subsequent pulse either increases (current in the same direction), refreshes (no current or a +/−maintenance current), or reduces (current in the opposite direction). The remanent flux of the doped cladding maintains the degree of rotation through a video frame without constant application of a field by the field-generating element.

Optimization of the doped ferri/ferromagnetic material may be further effected by ionic bombardment of the cladding at an appropriate process step. Reference is made to U.S. Pat. No. 6,103,010, Alcatel, in which ferromagnetic thin-films deposited by vapor-phase methods on a waveguide are bombarded by ionic beams at an angle of incidence that pulverizes nuclei not ordered in a preferred crystalline structure. Alteration of crystalline structure is a method known to the art, and may be employed on a doped silica cladding, either in a fabricated fiber or on a doped preform material. As single-molecule magnets (SMMs) are discovered which can be magnetized at relative high temperatures, these will be preferable as dopants, allowing for superior doping concentrations.

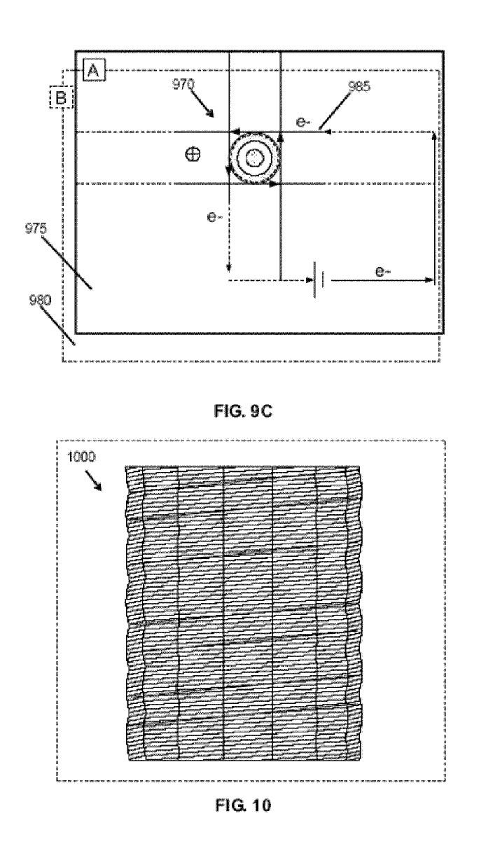

IV. A coil or ‘coilform’ structure fabricated integrally on or in the fiber element to generate the initial magnetic field, which rotates the angle of polarization of light in the fiber core and magnetizes the ferri/ferromagnetic dopant in the cladding 2 to maintain the angle of rotation through a video frame. A ‘coilform’ may be defined as a structure similar to a coil, in that a plurality of conductive segments are disposed parallel to each other and at right-angles to the axis of the fiber. As materials performance improves—that is, as the effective Verdet constant of a doped core increases by virtue of dopants of higher Verdet constant (or as augmented structural modifications, including those introducing non-linear effects)—the need for a coil or ‘coilform’ surrounding the fiber element may be reduced or obviated, and simpler single bands or Gaussian cylinder structures will be practical. FIG. 10 is a generalized schematic diagram of a waveguide 1000 including a twisted fiber implementation of a coilform.

The variables of the equation specifying the Faraday Effect (See. Eq. 1 above) being field strength, distance over which the field is applied, and the Verdet constant of the rotating medium, a flat panel display of greater depth can compensate for a coil or coilform in which the conductive material is conductive polymer, for example, and less efficient than metal wire, or in which the coil or coilform has wider but fewer windings than otherwise, or in general, if the coil or coilform is fabricated by convenient means but of less efficient operation.

Given the understanding of tradeoffs between design parameters—display depth/fiber length, Verdet constant of core, and peak field output and efficiency of the field-generating element, there are four preferred embodiments of an integrally-formed coilform to be disclosed:

Twisted fiber to Implement a Coilform (See, for example, FIG. 10).

The essence of this novel method of fabricating a ‘coilform’ around an optically-active core is to twist the fiber and coat or coat and then twist; cutting or scoring the preform to facilitate twisting, or embedding metallic wire in the preform and twisting, and the like, and by in effect twisting the fiber around its core, effectuate a ‘winding’ or spiral lines of conductive material around the core. Established commercially available processes of twisting fiber are modified to accomplish these novel methods.

Reference is made to the following representative US patents: 1. U.S. Pat. No. 3,976,356; 2. U.S. Pat. No. 4,572,840; 3. U.S. Pat. No. 5,581,647; 4. U.S. Pat. No. 6,431,935; and 5. U.S. Pat. No. 6,550,282 for related information on fiber manipulation. In conventional operation, twisting of fiber in general is most often employed to reduce attenuation or dispersion in the fiber and thus varies from the structures and methods disclosed herein.

Twisting in theory might be performed at some stage in the drawing of the fiber, as long as the temperature is suitable. A goal is to achieve a high frequency of twist per unit length, and to preserve the twist permanently preferably without requiring a ‘fixing’ outer jacket. Twisting in this instance is not performed in order to increase stress on the fiber structure. In any twisting scheme, varying viscosities of cladding layers may tend to improve the effective twisting around a relatively undisturbed core.

A result of twisting at the right temperature and choosing materials conducive to relative twisting of outer versus inner claddings and core, is twisting that specifically does not introduce stresses to a cooled crystalline structure, and thus does not introduce any additional risk of breaking or fracture.

Preferred methods of accomplishing a ‘coilform’ of continuous conductive material wound around a fiber core via twisting fiber:

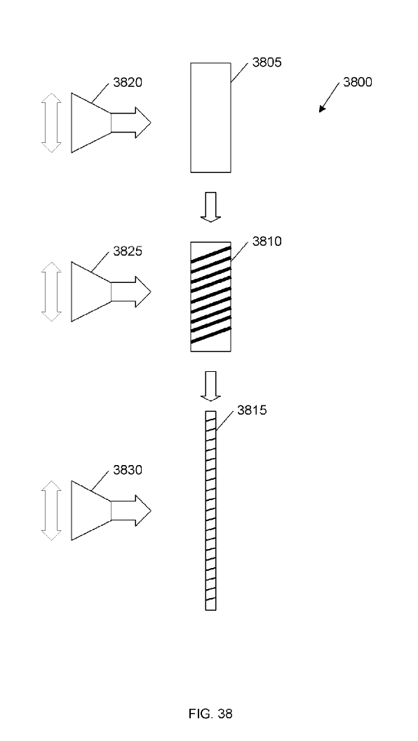

I. Coating a Preform with Conductive Material, Superficial Helical Cutting of the Preform, Twisting of the Preform or Hot Fiber During Drawing—FIG. 38 is a schematic diagram of a generic waveguide processing system 3800 for producing conformed waveguides according to the various disclosed embodiments of the present invention. System 3800 processes one or more elements from which a final waveguiding structure is produced, including for example a preform 3805, a processed preform 3810 and a produced waveguide 3815 including the desired coilform structure. System 3800 includes one or more processing stages (e.g., stage 3820, stage 3825, and stage 3830) to implement the requisite processing of preform 3805, preform 3810, and waveguide 3815, respectively. In some coilform fabrications systems 3800, depending upon the type of coilform to be installed, one or more of the stages may be omitted.

Processing stage 3820 through stage 3830 variously implement structuring and application processes for production of waveguide 3815. These processes include one or more of: (1) fiber twisting; (2) conductive material application; and (3) PCF specific implementations.

Fiber twisting has many different variations and possible implementations. In these variations and implementations, a conductive element (e.g., a metallic structure or conductive polymer) suitable for generating the requisite influence over propagating radiation in response to a control signal is applied at one or more of the stages. The conductive element may be applied before or after twisting and the conductive element may be applied on a surface or in one of the waveguiding or bounding structures. In some cases the fiber is twisted and coated with a jacket to inhibit untwisting, in other cases the fiber is coated with the jacket and then twisted. In still other cases, twisting is performed at a time when the waveguiding structure will set and resist untwisting without a jacket. For example, in the case that the waveguiding structure is produced from drawing a fiber from a preform, when the twisting is performed at a point that the fiber is above its vitreous temperature no jacket is required. In some instances, a waveguiding structure or a preform stage may be cut or scored to facilitate twisting. It is a goal of the twisting to produce a coilform that includes a high twist count per unit length sufficient for the necessary influence and to have the twist persist without a jacket. This is in contrast to conventional twisting systems for fiber that achieves improved optical characteristics by inducing stress in the waveguide through the twisting. It is one implementation of the preferred embodiments to produce various layers of the waveguiding structure with materials having different viscosities to improve effective twisting around a relatively undisturbed core. This has as one goal a desire to reduce stress to reduce risk of breakage or fractures.

The conductive element may be applied in different patterns at different times to achieve varying coilform patterns. A conductive element may be applied in linear fashion extending a length of the preform or waveguiding structure. Or, the conductive element may be applied in a spiral fashion having a particular pitch, steep, shallow, otherwise or varying. Again, the preforms or the waveguiding structure, or both, may be twisted and the waveguiding structure in the resulting configuration will have differing twist patterns for the conductive element around the core. It is the preferred embodiment for twisting that the twisting operation preferably cause the layer supporting the conductive element, whether it is the surface layer or one of the bounding regions or otherwise to twist and rotate around the core or guiding channel rather than twist the core.

The conductive element may be applied as a discrete structure or it may be applied as a conductive coating and then selected areas of the coating are removed such as by etching, lathing, masking or other process to leave a particular linear, spiral or other pattern on or in the preform or waveguiding structure. In other respects, this structure may also be twisted as discussed above. The following are specific examples of preferred embodiments for the general class of twisting implementations.

Additionally, as in the fabrication process known in the manufacture of photonic crystal fiber, solid or capillary glass may be combined surrounding an inner cladding and core or core only. These multiple thin rods or capillary glass (in the case of PCF variations on the present method of fabrication of the present feature of the preferred embodiment of the present invention, see further disclosure elsewhere herein and in the incorporated applications) are previously metallized as described in regard to the conductive strip version, so that in the twisting of the preform or in the drawing when the temperature is suitable, the multiple thin surrounding fiber twist together as a coilform around the core.

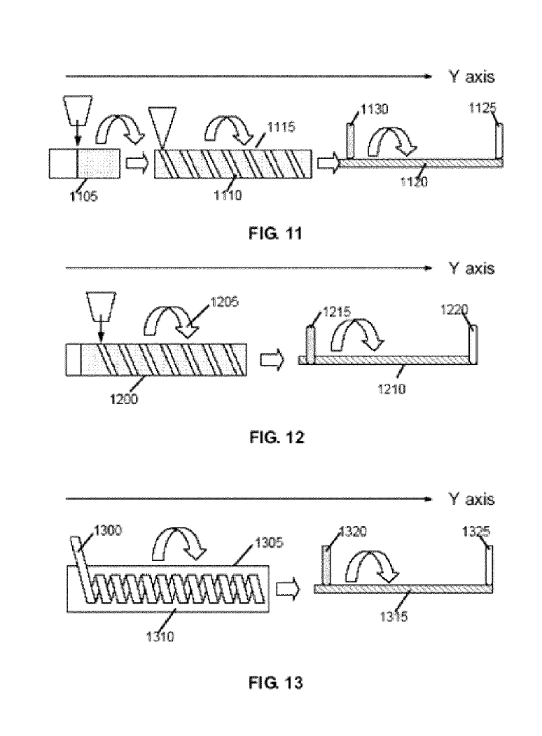

FIG. 11 is a schematic diagram of a first specific implementation of the system shown in FIG. 38 including a conductively coated preform and a superficial helical cut. This first example includes coating a preform 1105 with conductive material and provides for superficial helical cuts with twisting performed on the preform or hot waveguiding structure during drawing. Preform 1105 is coated with metal powder or other conductive coating (metallic soot and the like) by standard vacuum deposition or other methods common to the art of fiber fabrication. Then a helical cut 1110 is made on a portion 1115 of preform 1105, preferably by rotation of the preform and precessing a lathing implement or precessing the preform relative to a fixed lathing implement (precession advances in the Y-axis). The preform is then drawn to produce a waveguiding structure 1120 and twisted using a first yoke 1125 and a second yoke 1130 while the material is above its vitreous temperature, such that the twist persists after cooling without need for a confining jacket material. In the preferred embodiment, the yokes are oppositely twisting structures to improve the number of twists per unit length. The result is a coilform of conductive material disposed on the surface of waveguide 1130, as an outer cladding layer. A spiral or helical ridge is formed by the process, with a conductive layer of a thickness increased by twisting, with the twists separated by subduction through the twisting against the helical cut in the preform.

Reference is made to U.S. Pat. No. 3,976,356, disclosing a method for fabricating a helical track waveguide on the surface of the glass fiber. A helical cut is made in a preform and another preform of differently constituted material is inserted in the slot, and then the combined preform is drawn and twisted as a fiber.

An alternative to a coated preform which is cut with a helical track, is a partially coated preform that is twisted without a facilitating helical cut; that is, coated with a strip of conductive material parallel to the axis of the fiber (metallic powder annealed by heat of the silica, or soot sintered on preform), which, after the preform is twisted and the drawing fiber is twisted while hot, a separate spiral of conductive material around the core is formed.

FIG. 12 is a schematic diagram of a second specific implementation of the system shown in FIG. 38 including a partially conductively coated preform without a superficial helical cut. This second example is an alternative to the coated preform which is cut with a helical track as shown in FIG. 11, This second embodiment includes a partially coated preform 1200 that is twisted (shown by arrow 1205) and precessed in the direction of the Y-axis without a facilitating helical cut. A tool removes some of the coating to leave a helical conductive strip that wraps around the waveguiding structure. Preform 1200 is then drawn to produce a waveguiding structure 1210 and twisted using a first yoke 1215 and a second yoke 1220 while the material is above its vitreous temperature, such that the twist persists after cooling without need for a confining jacket material. In the preferred embodiment, the yokes are oppositely twisting structures to improve the number of twists per unit length. The result is a coilform of conductive material disposed on the surface of waveguide 1210, as an outer cladding layer. The twisting of waveguide 1210 and the longitudinal compression of the helical strip form the desired conductive coilform structure.

A variant on this alternative is a precision coating of the preform with metallic powder is implemented by ‘painting’ a spiral stripe of powder which then anneals from the temperature of the heated preform on the preform; alternatively, a preform which has been coated evenly across its surface may have a thin line ‘cut’ in the powder as it begins to anneal, forming a spiral by removal of material. The self spiral is accomplished by rotating the preform about its axis and translating the preform at the same time with respect to the precision powder injector nozzle. A thin annealed-powder spiral around the preform is preserved in either case as the fiber is drawn therefrom. The number of ‘turns’ per length of fiber will not be as large, on average, as when the preform itself is twisted.

Additionally, as in the fabrication process known in the manufacture of photonic crystal fiber, solid or capillary glass may be combined surrounding an inner cladding and core or core only. These multiple thin rods or capillary glass (in the case of PCF variations on the present method of fabrication of the present feature of the preferred embodiment of the present invention, see further disclosure elsewhere herein) are previously metallized as described in regard to the conductive strip version, so that in the twisting of the preform or in the drawing when the temperature is suitable, the multiple thin surrounding fiber twist together as a coilform around the core.

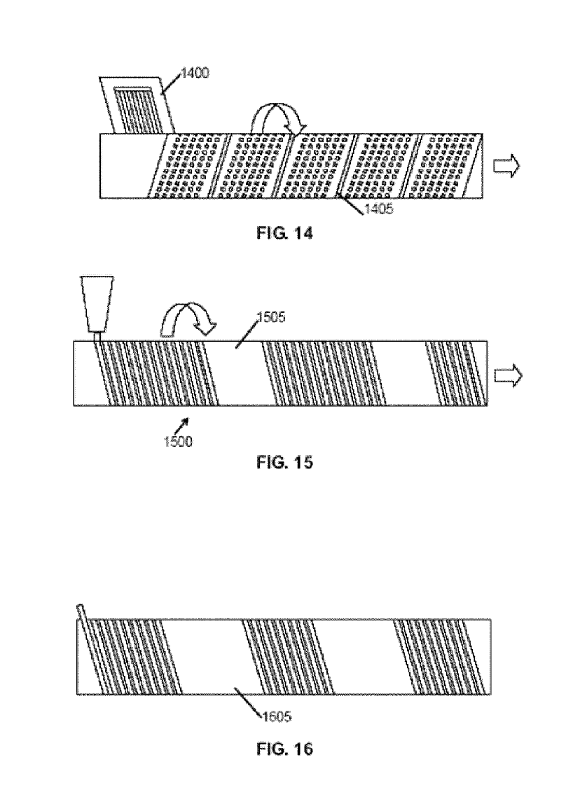

FIG. 13 is a schematic diagram of a third specific implementation of the system shown in FIG. 38 including a conductive element 1300 embedded/applied into/onto a preform 1305. This third embodiment provides for conductive element (e.g., a wire, conductive polymer and the like) 1300 to be embedded in or disposed within a preform 1305 as the preform rotates and precesses along the Y-axis (which as depicted in FIG. 52 is downward in the drawing tower) to produce a longitudinally extending pre-coilform structure 1310. Conductive element 1300 is fed into or laid upon or otherwise disposed in connection with preform 1305. Rotation of preform 1305 (and any necessary precession along the Y-axis) containing conductive element 1310 produces the initial helical structure within preform 1305 prior to drawing. Preform 1305 is then drawn to produce a waveguiding structure 1315 and twisted using a first yoke 1320 and a second yoke 1325 while the material is above its vitreous temperature, such that the twist persists after cooling without need for a confining jacket material. In the preferred embodiment, the yokes are oppositely twisting structures to improve the number of twists per unit length. The result is a coilform of conductive material disposed within waveguide 1315 or on the surface of waveguide 1315. The twisting of waveguide 1315 and the longitudinal compression of the helical conductive element form the desired conductive coilform structure.

A wire of suitable thickness is embedded in the preform, between the inner claddings and an outer cladding. It is not preferable that this be composed of glass that later can be dissolved chemically. Reference is made to U.S. Pat. No. 6,431,935; it is a drawback of the method disclosed that a process of wet-solving must be employed to the fiber after fabrication to expose the conductive element (in this case, a straight wire) to contact. The process is more costly and more difficult to control, and introduces questions of the strength of adhesion of the wire to the fiber after solution of the soluble glass layer.

Other implementations of wires embedded in fiber are known, including an embedded wire to serve as an electrode in a tunable grating application, including as disclosed by Fujiwara et al. in an article entitled ‘UV Excited Poling and Electrically Tunable Bragg Gratings in Germanosilicate Fiber.’ In this version, a hole is left in the preform and remains after drawing, so that a wire may be inserted in the fiber.

The preform is then rotated as the fiber is drawn, resulting in a twist around the core; the wire, carried by the twist, thus forms a spiral. Depending on the tightness of the twist, an actual winding may be effected. But the necessary continuous track of conductive material disposed in repetitive strips at right angles to the axis of the fiber is achieved.

In the present variant of the ‘embedded wire’ approach, the outer glass cladding is not required to be a soluble glass: electrical contact with the winding may be provided at the ends of a fiber attenuator segment.

Contact Between ‘Interior’ (Cladded/coated) Layers and Outer Layers, to Complete Requisite Circuit Elements:

However, preferably, contact is made in this case and all others in which the coilform is ultimately an interior element of a multi-cladding/coated fiber, a known method is commercially available for the formation of micro-structure air-holes in a fiber structure, in this case formed perpendicular to the axis of the fiber, and formed in the heating of a fiber which has a thin outer cladding that is constituted such that it separates in thin strands, exposing the next (interior) cladding to the air. Reference U.S. Pat. No. 6,654,522 reflecting commercially disclosed methods (Lucent Technologies).

A novel element is that the capillary air holes, already present in the cladding at the preform stage, later, due to the thinness of the cladding, collapse with brief but sufficient intense heating and brief but energetic stretching, such collapse exposing the next cladding layer to an ovoid hole. A temperature, heating time, and composition of this cladding must be chosen such that the inner-structure is substantially unaffected.

In such a process, the next layer, which in the present case includes the coil form, is protected over the majority of its area by the cladding, but is air exposed at points by micro-structured ovoid holes. Other methods of applying a substantially coated but perforated layer, whether a coating or cladding, are known to the art. These methods may be implemented advantageously in the preferred embodiments of the present invention.

When such a treated material is then coated in bands, spots, or over increments of the fiber as a cylinder, by a conductive liquid polymer sol and cured, contact is formed where the conductive polymer has penetrated to the coilform layer.

FIG. 14 is a schematic diagram of a fourth specific implementation of the system shown in FIG. 38 including a thinfilm 1400 epitaxially wrapped around a waveguide channel. In this preferred method of accomplishing a coilform around a waveguide or preform (for the rest of the discussion of FIG. 14 waveguide shall refer to both waveguide and preform unless the context clearly indicates otherwise), a coil-producing conductive pattern is formed on film (the conductive element are not to scale and are adapted to produce the desired coilform structure after application). Thinfilm 1400 is wound and bonded as a printed strip or tape, epitaxially around the waveguide and in the preferred embodiment the conductive ‘lines’ contact the waveguide. A gap between successive longitudinal wraps is exaggerated to depict the thinfilm wrapping.

II. Fiber wrapped Epitaxially with a Thinfilm Printed with Conductive Patterns to Achieve Multiple layers of Windings—In this preferred method of accomplishing a coilform around a fiber, a thinfilm is wound and bonded as a printed strip or tape, epitaxially around the fiber.

A polymer thinfilm is formed either by electrostatic self-assembly (ESA) of nanoparticles (commercially available from Nanosonic, Inc. of Blacksgurg, Va.) or by standard polymer fabrication methods known to the art, and then either printed as noted below, and then removed by epitaxial liftoff from the forming bed, or by other standard methods of convenience, or formed and taken up on a spindle and then redeployed under tension and elements are printed or deposited and otherwise fabricated as noted below.

The thinfilm is first imprinted or electrostatically formed (ref. Nanosonic) with a series of conductively connected parallel lines disposed at right angles with respect to the edge of the film, and ultimately with respect to axis of a fiber around which the thinfilm is later wrapped. Conductive polymer, to enable wrapping, or nanoink printed material is preferable for the deposited structures. After the thinfilm is imprinted or deposited with conductive patterns by any of the established semiconductor patterning methods, or by newer methods such as dip-pen nanolithography, an intervening second layer is added epitaxially or deposited on top of the printed face of the thinfilm, such second layer, just as the thinfilm itself, being of appropriate electrical insulating value but also of appropriate magnetic permeability. The two layers of film or film and coating thus form a two-ply structure.

Such films may be fabricated in large batch runs and after printing wound up on rolls. Then when they are to be wound onto fiber, fiber is unspooled in increments, while a filmstrip is on a spool held in an armature next to the fiber. Adhesive for epitaxial winding is applied by common methods, aerosol or liquid or activated dry material, and the leading edge of the film, with the backing making contact, is adhered to the fiber by motion of the armature.

To provide selected conductive points from the outside of the thin film to the inside, the film may be perforated selectively with micro-perforations, achieved by mask-etching, laser, air-pressure perforation, or other methods known to the art before the printing or deposit of the conductive patterns. Thus, when the conductive material is deposited, in those regions with appropriately-sized perforations, the conductive material may be selectively-accessed or contacted through the perforations. Perforations may be circular or possess other geometries, including lines, squares, and more complicated combinations of shapes and shape-sizes.

Optionally, at the leading edge of the film strip, the film strip is slightly wider for a small distance, so that after winding around the fiber, the extra width functions as a tab and may be folded ‘up’ to provide for better contact on the innermost layer of the winding structure formed by the wound film.

Then either the fiber is rotated, effectively drawing the filmstrip off the spool, or preferably the spool is itself mounted on a cam-driven spindle that revolves around the fiber, effectively winding the film strip around the fiber.

By this method, multiple thinfilm layers of electrical winding patterns may be wound around a fiber without increasing significantly the diameter of the resultant integrated device. The result is a structure of very thin and tightly spaced conductive bands not only wound once, for a given length ‘d’ (Ref. Eq. 1 above) of a fiber component, but wound around the fiber again and again x times, the equivalent of x metallic coils wound similarly around the fiber over ‘d.’

Good electrical contact points for the coilform may be found via selected perforation areas, such that a ‘bottom most’ of the winding sections has a ‘clear’ (no overlapping windings from multiple wrapping layers) conduit through perforations to the outer layer. Then, when a conductive liquid polymer solution is applied to the bottom section over the perforation region, the conductive solution will penetrate and contact the innermost layer. Upon UV curing, the contact structure is solidified.

Optionally, at a ‘tab’ of film folded up at one edge, providing a contact point for the innermost part of the thinfilm tape where the winding begins, (shown in the FIG. 14 at the input end of the fiber element), and then at the terminating edge of the wound film and the final conductive strip printed on the thinfilm, at the output end of the fiber element.

In regards to the circuit formed by any alternative method, current enters the thinfilm coilform at the tab or through the perforation-depth contact, is distributed to the parallel conductive lines on the bottom layer and which are printed close together on the whole length of the thinfilm tape wrapped around the fiber. Current circulates around the fiber as many times as the thinfilm tape is wound, finally exiting the thinfilm coilform structure at the contact point on the outermost edge of the thinfilm tape, near the ‘top’ or output end of the fiber component, as shown.

A variation of this method is to wind the tape itself in a spiral around the fiber, achieved by precession of a cam-driven winding spindle or of an armature holding the fiber in tension from the spool. While greater field strength from multiple layers wrapped in place is lost, thickness from the multiple layers of tape is reduced.

It should be apparent that other electronic devices may also be formed through layers of thin-films, given this novel method additional utility to the embodiments of the present invention and even wider application outside the field of the invention.

III. Printed by Dip-pen Nanolithography on Fiber to Fabricate a Coilform—FIG. 15 is a schematic diagram of a fifth specific implementation of the system shown in FIG. 38 including a disposition of a coilform 1500 on a waveguide channel using dip-pen nanolithography. This preferred method is a novel application of established dip-pen nanolithography processes, as is commercially available from a US company (Nanolnk, Inc.) According to the present embodiment of the invention, a nanotube nanolighographic device is employed to stereo-lithograhically print winding structures on fiber in bulk. The nanolithographic device is mounted on a stable platform, while the fiber (and spool, when necessary) is mounted on a spindle apparatus that rotates and precesses the fiber past the dip-pen nanolithographic device. Precise precession and rotation as controlled by commercially available machining systems ensures precise formation of the wire-like winding structures. Commercially available equipment from Nanolnk makes possible extremely fine structures. It should be apparent that this novel application of the commercially available dip-pen nanolithography has additional utility to embodiments of the present invention. A periodic gap 1505 allows for cleaving a continuous waveguide into waveguide segments, each provided with a fully functional coilform structure. Gap 1505 is not necessarily to scale and as disclosed above and in the incorporated patent applications, additional in-waveguide structures may be integrated into the space to form large numbers of uniform and fully independent waveguiding components. Further, coilform 1500 is representative with the specific parameters of coil count, density, material and other composition is determined by any specific implementation. As discussed elsewhere, in some implementations a discrete coilform structure may not be necessary as a Gaussian cylinder (e.g., a fully conductively coated/metallized waveguide portion) may be used as the coilform.

IV. Wound with coated/doped glass fiber, (alternatively, conductive polymer, metallically coated or uncoated, or metallic wire)—FIG. 16 is a schematic diagram of a sixth specific implementation of the system shown in FIG. 38 including a disposition of a conductive element on a waveguide channel using a wrapping procedure. In this preferred method, an all-waveguide winding structure is also realized. For example when the waveguide is an optical fiber—a primary optical fiber drawing tower (shown in FIG. 52), fabricating the primary waveguiding channel as specified herein, is combined in a manufacturing process with a second glass fiber drawing tower (also of the type shown in FIG. 52), which draws the winding fiber.

In this preferred method, an all-fiber winding structure is also realized. A primary optical fiber drawing tower, fabricating the primary waveguiding light channel fiber as specified herein, is combined in a manufacturing process with a second glass fiber drawing tower, which draws the winding fiber. A hot filament of coated (or coated and doped) glass fiber pulled from a second drawing tower, of substantially smaller diameter than the primary optical waveguide fiber including core and claddings, is wound around a hot primary optical fiber being pulled from a primary drawing tower. The preform for the secondary, winding fiber is coated with metallic powder or soot using standard fiber fabrication methods (or coated and doped with conductive dopants), and then drawn.

After the hot end of the secondary fiber is attached to the primary fiber by heat adhesion of the silica. The primary fiber fabrication apparatus is then rotated such that the secondary fiber forms a tight winding around the primary fiber. Winding while the fibers are both of sufficiently high temperature makes possible a new unitary all-fiber structure implementing a conductive winding around the optical waveguide fiber. Long batch runs result in bulk quantities of wound fiber prepared for later assembly into the final switching matrix.

Alternatively, conductive polymer filaments, which may in addition be metallized by coating with metallic powder or soot and annealing in the heating of the preform and drawing of the fiber, may be wound around the optical waveguide fiber and bonded using an adhesive coated on the optical waveguide. Polymer filaments may be fabricated with extremely small diameters and have an advantageous Young's modulus. Similarly, metallic wire may be wound around the optical fiber. While conductivity is greater, there are greater constraints in terms of wire diameter and flexibility.

V. Combinations of I. Through IV—It should be apparent that a range of methods for incorporating a coilform or coil as an integral fiber component are not mutually exclusive, but may be used in combination to achieve a desired level of performance. In general with regard to the combination of dopants and processes involved in fiber fabrication disclosed or referenced throughout by the present, co-doping is preferable to introduce multiple dopants in a single process, although MCVD (modified chemical vapor deposition), for instance, may be less suitable for some requirements than, for instance, SOD (solution doping), and thus doping may be achieved by different successive processes.

VI. Periodic Twisting, Wrapping, Printing, and the like—To allow gaps between the coilform structure on bulk runs of fiber manufacture, so that in cleaving segments of fiber a ‘head’ and ‘tail’ of fiber without the coilform remains, the twisting, wrapping, printing etc. of the coilform may be periodic. For instance, as the fiber is drawn and twisted according to the variants disclosed herein, twisting is performed for a precise length of fiber and then stops, but the fiber continues to be drawn in the drawing tower, until a gap of desired length is reached, and twisting commences again. Untwisted conductive material then provides input and output contact points (see inter and intra-cladding contact methods disclosed elsewhere herein). Additional structures that may be fabricated integrally in the fiber, including transistor structures (also as disclosed elsewhere herein), thus may be fabricated in the ‘clear’ input section of fiber that has no coilform structure also fabricated integrally in the fiber.

Wrapping or winding the fiber may be similarly intermittent, according to the details of these methods disclosed elsewhere herein; after the precise length of winding is effected, rotation of the fiber ceases (or almost ceases) such that the conductive filament adheres to the primary fiber but parallel (or almost parallel, executing a portion of a winding over the much larger length of the gap). In the case of a printed film wrapping the fiber, the film wrapping may be continuous, but the printed coilform itself an intermittent pattern.

VII. Optional Coatings and/or Cladding Over the Coilform—After any one or combination of methods disclosed is completed, protective coatings may be applied, for instance, to a thin-film wrapped fiber to protect the film.

In addition, fibers with integrated coilforms and other disclosed functionality, structures, and characteristics, through doping, addition of gas bubbles, twisting, winding, wrapping, heating to introduce holes, irregularities, gas bubbles, and the like, exposure to transverse laser light to alter a photoreactive dopant, may, after fabrication, coated or uncoated, be re-introduced along with a cladding material and drawn as part of a new preform. Such cladding itself may be doped and processed as specified in the various disclosures. A fabricated silica-based fiber may also be combined with other fibers and preform material in a new preform stage and be braided or combined as a larger complex fiber, cable or textile structure. (Reference U.S. Pat. No. 6,647,852, Continuous Intersected Braided Composite Structure and Method of Making Same).

Much as in the first implementation of the transistor as an integrated semiconductor device, the integrated electro-photonic optical fiber device is a paradigm change from conventional Faraday attenuators. Reference is made to U.S. Pat. No. 6,333,806.

Optical fiber may be regarded as a self-substrate, in which may be implemented solid state electronic and photonic components. The novel methods and structures disclosed by the novel fiber components of the embodiments of the present invention represent a paradigm shift implementation of the concept of fiber as computing component and devices. One example out of many is the significance of the implementation of a ferri-ferromagnetic dopant in a fiber cladding, which effectively implements a fiber-based memory device that preserves a logic state.

The ability to manufacture at high volume and with low defects a structure that implements both semiconductor doping methods and waveguiding structures, including differential refraction internal reflection and photonic bandgap confinement, represents an alternative opto-electronic or photonic paradigm for optical switching systems, and ultimately, opto-electronic integrated computing. Ultimately, the combination of electronic band-gap and photonic bandgap structures, involving manipulation of quantum holes, macro-scale holes and defects, dopants exploiting silicon, germanium, metallic valence replacement strategies, by low-cost, high volume, dense systems suggests a broad-based alternative to wafer-based semiconductor architectures. As such, the novel components disclosed herein have broad application.

Further elaboration of the potential of the general switching paradigm herein disclosed is included in the disclosure of the three-dimension textile lattice assembly methods preferred for the manufacturing of the switching matrix of the embodiments of the present invention, and in the disclosure of methods of integrating transistors in an ‘active matrix’ switching paradigm in the fiber structures themselves.

Switching Matrix as Woven Textile Structure—In this preferred embodiment, the optical fiber elements are held and assembled as elements of a textile structure that forms the ‘switching mechanism’ or matrix. The switching structure, holding and addressing the optical fiber elements, is therefore disposed as a planar surface parallel to the illumination system at the relative rear of the device and also parallel to the display surface at the relative front of the device.

Jacquard-loom Type Textile Manufacturing Process Detailed—The textile-type assembly of the optical fiber elements is accomplished through a modern, precision Jacquard loom textile manufacturing system (commercial example reference, Albany International Techniweave). The steps are described as follows. (A switching matrix possesses ‘x’ addressing elements and ‘y’ addressing elements as follows.)

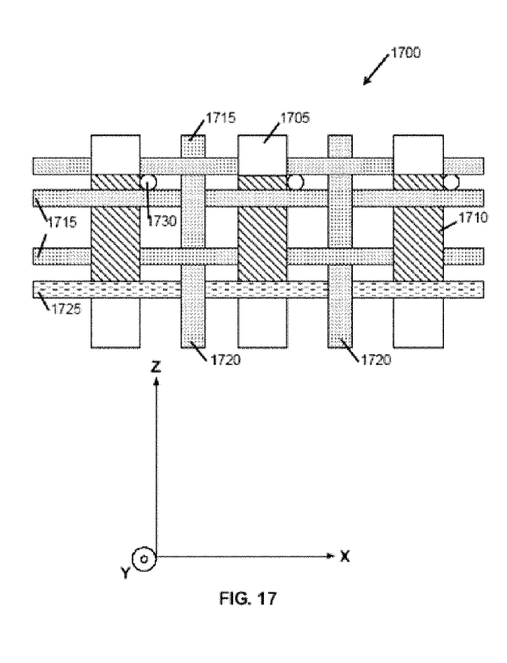

FIG. 17 is a schematic diagram of an ‘X’ ribbon structural fiber system 1700 according to a preferred embodiment of the present invention. Fiber system 1700 includes a plurality of modulator segments 1705, each having an integrated influencer element 1710, for controlling an amplitude of individual channels as described herein and in the incorporated patent applications. In addition, system 1700 includes a plurality of structural elements 1715 and/or spacer elements 1720 as further described below. System 1700 further includes a conductive ‘X’ addressing filament 1725 and a conductive ‘Y’ addressing filament 1730 for an X/Y matrix addressing system. The conductive elements may be metal or conductive polymer or the like.

I. ‘X’ Ribbons: Structural Fiber Parallel to Display Face, Woven to Hold Optical Fiber Segments and Parallel Spacer Filaments; Optical Fiber Components Whose Output Ends Point to/form Display Face; Also incorporating a Conductive Polymer Filament Implementing the ‘X’ Addressing.

With fibers and filaments prepared in a precision, three-dimensional Jacquard loom apparatus, a ribbon is woven as illustrated herein. The ‘vertical’ optical fibers, in color batches and fabricated in bulk production runs according to the methods disclosed above, (along with optional ‘spacing’ filaments, also vertical), are set to be interwoven with structural fibers, indicated at a and b—depending on structural strength requirements, a minimum of about four microfibers, two each at the top and bottom—one of the lower of which will be a conductive polymer microfiber that accomplishes the ‘x’ addressing of each optical fiber. Other conductive filaments or wires are possible, although not optimal. Optionally, the conductive filament or fiber may be in addition to two purely structural fibers.

The need for the optional ‘spacing’ filaments is determined by the relative diameter of the optical fiber segments as compared to the diameter of a subpixel, which is in turn determined by the size of the display and its resolution. A fiber diameter significantly smaller than the subpixel diameter will require at least one or more spacing filaments, unless, as is detailed below, multiple fibers are employed per subpixel, or other methods are employed, also detailed below.

It is a virtue of the textile fabrication paradigm that adjacent Faraday attenuator/subpixel/pixel elements may be ‘vertically’ offset from each other, as well as separated by spacing elements, as an additional way to isolate elements electrically and magnetically from each other, should such isolation be desirable.

In the case of both ‘x’ and ‘y’ addressing fibers, good contact is made at the relative ‘top’ and ‘bottom’ (near the output and input ends) of the fibers, as illustrated. The coilform or coil or other field generating element having provided superficial contacts on the fiber.

As each fiber will function as a subpixel, and each ribbon is woven with dye-doped fiber of one color only, the number of vertical optical fibers will determined by resolution demands of the display they are specified for, and could range from hundreds to multiple thousands.

After weaving of the structural fibers and the addressing fiber, leaving a space between the upper and lower fixing points in the ribbon, a fixing adhesive may be applied to the ribbon before cutting. The structural and addressing fibers are hooked in removable tabs in the frame to either side. The ribbon is then tightened appropriately. Leaving spacing between ribbon rows, the process may be repeated, resulting in a long woven fabric run, that can then be de-loomed at a length optimal, as determined by textile manufacturing standards. The resulting fabric is taken up on spindles in a standard textile manufacturing manner. Once rolled onto spindles or holding frames, the loomed fabric is then moved to another textile handling apparatus in which the ribbons are cut from the long-fabric bolt. The vertical optical fibers and spacing fibers are cleaved above and below. The cleaving apparatus may also first apply heat to what will be the output ends of the optical fiber elements, and combined with the exertion of tension on the fibers by the loom apparatus as heating and softening of the fiber is effected, will result in an efficient stretching and modulation of the shape of the fiber ends. Thus a taper or a compression when the cleaving apparatus has a first heating bar constructed with rollers as the contact points, rotating at right angles to the axis of the fibers, then the cleaving apparatus may move parallel to the axis of the fibers and thus accomplish twisting or abrasion of the fiber ends as well. Other similar mechanical pressure, heating, and forming methods may obviously be applied to alter the shape and structure of the fiber ends before cleaving, to achieve increased scattering and dispersion characteristics at. Once cleaved, the resulting ribbon may be taken up on spools.

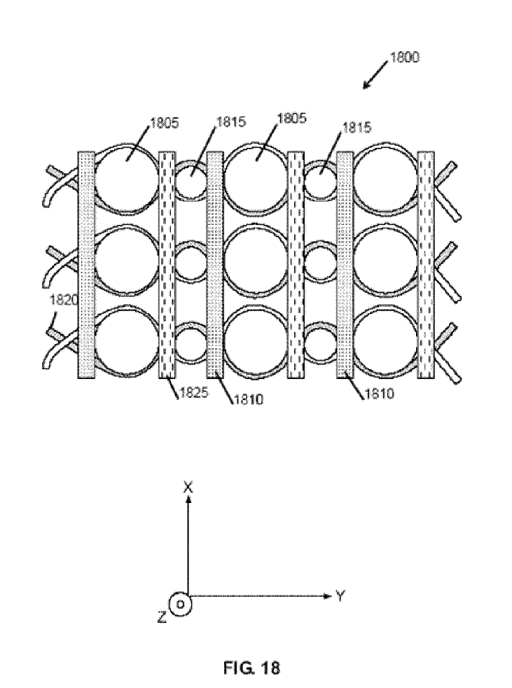

FIG. 18 is a schematic diagram of a ‘Y’ ribbon structural fiber system 1800 according to a preferred embodiment of the present invention. Fiber system 1800 includes a plurality of modulators 1805 with one or more interposed first structural filaments 1810 and one or more interposed structural filaments/spacers 1815. One or more ‘X’ addressing ribbons 1820 as shown in FIG. 17 are woven among the modulators 1805 and filaments/spacers 1815 as shown to provide the ‘X’ address input for modulators 1805. A conductive ‘Y’ filament 1825 completes the X/Y matrix addressing. Combination of fiber system 1700 and fiber system 1800 produces a woven switching matrix.

II. ‘Y’ Fibers/filaments forming another ‘ribbon,’ but Woven At Right Angles With and Through ‘X’ Ribbons, Including Structural Filaments and Conductive Polymer Filament Implementing the ‘Y’ Addressing, forming a resulting textile matte.

The ‘x’ ribbons, composed of ‘lengthwise’ structural filaments and an ‘x’ addressing filament, as well as hundreds or thousands of ‘vertical’ single-color dye-doped and fabricated optical fiber Faraday attenuator elements, are next set in another precision Jacquard loom machine, with hundreds or thousands of ribbons ultimately loomed into what will be the finished textile-woven switching matrix.

Interwoven now with the parallel ribbons are ‘Y’ structural filaments and a ‘Y’ addressing filament, as shown, which, as woven into the ‘x’ ribbons, form an equivalent ‘y’ ribbon. The optical fiber axis of the ribbon (their width) is set perpendicular to the plane of the ‘y’ filaments. Precision Jacquard looming allows for penetration of the gap between the upper and lower reinforcing structural filaments of the ‘X’ ribbon, such that the thin ‘x’ ribbon forms the depth of a textile ‘matte’, the surface of which consists of the projecting ‘output’ ends of the optical fiber Faraday attenuator elements. Parallel to this ‘surface’ are both the structural and ‘bottom’ addressing filaments of the ‘X’ ribbons, and the structural and ‘top’ addressing filaments of the ‘Y’ grid.

A Removable ‘display frame’ from Jacquard Loom that Becomes the Structural Frame of the Flat Panel Display and fixes the addressing filaments to the drive circuit, and which holds overall woven structure of switching matrix. Self-fixing by weaving at sides also enables implementation of individual hooks or fastening apparatus at the ends of each ‘x’ and ‘y’ row of the textile matte. Once woven and tightened, the removable frame for the textile matte is removed from the loom. This frame will be used to fix the textile switching matrix matte in the final display case. The frame may be rigid or flexible, solid or textile, but is either fabricated with addressing logic (e.g., transistors) or conductive elements that contact each ‘X’ and ‘Y’ row and column. In addition, looming on the edges of the matte self-fixes the matte, by standard means of textile manufacturing, such that the matte may optionally be removed from the loom intact, with hooks or fastening elements fixed at the sides for each ‘X’ ribbon and ‘Y’ ribbon. Then the matte may be hooked or fastened by mans of these hooks or fastening apparatus into a display case structure, where the hooking or contact points for the ‘x’ and ‘y’ addressing filaments may make contact with the driving circuit for the display device. Once removed, or as may be convenient according to the numerous options in textile manufacturing, while still in the loom, the resulting textile matte may be saturated with a sol, such sol being dyed black to accomplish a black matrix, and UV cured. The sol then seals the textile lattice. A sol may chosen to result in a flexible but sealed textile matte, or a rigid or semi-rigid structure, and with appropriate insulation and/or shielding properties. Once cured, additional sol or liquid polymer may be spread over the cured, sealed textile matte/switching matrix surfaces, top and bottom in turn, if necessary. As the optical fiber elements of the output and input ends will extend above the horizontal filaments fixing and addressing them, additional flexible or rigid or semi-rigid material may be desirable to fill the space between the projecting ends of the optical fibers. The formation of even, flush output and input surfaces enables the deposit of the polarization thin-film or sheet before the input ends, and after the output ends, of the optical fiber Faraday attenuator elements, although such films or sheets may be adhered or fixed into place between the input ends and the illumination source, and on an outside display optical glass or between the output ends and any final optics, including optical glass, and the like.

An alternative method for implementing the switching grid is to fabricate the textile matte structure without the addressing filaments, saturating with a sol and curing, additional liquid polymer smoothing of a top layer, and depositing by epitaxy a thinfilm printed with a standard FPD addressing grid, or by other standard semiconductor lithographic methods.

The switching matrix as woven textile structure paradigm applies to any scale of textile fabrication machinery, from the exemplary commercially available equipment and processes of Albany International Techniweave, to micro- and nano-scale textile-type fabrication, utilizing micro-assembly process apparatus and methods commercially available from Zyvex, in particular for textile-type manipulation of micro and nano-fibers and filaments with nanomanipulator systems, and Arryx optical tweezer methods. Such methods translate the textile paradigm, separately or advantageously in combination, to the smallest possible scale of assembly and components, realizing various forms of ‘nano-looming’ systems.

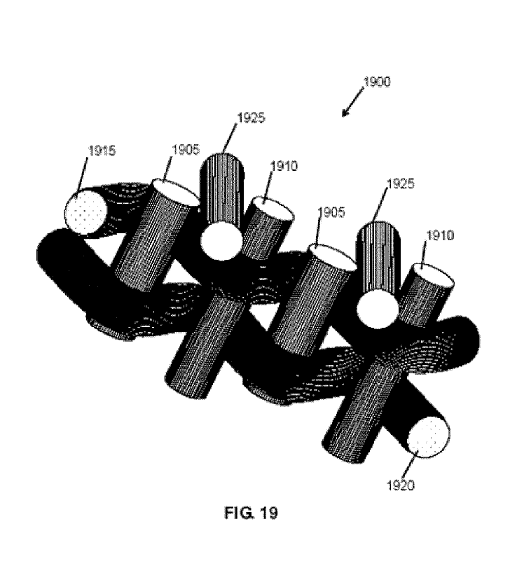

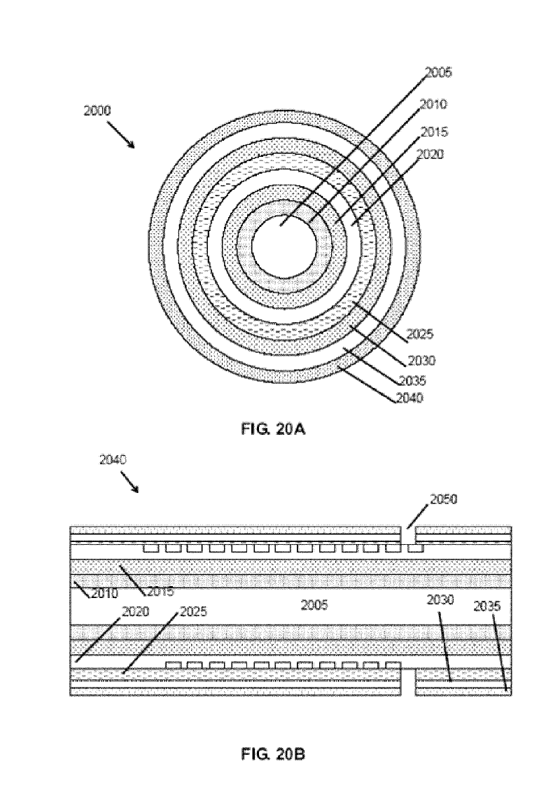

FIG. 19 is a schematic three-dimensional representation of a textile matrix 1900 useable as a display, display element, logic device, logic element, or memory device and the like as described and suggested herein and in the incorporated patent applications. Matrix 1900 includes a plurality of waveguide channel filaments 1905 and optional structural/spacer elements 1910 interwoven with an ‘X’ structural filament 1915, an ‘X’ addressing structural filament or ribbon 1920, and a ‘Y’ addressing/structural filament 1925.

The following discussion relates to Logic Addressing of Faraday Rotator Elements in a Matrix.

‘Passive Matrix,’ Logic and Transistors Along Two Sides of Matrix (X&Y)— The switching matrix, in the form of a textile matte, ready for assembly into the display casing/structure, is positioned and secured into place by either placement and fixing of the removable frame (rigid or flexible) from the loom, or by means of the hooks or fastening devices provided for each color subpixel row.

In the case of the removable frame, the frame itself preferably, in this ‘passive matrix’ option, incorporates the logic required to address each ‘x’ and ‘y’ row, sequentially for the entire switching matrix, or portioned into sectors which are each addressed sequentially, with appropriately modulated pulses of varying current that by magnitude effectively carries the subpixel information and current necessary to change the rotation of each subpixel Faraday attenuator element for a given video display ‘frame.’ Fabrication of this logic is by standard semiconductor or circuit board lithographic or printing systems, or by such methods elsewhere cited herein, including dip-pen nanolithography.

Alternatively, the removable frame may simply be fabricated with printed conductive strips that in turn contact the logic fabricated on an ‘interior’ frame emplacement in the display casing/structure.

‘Active-matrix,’ Logic and Transistors Integrated in Fiber Components or Other Textile Elements—The added complication of implementing a transistor to control each subpixel of the display, as opposed to implementing a ‘passive’ matrix as described above wherein each subpixel is addressed by switching x-y column and rows through x-y axial transistors, may nevertheless, given current Verdet constants of materials of convenience for fiber dopants, be advantageous for achieving optimal performance of the Faraday attenuator components.

In the case of an ‘active matrix’ regime, the following integral to fiber or textile matrix options are disclosed:

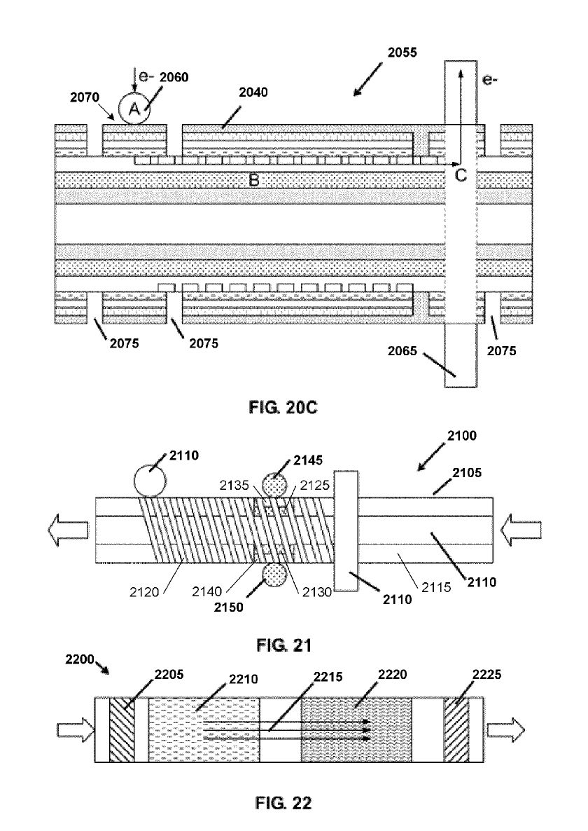

Transistors Integral to Fiber, Formed in-fiber by Doping—FIG. 20 (consisting of FIG. 20A, FIG. 20B, and FIG. 20C) is a cross-section of a waveguide channel 2000. FIG. 20A is view of channel 2000 perpendicular to a propagation axis adjacent to an integrated influencer (e.g., a coilform) structure. Starting from a center and working out, channel 2000 includes a core 2005, an optional first bounding region 2010, a second bounding region 2015, a buffer/influencer region 2020, an ‘N’ region 2025, a gate region 2030, a ‘P’ region 2035, and a conductive contact region 2040. Core 2005 is an optically-active core that, in the preferred embodiment, is dye doped for desired spectral characteristics and otherwise includes the transport characteristics to improve the ‘influencibility’ of channel 2000 to amplitude control-effecting influence from influencer region 2020. As discussed above and in the incorporated patent application, optional region 2010 may be doped with permanent magnetic constituents and region 2015 may include ferri/ferro magnetic constituents to improve operation.

FIG. 20B is a cross-section 2040 of waveguide channel 2000 shown in FIG. 20A, in process, parallel to the propagation axis, after an initial diameter cut 2050. A transistor may be fabricated ‘inter-cladding’ during the fiber-fabrication processes, preferably as an ‘outer’ structure with respect to the inner claddings 1 and 2 (with inner cladding 1 optional). A thin buffer-layer glass soot, doped to achieve appropriate electrical insulation and magnetic shielding, is deposited on the preform to form another cladding, on top of claddings and a doped core already built-up as required by the fiber specifications, and which has already been coated with metallized soot or metallic powder to implement a field-generating structure, (this same buffer-layer may be the same layer of the preform which was intermittently coated and twisted or ‘spiral-painted’ or ‘spiral-incised,’ in the event a coilform is necessary as the field-generating structure, and according to the relevant options for fabricating a coilform disclosed in the incorporated patent applications). Doped semiconductor ‘p’ and ‘n’ cladding layers are deposited, with a ‘gate’ layer in-between deposited as well, all as soot-deposited cladding elements of the preform. Various transistor types may be fabricated by this general scheme.

A length of the claddings so deposited on the preform is partitioned off, delimiting the coilform/field-generating structure, by incising a diameter cut 2050 on a rotating preform, such that the preform is cut through to buffer/influencer layer 2020 at an output-end of the coilform/field-generating structure. Cut 2050 defines a circular groove about the axis of the fiber.

FIG. 20C is a cross-section 2055 of waveguide preform 2040, in process, parallel to the propagation axis, after an initial diameter cut 2050 and contact layer 2040 is deposited on waveguide 2040 shown in FIG. 20B. Preform 2055 includes an ‘X’ addressing input 2060 and a ‘Y’ addressing output 2065 of an X/Y addressing matrix. Input 2060 is a longitudinal conductive element for contact with rows of segments, each having a layered contact structure 2070 defining a transistor switching element. A circuit is defined for actuation of influencer region 2020 by directing a control signal into input 2060 at ‘A’ then through transistor element 2070 into influencer region 2020 (shown as ‘B’) and then to Y output 2065 shown as ‘C’ to actuate influencer 2020. In some instances, additional axial grooves 2075 are formed to isolate various regions, such as transistor elements 2070.

The opportunity to fabricate transistors as integral elements of a fiber structure is suggested by the fact that an optical fiber may be regarded as a ‘self-substrate’ upon which other electronic and opto-electronic structures, including transistors, may be fabricated, ‘inter-cladding.’ Claddings or layers that are in fact semiconductor and electro-optical structures may be fabricated through the fiber preform and drawing processes, and/or grown on the fiber epitaxially, as with a semiconductor wafer. In addition, the method of fabricating a thinfilm, removing from a standard substrate by epitaxial liftoff, and adhering to the fiber as disclosed elsewhere herein with regard to coilforms printed on thinfilms without epitaxial liftoff from a substrate, is in reality a variant of the semiconductor manufacturing paradigm.

A transistor may be fabricated ‘inter-cladding’ during the fiber-fabrication processes, preferably as an ‘outer’ structure with respect to the inner claddings 1 and 2 (with inner cladding 1 optional). A thin buffer-layer glass soot, doped to achieve appropriate electrical insulation and magnetic shielding, is deposited on the preform to form another cladding, on top of claddings and a doped core already built-up as required by the fiber specifications disclosed elsewhere herein, and which has already been coated with metallized soot or metallic powder to implement a field-generating structure, (this same buffer-layer may be the same layer of the preform which was intermittently coated and twisted or ‘spiral-painted’ or ‘spiral-incised,’ in the event a coilform is necessary as the field-generating structure, and according to the relevant options for fabricating a coilform disclosed elsewhere herein).

Doped semiconductor ‘p’ and ‘n’ cladding layers are deposited, with a ‘gate’ layer in-between deposited as well, all as soot-deposited cladding elements of the preform. Various transistor types may be fabricated by this general scheme.

A length of the claddings so deposited on the preform is partitioned off, delimiting the coilform/field-generating structure, by incising a diameter cut on a rotating preform, such that the preform is cut through to the buffer layer at the output-end of the coilform/field-generating structure. The cut is circular about the axis of the fiber. On the preform is then deposited a metallized soot, that fills the cut at the output end of the coilform/field-generating structure.

A second series of cuts are then made after the conductive layer is added, one adjacent to the cut made at the output end or of the coilform/field-generating structure, and two at the relative input end of the structure, through the conductive layer and the semiconductor layers to the inner buffer/coilform layer, such that the transistor structure and coilform segment are conductively isolated. After the diameter cuts are completed, only the first cut, at the output end of the coilform/field-generating structure, is filled with conductive material that connects to the exterior conductive layer.

The conductive metallized soot filling the cut at the relative ‘bottom’ of the coilform provides a contact point with the transistor structure directly, while the conductive metallized soot filling the ‘uppermost’ cut at the relative ‘top’ of the coilform forms a direct contact with the coilform itself. A contact, then, made with the ‘lower’ large ‘cylinder’, which is the outermost conductive (laid down as metallized soot at the preform stage) layer, as well, of the cladding-structured transistor structure, provides a switch integrated with the fiber, while a contact made with the ‘upper’ thin cylinder section completes the circuit. When the transistor is switched on, current flows at the appropriate magnitude to the coilform as a pulse, magnetizing the ferri-ferromagnetic dopant molecules to preserve the magnitude of rotation of the angle of polarization of the light passing through the core. The pulse current exits the coilform at the relative top, passing through the conductive material as opposed to the semiconductor structure adjacent.

Other methods of isolating the cladding-structured transistor, which encloses the inner cladding layers and core as a series of outer cladding cylinders, from the entire length of the fiber also constructed with those layers, such that circuits may be formed between elements of the various levels, in this case forming a circuit with a transistor in sequence with a coilform, are practical and encompassed by the novel method of the embodiment of the present invention. They include the previously referenced electrostatic self-assembly process commercially available from Nanosonic.

Analogues of the above method may be implemented at the drawing stage in the form of coatings, such that instead of forming claddings by deposit of soots on a preform, coatings are added to the fiber length, fabricating a transistor structure following the pattern indicated by the structuring of the transistor as claddings, in bulk after the fiber is drawing and the coilform is implemented by one of the relevant methods.

In regard to the formation of contact points to implement a transistor and coilform in series, a further option available, especially relevant if the transistor layers are formed by coatings or if the fiber is wound with a coilform or field-generating structure imprinted on a film. Viz., the buffer layer may very thin, so that after drawing, the fiber may be selectively stretched in portions so that holes form and collapse, such that the conductive ‘base’ cladding is brought into contact at points on the coilform or field-generating structure. Unequal stretching of the fiber by preferential bending, against the drawing axis, can stretch the buffer layer first at the ‘bottom’ of the coilform, effecting contact between the ‘inner’ semiconductor layer (or base). Depending on the magnitude of stretching and bending and the depth of holes or fractured created thereby, conductive polymer or metallic powder coating may be deposited to form the differential-depth contacts analogous to those formed by the ‘cut and fill’ method specified at the preform stage, employing soots. Heating and ablation of a coating at contact spots, in order to replace materials in a contact structure analogous to the ‘cut and fill’ method specified for the preform stage, employing soots, is a further option.

Contact points may also be implemented by changing the nature of the material at the contact points in the various layers of claddings or coatings. This may be implemented, by ion-beam bombardment, at an appropriate angle of incidence, perforating and mixing the buffer layer and ‘inner’ semiconductor cladding layer (or base) together, at the ‘bottom’ and ‘top’ contact points of the coilform or field generating structure.

Alternatively, spot-etching and epitaxial deposition of altered layers—conductor or semiconductor material replacing a precise ‘spot’ of the buffer layer at the relative ‘bottom’ of the coilform, and oppositely at a precise ‘spot’ on the ‘top’ of the coilform, may be employed. The buffer material replaced with semiconductor or ‘base’ material, the two semiconductor and gate materials are re-deposited as well at the same points on the compound fiber structure (also by dipping in appropriate electrostatic self-assembly solutions).

These and other methods of forming effective ‘inter-layer’ contact points, and thereby a circuit consisting of a transistor and a coilform, both themselves fabricated as part of the ‘bulk’ fabrication process and both integral structural elements ‘inter-cladding’ and/or ‘inter-coating,’ are practical and subsumed by the scope of the inventive method and component.

Alternatively to fabricating the transistor structure in the form of claddings surrounding the core in the preform and drawing processes, the transistor structure may be fabricated by the known semiconductor vapor-based and other methods on a previously fabricated fiber as self-substrate. Quantum well intermixing (QWI) in particular is advantageous.

The fiber may already possess the compound p-n/and gate claddings, which are then masked and etched to form the appropriate transistor structures, or the entire transistor semiconductor structure may be grown/masked/etched on the fiber, with its pre-existing optically-active core, optional permanently magnetized cladding 1, ferri-ferromagenetic cladding 2, and coilform/field-generating structure.

This preferred embodiment for a method, and component, of forming transistors integrally in the fiber structure, is not limited in the number of elements that may be fabricated thusly. Through structuring and doping of performs and then drawing of the fiber, or in combination with epitaxial growth of additional layers on top of and in restructuring of the drawn claddings, and/or with adhesion of thinfilms fabricated otherwise and removed by epitaxial liftoff, and variants disclosed elsewhere herein and occurring as logical extensions to the method and component, more than a single transistor ‘cladding cylinder’ structure may be fabricated.

The number of elements or features possible range from an individual transistor fabricated through an inter-cladding structure, as disclosed above, to an entire microprocessor fabricated on and through the three-dimensional structure of the fiber. The number of elements depends on the dimensions of the fiber. The relatively ‘bare’ fiber structures disclosed herein, not necessarily coated with the ruggedized material necessary for environmental protection of fiber in telecommunications contexts, having a relatively small diameter, will ‘support’ a relatively smaller number of elements per unit length. However, length of the fiber may be increased even in this case, so that the number of elements may be multiplied thereby.

By way of illustration, a die area of 300 mm2 and feature size of 0.30 microns may be implemented by a fiber of 250 microns diameter and 190 mm length. A smaller diameter single-mode fiber, of 20 microns diameter, having a circumference of approximately 126 microns, will in fiber segment length of 15 mm result in a surface area of 1.89 square mm. Such a surface-area which is utilized (in a multi-layer structure) to fabricate an integrated circuit provides a not insignificant fraction of the die area of a modern electronic microprocessor.

However, the design opportunities provided by a three-dimensional cylindrical surface geometry offers its own advantages in comparison to the 2-dimensional square geometry of a standard die.

Furthermore, since the semiconductor structures are fabricated intra- and inter-cladding and coating and therefore may utilize the fiber structures down to and including the core, the solid fiber structure may be additionally micro-structured to permit, through various mechanisms (including radial doping profiles forming conductive micro-filaments), additional circuit structures and strategies between exterior surface points through the fiber body.

This solid-state IC microstructuring of the fiber is obviously not limited to transistor, capacitor, resistor, coilform or other electronic semiconductor structures, but it in fact provides a natural paradigm for opto-electronic integration, as evidenced by the methods, devices and components disclosed elsewhere herein. The novel integrated (micro) Faraday attenuator fiber optic device disclosed herein thus may be alternatively disclosed as an instance of a novel generally-applicable integrated opto-electronic IC device.

Not only may electronic semiconductor features be fabricated intra- and inter-cladding, but any electro-photonic or opto-electronic device may be an element of such integrated IC's so fabricated, positioned integrally in-fiber to modify light channeled in the fiber core, constrained by mode or other selection to claddings, or additionally channeled in superficial-helical channels fabricated in the preform-drawing process or as semiconductor waveguide channels fabricated as subsidiary guiding structures in the cladding/coating structure of the primary fiber. Photonic bandgap structures may be fabricated intra- or inter-cladding by methods referenced and disclosed elsewhere herein and known to the art, resulting in a compound fiber structure that may include a standard fiber core and claddings or a photonic crystal base fiber structure upon which is further fabricated claddings and coatings.

Electrostatic self-assembly of nanoparticles by successive dipping in appropriate solutions in particular is of relevance for fabricating fiber-based structures efficiently and in large volume.

Additional advantageous methods of fabrication, especially effective for the curved surface geometries of fibers, are commercially available from Molecular Imprints, Inc. This fabrication paradigm is trademarked ‘step and flash’ imprint lithography, which affords sub-micron alignment, and room temperature fabrication, of a ‘nano-imprint’ mold that replicates a mold nano-structure of a liquid imprint fluid (in this case of sufficient viscosity to adhere by surface-tension to the curved fiber geometry) that is flash UV cured. The step process is well-suited to patterning a curved geometry in relatively flat planar sections, and provides a potentially low-cost fabrication alternative.

Light guided in cores, constrained in claddings, or guided in subsidiary and smaller semiconductor structures, may be controlled by Faraday rotation, implementation of photorefractive doping of fibers to permit induced Bragg gratings and other structures, actuated by photonic stimulation, and electro-optic alteration of fiber structures (core and claddings) to implement gratings and other structures, and other photonic switching and modulation methods may be advantageous implemented as elements of a compound complex fiber-based IC structure.

The power of the paradigm, implementing combinations of preform-drawing and other batch fiber fabrication processes known to the art and semiconductor manufacturing methods, including batch fiber runs through epitaxial growth or ion bombardment batch processes or electrostatic self-assembly, is illustrated by the preferred embodiments and implementations of the present invention and further developed as disclosed elsewhere herein in the context of textile structures combining multiple such IC fiber electro-photonic devices.

Adjustments to the geometry of optics for semiconductor lithographic and alternative patterning methods (particle beam direction) known to the art, to adapt to the geometry of the fiber as self-substrate in IC fabrication, may be made effectively by standard modification of optical elements and focusing elements known to the art.

Transistors Integral to Fiber, Wrapped Thin-film on Fiber—As in the novel method disclosed elsewhere herein, that is, the epitaxial wrapping of thinfilms with conductive patterns printed on those films to implement a coilform, the novel method for integrating transistors into the fabrication of the fiber component is implemented following the same pattern.

Printing, through standard semiconductor or nano-lithographic methods, of the transistor on a thinfilm tape, may be on a top or bottom portion of the same thinfilm tape that may optionally wrapped around the fiber to effect the coilform that generates the field that rotates the angle of polarization of the light guided by the optical fiber. Or it may be on a tape wrapped around a top or bottom portion of a fiber in which the coilform or coil is fabricated by one of the other methods disclosed herein.

Transistors Printed on Thinfilm tapes, Wrapped on structural filaments adjacent to fibers in switching matrix—A variant on the above is the wrapping of a thin film on a filament adjacent to the Faraday attenuator optical fiber element, either one of the filaments in the ‘x’ ribbon, or one of the filaments woven in the ‘y’ axis of the textile matte, or a ‘space’ filament parallel to the Faraday attenuator. Wrapping is implemented as described elsewhere herein, and the transistor so fabricated will be disposed adjacent to the optical fiber Faraday attenuator elements they address.

When a filament is chosen that is part of either the ‘x’ or ‘y’ ribbon structures, the addressing fiber is a non-conductive polymer that is wrapped in its entirety by a thin film, which includes a conductive stripe, interrupted periodically by a transistor, to address each Faraday attenuator optical fiber element.

When the filament is a ‘spacer’ filament adjacent and parallel to each Faraday attenuator optical fiber element, then one of the addressing ‘x’ and ‘y’ filaments actually contacts these spacer fibers, which must then be wrapped with the thinfilm, printed with a conductive stripe, as well as the printed transistor, and finally a conductive element is printed such that it will curve around the filament and contact the actual Faraday attenuator optical fiber element at either the relative top or bottom of the fiber. The other of the ‘x’ or ‘y’ addressing filaments then contacts the Faraday attenuator optical fiber at the opposite end of the optical fiber.

Transistors Printed on Fiber or adjacent structural filaments by Dip-pen Nanolithography—According to the same fabrication process disclosed elsewhere herein, in which dip-pen nanolithography prints a spiral coilform winding structure directly on a fiber, the transistors may similarly be fabricated by dip-pen nanolithography on the optical fiber Faraday attenuators themselves, above or below the segment where the coilform is fabricated in similar fashion or by other modes also disclosed herein.

The same scheme as described above for utilizing either ‘x’ or ‘y’ filaments or ‘spacer’ filaments applies to the dip-pen nanolithography approach. Conductive strips are also printed by dip-pen nanolithography.

In all the novel methods disclosed herein for fabricating opto-electronic devices on adjacent structural elements of the three-dimensional textile matte/matrix, the advantages gained are options for shielding and compactness of pixel-element construction, spreading of process steps to adjacent elements, reducing the number of process steps per element in the textile matte/matrix, and in general, exploitation of three-dimensional topology for greater special efficiency of opto-electronic or photonic switching design.

Fiber is drawn in a bulk fiber fabrication process and is variously doped and processed as disclosed elsewhere herein to implement an optically active core dye-doped core; an optionally doped permanently magnetized inner cladding with magnetization at right-angles to the axis of the fiber; a cladding doped with an optimal ferri/ferromagnetic material which may be magnetized and demagnetized and whose hysteresis curve is suitable for maintaining a magnitude of rotation during a video-frame cycle; a coilform or coil or field-generating element, fabricated in the structure of the fiber either by twisting or addition of conductive patterns to the cladding or structurally wrapped with a conductive structure—film, coated silica fiber, conductive polymer, and the like—and capable of receiving a pulsed current of sufficient magnitude to generate a field that will magnetize the doped outer cladding; and an optional transistor fabricated also as a structural element, by the same variety of methods, combined with the other structural elements to implement an active matrix for the display. The doping and structuring of the compound fiber structure may be periodic or continuous, at least in regard to certain dopants or structural features, such that typical long low-cost runs of fiber fabrication are possible. If a coilform is effectively continuous (continuous twisting or implanted wire, etc.), then the coilform functionality is later precisely accessed by precisely selecting a portion of the coilform by contact points, rendering the continuing structure beyond those points non-functional and inert as regards the operation of the device.

Fiber fabrication processes continue to advance, in particular with reference to improving the doping concentration and manipulation of dopant profiles, periodic doping of fiber in a production run, etc. U.S. Pat. No. 6,532,774, Method of Providing a High Level of Rare Earth Concentrations in Glass Fiber Preforms, demonstrates improved processes for co-doping of multiple dopants. And success in increasing the concentration of dopants can directly improve the linear Verdet constant of doped cores, as well as the performance of doped cores to facilitate non-linear effects as well.

Finally, the mode of high-volume fabrication in fiber-optics enables a testing regime of components that allows for bulk testing of structured fiber for defects, allowing defective portions of a long run of fiber to be marked and discarded in the fiber component cleaving and looming process. And therefore avoiding the crippling defect rate and consequent rejection rate of large semiconductor-process based LCDs and PDPs.

While the emphasis in terms of performance parameters and basic device configuration has been on the linear Faraday Effect, the essential nature of the employment of static magnetic fields to change the angle of polarization, implemented in a polarizer/analyzer light valve scheme, allows also for the exploitation of so-called ‘non-linear’ polarization rotation phenomena as well, with the addition of certain functionality to the Faraday attenuator optical waveguide structure. ‘Non-linear’ refers to a rotation response that may be described mathematically as a response curve with a slope greater than that of the linear Verdet constant parameter in the standard Faraday-effect equation.

Exploitation of non-linear responses of materials to an applied magnetic field is generally based on excitation of the propagating medium, through typically electrical or photonic stimulation. That is, an optically-active medium is excited by operation of an electrode that passes a current through the medium, altering its state, or by a beam of coherent light that optically pumps the medium, achieving resonance or near resonance of that medium.

Two basic regimes are considered, with their attendant modifications to the integrated Faraday attenuator optical waveguide devices: Faraday-Stark effect and optical pumping.

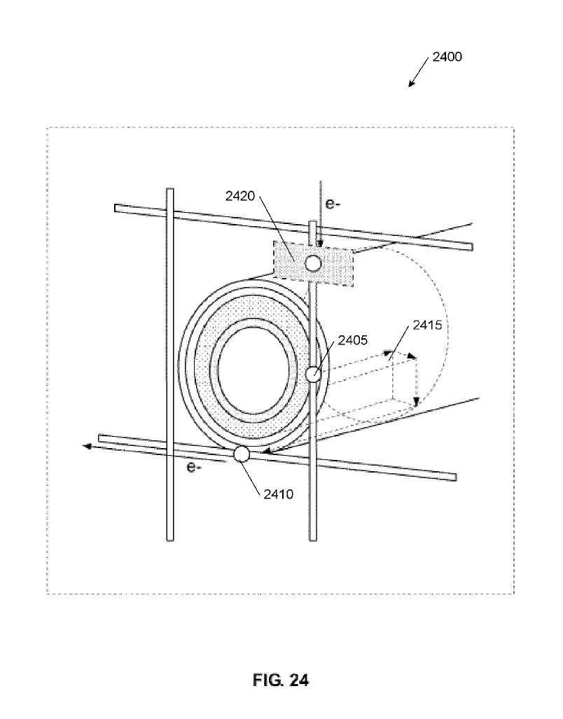

FIG. 21 is a schematic diagram of an alternate preferred embodiment of the present invention for a modulator 2100. Modulator 2100 is a special modification to the more general modulator 900 shown in FIG. 9. Modulator 2100 includes a transport 2105, defining a waveguide having a waveguiding channel 2110 and a plurality of bounding regions including an associated first bounding region 2115. Disposed in or on an input end of transport 2105 is an input wave property processor and disposed in or on an output end of transport 2105 is an output wave property processor. Embedded in one of the bounding regions is an element 2120 of an influencer for enabling generation of a wave property modification mechanism, for example a coilform structure for generating a longitudinally-oriented magnetic field in channel 2110. Transport 2105 receives radiation for WAVE_IN from a radiation source and outputs a modulated wave_component. A controller (not shown) for modulator 2100 is coupled to each element 2120 via a pair of couplers 2125 (as shown an ‘X’ addressing filament and a ‘Y’ addressing filament as shown in FIG. 24 below for example) provides for independently controlling radiation propagating through each transport 2105. In some implementations, the controller may have discrete components for controlling each transport 2105. Modulator 2100 includes a plurality of constituents disposed in the waveguide that enhance the influencer response of radiation propagating therethrough. When modulator 2100 is configured to use the Faraday Effect, the influencer generates a magnetic field parallel to the transmission axis of the waveguide. The magnitude of the magnetic field, a length over which the magnetic field operates on the propagating radiation, and the Verdet constant all affect the influencer response. The constituents increase an effective Verdet constant to enhance the influencer response. As shown above in Eq. 1, the Faraday response is generally described as a linear response.

An optoelectronic effect based on resonant Faraday rotation and the quantum confined Stark shift was developed and described in U.S. Pat. No. 5,640,021 (hereby expressly incorporated by reference). By exploiting the resonance nature of excitonic Faraday rotation combined with the tunability of exciton energy provided by a quantum confined Stark effect, it is possible to control the Faraday rotation in a quantum well structure using an electric field. Electric fields may be modulated at high speed, permitting a high-speed modulator to be constructed using a DC magnetic field such as that provided by a permanent magnet. The inventors of the '021 patent observed this effect in Kerr reflection geometry in a structure having a GaAs single quantum well with an effective width of 350 Å (Z. K. Lee, D. Heiman, M. Sundaram, and A. C. Gossard, proceedings 22nd Int. Sym. on Compound Semiconductors, Korea, 1995), hereby expressly incorporated by reference for all purposes. An electric field-tunable rotation change of 11 degrees was obtained using a magnetic field of only 1 T. Other material systems were examined to estimate the magnitude and operating conditions for the Faraday-Stark effect. The maximum achievable Faraday rotation was higher in high bandgap materials, although they require higher magnetic fields to achieve. Furthermore, it was found that adding manganese to II-VI semiconductors reduced the required magnetic field in some cases even for room temperature devices.

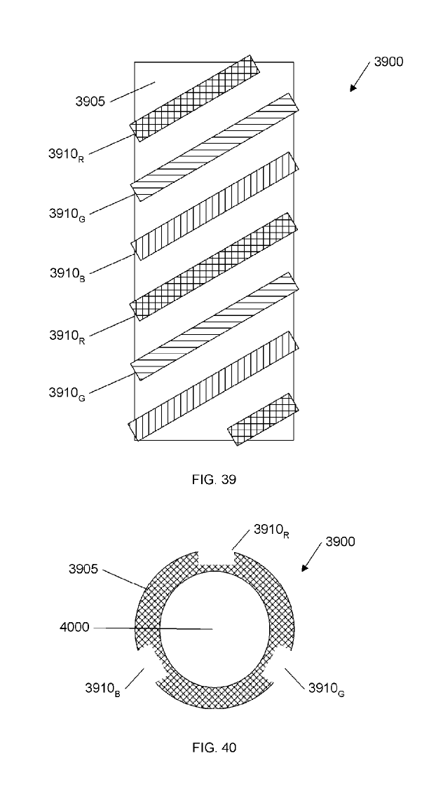

Exploitation of non-linear responses of materials to an applied magnetic field is generally based on excitation of the propagating medium, through typically electrical or photonic mechanisms. That is, an optically-active medium is excited by use of an electrode that passes a current through the medium, altering its state, or by a beam of coherent light that optically pumps the medium, achieving resonance or near resonance of that medium. FIG. 21 is an example of an excitation system using the former principle while FIG. 22, and certain implementations of FIG. 30, FIG. 39, and FIG. 40 are examples of an excitation system of the latter type.

Two basic regimes are considered, with their attendant modifications to the integrated Faraday attenuator optical waveguide devices: (a) ‘Faraday-Stark’ Rotation—As described in U.S. Pat. No. 5,640,021, ‘Faraday-Stark magneto-optoelectronic device,’ the ‘resonant’ Faraday Effect ‘is exhibited in semiconductor quantum wells whenever the energy (wavelength) of the excitation light corresponds to the difference in energies of one pair of the conduction and valence Zeeman-split subbands of the quantum wells.’ The ‘quantum confined Stark effect, known in the last quarter of the 20th century, names the way the transmission (absorption) spectra of excitation light applied through a quantum well of a semiconductor material is varied with the electric potential applied thereto via tuning electrodes.’ The exploitation of the non-linear Faraday-Stark is accomplished in a preferred embodiment of the present invention by providing an excitation system with tuning electrodes, for example fabricated on thinfilm or nanolithically disposed/printed, that wrap the waveguide/fiber (which may be combined in one circuit-printed thinfilm with winding patterns and a transistor) or by dip-pen nanolithography on the fiber (also optionally performed while other elements are deposited), positioned opposite each other on the axis of the fiber. A coating or cladding is first added to the coilform layer; contact to the ‘bottom’ and ‘top’ of the coilform is enabled by a perforation method disclosed in the incorporated patent applications. Between these contact points and offset 90 degrees on the surface of the coating or cladding, electrodes are formed by the processes indicated, or by annealing of conductive coating separated by a non-adhering strip.

Modulator 2100 thus includes elements of an excitation system for enhancing the influencer response using this Faraday-Stark effect that is an enhanced non-linear response as compared to the Faraday Effect alone. Consequently, the enhancement provides that one or more of the variables of the Faraday Effect's linear response equation may be decreased while still producing the desired rotational control. The excitation system includes a pair of tuning electrodes (e.g., an anode 2125 and a cathode 2130) axially disposed from each other in a bounding layer of modulator 2100. A permeable/non-conductive contact is provided for each electrode (e.g., a first contact 2135 and a second contact 2140) that is communicated in turn to a corresponding control coupler (e.g., a first excitation coupler 2145 and a second excitation coupler 2150). These electrodes produce the exciting current to generate the Stark effect in modulator 2100.

To simplify the following discussion of the operation of modulator 2100, FIG. 21 illustrates operation of a single pixel/subpixel using no particular color model to produce a single picture element (pixel) independently controlled from a controller. Further, while the discussion above sets forth different mechanisms for the influence systems that may be used for controllably and reproducibly varying an amplitude of propagating radiation, the following discussion recites operation using the Faraday-Stark Effect for controllably rotating polarization angles of propagating rotation and applying that modified radiation to a polarizer analyzer having a known relationship between a transmission axis angle and an unrotated angle of the propagating radiation.

In operation, modulator 2100 receives a color component from a source providing, for example, one of a RED WAVE_IN, a GREEN WAVE_IN, and a BLUE WAVE_IN, to transport 2105. The input wave property processor produces a wave_component having the desired property for influence by the influencer system. In the present example, the processor produces a particular polarization having a particular initial angular orientation (e.g., left handed polarized radiation at ‘zero’ degrees). The particularly polarized and oriented wave_component of the individual color propagates through transport 1005 where the controller asserts independent control over the wave_component magnitude by virtue of the magnetic field generated by the influencer elements 2120 and by the added affect of the excitation system. As explained above, the magnitude of the magnetic field and excitation system enhancement influences a polarization rotational change of the propagating radiation through channel 2110. The final polarization angle of the radiation is then applied to the output processor (e.g., a polarizer analyzer having a transmission axis oriented with a ninety degree offset relative to the input processor transmission axis) so that the color is modulated anywhere from full intensity to ‘off’ in response to the controller and the excitation system. Arranging a plurality of pixels into a matrix produces a display.

Modulator 2100, similar to modulator 900, may use attenuation smoothing at the macro-pixel level (combination of channels) or for each sub-pixel channel. Depending upon relative geometries of a display system and a size of individual channels, in some cases a single pixel is composed of multiples of modulator 2100 particularly as dimensions of a display increase which increases the actual physical dimensions of a display pixel.

FIG. 22 is a schematic diagram of a modulator 2200 including an alternate preferred embodiment for an excitation system using optical pumping. Optical pumping may not technically be an enhanced non-linear effect like the Faraday-Stark effect, but optical pumping produces an augmentation to a basic Faraday modulation schema and for that reason is considered in the preferred embodiment to be included within the scope of ‘non-linear effects.’ Modulator 2200 includes a polarizer 2205, an integrated LASER generation structure 2210 that produces coherent light 2215 for pumping the waveguiding region, a modulator region 2220 (functionally equivalent to modulator 900) and an analyzer 2225.

The exploitation of the non-linear Faraday-Stark is accomplished in a preferred embodiment of the present invention thus: (i) Tuning electrodes are fabricated on thinfilm, wrapping the fiber (which may be combined in one circuit-printed thinfilm with winding patterns and transistor) or by dip-pen nanolithography on the fiber (also optionally performed while other elements are deposited), positioned opposite each other on the axis of the fiber; (ii) A coating or cladding is first added to the coilform layer; contact to the ‘bottom’ and ‘top’ of the coilform is enabled by the perforation method disclosed elsewhere herein; and (iii) Between these contact points and offset 90 on the surface of the coating or cladding, electrodes are formed by the processes indicated, or by annealing of conductive coating separated by a non-adhering strip.

Non-linear Faraday Rotation Achieved by Optical Pumping of Rotating Medium:—Numerous configurations for achieving non-linear responses from an optically pumped resonant or near-resonant medium are known to the art.

Not a non-linear but none-the-less characteristically fast ‘augmented’ Faraday attenuation scheme is described in U.S. Pat. No. 6,314,215, ‘An apparatus and method wherein polarization rotation in alkali vapors or other mediums is used for all—optical switching . . . where the rate of operation is proportional to the amplitude of the pump field. High rates of speed are accomplished by Rabi flopping of the atomic states using a continuously operating monochromatic atomic beam as the pump.’

Any implementation of any optically-pumped non-linear (or linear, as in U.S. Pat. No. 6,314,215) system in a preferred embodiment of the present invention is generally achieved by one of two ways, although other methods fall within the scope and logic of the invention.

a. Implementing either an ‘external’ array of semiconductor lasers, deployed along one ‘x’ and ‘y’ axis each, directing beams of coherent (preferably non-visible) light transversely through the axis of the Faraday attenuator fiber components of the switching matrix. This method may not be practical with variants of the matrix assembly process in which the structural elements are not sufficiently transparent. Any such array may employ an optical sequence such that a waveguide of much wider diameter is employed from which the beam then is further diffused and refocused to illuminate multiple rows of Faraday attenuators whose axes are at right angles to the pumping beam. The pumping must have sufficient intensity to excite all full rows to resonance or near resonance.

b. Implementing a pumping beam through the axis of the fiber components. This may be accomplished by: i. either through laser pump (semiconductor laser array, etc.) in the illumination cavity at the relative ‘rear’ of the FPD or switching module or ‘beneath’ as fused fiber substrate of ‘vertical’ semiconductor embodiment or on the same axis as ‘planar’ semiconductor embodiments. (See embodiments disclosed later in this application); or ii. integrally in the fiber structures themselves. These would be fiber-embodied lasers, of which numerous variations are known to the art of optical communications. These structures must be implemented in the fabrication process of the integrated Faraday attenuator fiber optic component. A section of the fiber is periodically structured (doped with photoreactive material which, when exposed to a transverse high-intensity laser, forms a grating structure in-fiber) to implement fiber lasing. This component may be located anywhere in the integrated fiber component external to the range of the fiber which incorporates the coilform for rotation.

Any such pumping through the axis of the fiber, either external to the fiber from the illumination unit, or integrated into the fiber structure, should implement a non-visible pumping beam, so as to be filtered by a thinfilm filter disposed between the output ends of the fiber components and the final display surface optics. A completely solid-state optically pumped medium requires no further changes to the micro-structure of the fiber. But implementation of a vapor for pumping and resonant cavities requires introduction of micro-bubbles or cavities. That may be accomplished by the heat-treatment processes referenced elsewhere herein, which in combination with addition of alkali dopant, may leach sufficient alkali molecules to result in a rarified alkali vapor in the micro-bubbles. Or, micro-bubbles may be introduced and unsuppressed at the preform stage, as disclosed elsewhere herein.

Additional Component Embodiments, Including for Integration of Further Display Components into Fiber, and Fabrication Methods of Same —While the standard optical fiber paradigm has been specified in the previous preferred embodiments, other optical fiber structures offer their own specific virtues. In particular, photonic crystal fibers, implementing waveguiding essentially by a photonic bandgap structure, are potentially of even greater optical efficiency than standard solid core & cladding fiber and potentially smaller overall diameter when manufacturing cost efficiencies are achieved.

In addition, other optical fiber structural paradigms exist and may be anticipated. Among them, an older paradigm already referenced elsewhere herein with regard to ‘twisted fiber to fabricate an outer coilform conductive cladding around an inner cladding(s) and core,’ presents an opportunity to integrate R, G, B color structurally in a single fiber.

Both photonic crystal and helical superficial channel fiber paradigms require some modification to the structures and fabrication methods already disclosed:

Photonic Crystal Fiber (PCF)—PCF fabricated by fusing of silica filaments and formation of hollow channels thereby.

I. Implementing manipulation of primary light channel to improve Verdet constant: in order to improve the Verdet constant of what would otherwise be the Verdet constant of air in a hollow continuous channel PCF, the central channel must be filled with a liquid polymer or other liquid solution and then cured by UV light or other chemical curing mechanisms known to the art. This liquid polymer or curable chemical solution is chemically constituted and/or includes dissolved solids or impurities of YIG, Tb, or other best-performing optically-active material.

II. Implementing Subpixel Color Integrally in Fiber Components. Similarly, the liquid polymer or curable liquid solution is dye-doped to implement RGB color selection or filtering integrally to the fiber.

III. Implementing ferri-ferromagnetic (and optionally, permanent magnetic) materials in the fiber structure: in this type of PCF fabrication, the silica filaments are previously doped with the ferri/ferromagnetic dopant, while others, or some of the same, or all of the filaments are also doped with permanent magnetic dopant. Preferably, only a minority of the filaments are doped with permanently magnetizable dopant and permanently magnetized by a strong magnetic field prior to assembly with the other silica filaments that are fused and drawing together to form the PCF.

IV. Other structures, including coilforms, are preferably fabricated through a cladding added to the preform of the PCF, which includes the plurality of doped rods (ferri-ferromagnetic and permanently magnetized). Thereafter, the methods are as disclosed for standard optical fiber, or logical variants and adaptations thereof.

PCF fabricated by heat-treatment of standard core & cladding optical fiber and formation of hole structures to form photonic bandgap structures thereby—According to this method, as referenced elsewhere herein, standard fiber is employed and processed after initial drawing and fabrication. Therefore, the structures and fabrication methods disclosed elsewhere herein for the fabrication of the Faraday attenuator functionality in the structure of the optical fiber component apply substantially equally to this form of PCF as they do to standard fiber.

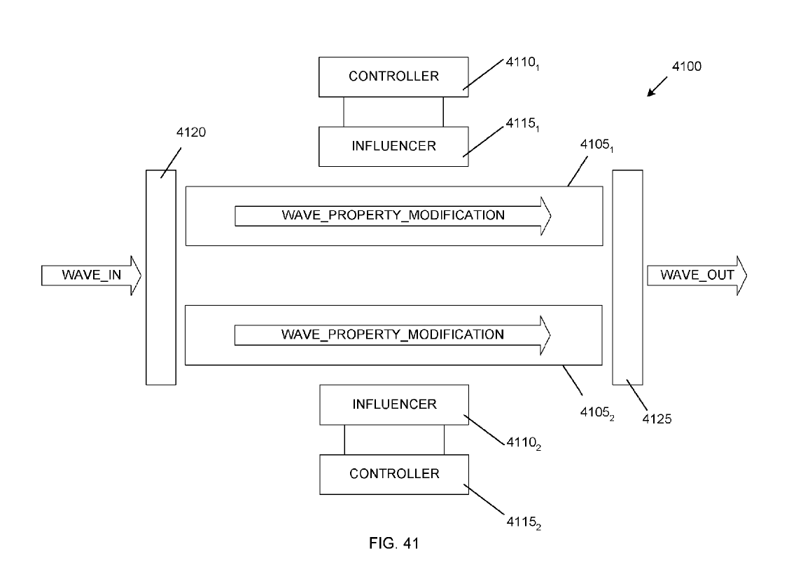

Helical 3—channels (RGB) Cut Superficially on Fiber with or without core, Referencing U.S. Pat. No. 3,976,356: Field-generation structure parallel to Fiber Axis—FIG. 39 is a schematic diagram of a preferred embodiment of an alternate system 3900 for structuring and propagating multiple channels of controllable radiation to produce a pixel/sub-pixel. System 3900 includes a center support 3905 and a plurality of helicoidal grooves 3910 traversing a length of support 3905. System 3900 may implement an embodiment of modulator 4100 (discussed below with respect to FIG. 41) using two or more grooves 3910. To simplify the discussion, system 3900 is shown implementing a three-element model in which each groove supports one of the primary colors of an applicable color model (e.g., RGB). System 3900 permits a single physical structure to support a plurality of sub-structures such as all the sub-pixels of a pixel. FIG. 40 is an end view schematic of system 3900 shown in FIG. 39 further illustrating the presence of an optional center core 4000. Additional details of these embodiments are described herein. FIG. 30 is an alternative preferred embodiment of system 3000 in which an element of an excitation system is disposed within core 3900 to produce system 3000.

It is disclosed in the reference that multiple helical tracks may be cut in a fiber preform and filled with optically differentiated ‘track material’ from a ‘track perform,’ then typically twisted and drawn. Three tracks are specifically cited as accomplished. The state of the art in fiber fabrication have improved significantly since the initial establishment of this form of optical fiber structure and its method of fabrication, methods are now available to further improve the performance of fibers structured and fabricated according to this paradigm.

In practice and logically, the fabrication of fiber with three or more helical-superficial waveguiding tracks will result, on average, in a fiber diameter greater than that of a single core standard single-mode fiber. Dimensions cited in the 1970's era state-of-the-art patent referenced were a diameter of 500 microns, with a lower limit of 100 microns.

However, when considering the combined cross-sectional area resulting from implementing three separate, dye-doped or coated subpixel fibers, including the dimensions of the cladding(s) and Faraday attenuator functionality incorporated therein, it is likely that the net dimensions of a multi-track helical-superficial ‘monolithic’ will be significantly less than the combined dimensions of three separate RGB subpixel fibers. Furthermore, there is potential for increased manufacturing cost efficiencies by consolidation of three colors into one fiber.

Among the adjustments that are preferably made to implement the requisite functionality in a three-track helical-superficial fiber are:

I. Color Subpixel Implementation: each separate RGB track material is dye-doped following the pattern disclosed elsewhere herein.

II. Optional permanently magnetized component: a core may be provided in addition to the helical-superficial tracks. This core may optionally be doped as previously disclosed for standard fiber. The addition of a core also provides a locus for implementing other functionality and integrated components, including fiber-laser functionality for stimulation of track material and implementation of non-linear Faraday-related effects.

III. YIG, Tb, TGG, or Best performing optically-active dopant: as with dye, the optically-active dopant(s) are added to the track preform material.

IV. Ferri/ferromagnetic dopant: dopant added to a thin cladding or coating surrounding the fiber and its three helical-superficial waveguide tracks.

V. Coilform: as the three superficial helical waveguides are themselves a spiral form around the axis of the fiber, implementation of a coil form by twisting methods is not practical for the fiber as a whole.

VI. Twisting of Channel Preform: However, twisting methods may be employed on the track perform material itself. In this case, two coatings are applied to the preform, a first (inner) ferri/ferromagnetic coating and a second (outer) conductive coating that generates the pulse field that is sustained by remanent flux in the inner coating.

VII. Employment of printed winding on thinfilm tape wound epitaxially. As disclosed for standard fiber, a winding pattern (three winding patterns, corresponding to the three helical tracks) are printed on one tape wrapped around fiber. The windings are disposed at right angles to each track, and multiple contact tabs to separately contact the coilform for each track must be provided, following the pattern previously disclosed for standard fiber.

VII. Dip-pen nanolithography similarly translates directly to the three channel helical-superficial waveguide fiber structure. Separate ‘bottom’ and ‘top’ contact points for each printed coilform are printed on the fiber cladding/coating.

IX. Active-matrix transistors: inclusion if specified by either the thinfilm tape method or the dip-pen nanolithography method, or variants as disclosed elsewhere herein and as logically implied by the essence of the various methods disclosed.

X. Precision contact points for three ‘x’ and ‘y’ addressing points for each RGB channel on the fiber. Precision contact points and alignment is assisted by the larger dimensions of this three-channel fiber structure, but in any event is accomplished by variants of the all-fiber textile assembly methods, employing multiple levels of structural and addressing ‘x’ and ‘y’ filaments to make good contacts at different positions along the fiber component segment, or by variants of the other methods disclosed herein elsewhere.

An alternative on the helical-superficial three channel fiber structure is a variant of the traditional core-and-cladding fiber that allows for R, G, B channels in the same fiber structure. In this variant, there is a core and two optically active cladding structures, each with their own attendant Faraday attenuator structures, each dye-doped; for instance, the core is dye-doped red, a cladding of sufficiently different index of refraction is dye-doped green, and a second cladding is dye-doped blue. Such a compound fiber structure would require three Faraday attenuator structures in sequence, fabricated with coilforms or field-generating structures as disclosed elsewhere herein, but also fabricated in successive layers of the fiber, with magnetically-impermeable buffer disposed between cladding/coating layers.

FIG. 41 is a schematic diagram of an alternate preferred embodiment for a modulator 4100 having multiple channels. Modulator 4100 is shown in a generic configuration without specification of the nature of the radiation propagated through the individual and collective channels. To simplify the following discussion modulator 4100 is illustrated as including two channels, however in other embodiments and implementations modulator 4100 may include more than two channels as necessary or desirable for the embodiment.

Modulator 4100 includes a pair of transports 4105_{N} (each supporting an independent waveguiding channel), a pair of property influencers 4110_{N} operatively coupled to transports 4105, a controller 4115_{N} coupled to a corresponding influencer 4110_{N}, a first property element 4120, and a second property element 4125. Of course, other implementations of modulator 4100 may include different combinations of transports, influencers, and/or controllers. For example, modulator 4100 may include a single controller 4115 coupled to all influencers 4110, or it may include a single influencer coupled to one or more transports 4105 and/or one or more controllers 4115. Further, some transports 4100 may include a single physical structure but support multiple independent waveguiding channels.

Transport 4105, like other transports disclosed herein, may be implemented based upon many well-known optical waveguide structures of the art. For example, transport 4105 may be a specially adapted optical fiber (conventional or PCF) having a guiding channel including a guiding region and one or more bounding regions (e.g., a core and one or more cladding layers for the core), or transport 4105 may be a waveguide channel of a bulk device or substrate having one or more such guiding channels. A conventional waveguide structure is modified based upon the type of radiation property to be influenced and the nature of influencer 4110.

Influencer 4110 is a structure for manifesting property influence (directly or indirectly such as through the disclosed effects) on the radiation transmitted through transport 4105 and/or on transport 4105. Many different types of radiation properties may be influenced, and in many cases a particular structure used for influencing any given property may vary from implementation to implementation. In the preferred embodiment, properties that may be used in turn to control an output amplitude of the radiation are desirable properties for influence. For example, radiation polarization angle is one property that may be influenced and is a property that may be used to control an amplitude of the transmitted radiation. Use of another element, such as a fixed polarizer/analyzer controls radiation amplitude based upon the polarization angle of the radiation compared to the transmission axis of the polarizer/analyzer. Controlling the polarization angle varies the transmitted radiation in this example.

Modulator 4100 schematically illustrates first property element 4120 and second property element 4125 as shared between transports 4105X. In some embodiments, each transport 4105 may include independent first elements 4120 and second elements 4125. FIG. 41 shows first property element 4120 and second property element 4125 as shared elements to schematically illustrate a second attribute for modulator 4100. Namely, modulator 4100 splits WAVE_IN into a plurality of wave_components appropriate for the implementation and construction of modulator 4100 (i.e., the number and nature of the waveguiding channels, the influencer, controlling mechanism and desired performance characteristics of the individual channels and modulator) and directs each wave_component into an appropriate channel/transport. For example, in some cases WAVE_IN includes radiation of a single wavelength but multiple orthogonal polarization components (e.g., a left handed polarization component and a right-handed polarization component). In other cases, WAVE_IN includes multiple frequencies having a single polarization orientation component. In still other cases, WAVE_IN has a single polarization orientation type and a single frequency so element 4120 apportions WAVE_IN into individual wave_components that may have equal or unequal amplitudes. Some alternative cases will include combinations of these cases or other division of WAVE_IN. In all of these cases, first property element preprocesses WAVE_IN to separate it into the appropriate independent wave_components (e.g., orthogonal polarization components or discrete frequency components) and direct each independent wave_component into an appropriate channel.

Similarly, second property element 4125 has a second attribute corresponding the second attribute described above for first property element 4120. The second property element 4125 second attribute combines/merges output radiation wave_components from the individual waveguiding channels (that may have been influenced and operated upon during propagation through transport) to integrate the wave_components (and in the preferred embodiment to also pass an appropriate amplitude for each wave_component) into WAVE_OUT.

As has been described herein, the preferred embodiment of the present invention uses an optic fiber as transport 4105x and primarily implements amplitude control by use of the ‘linear’ Faraday Effect. While the Faraday Effect is a linear effect in which a polarization rotational angular change of propagating radiation is directly related to a magnitude of a magnetic field applied in the direction of propagation based upon the length over which the field is applied and the Verdet constant of the material through which the radiation is propagated. Materials used in a transport may not, however, have a linear response to an inducing magnetic field, e.g., such as from an influencer, in establishing a desired magnetic field strength. In this sense, an actual output amplitude of the propagated radiation may be non-linear in response to an applied signal from controller and/or influencer magnetic field and/or polarization and/or other attribute or characteristic of modulator 4100 or of WAVE_IN. For purposes of the present discussion, characterization of modulator 4100 (or element thereof) in terms of one or more system variables is referred to as an attenuation profile of modulator 4100 (or element thereof).

Any given attenuation profile may be tailored to a particular embodiment, such as for example by controlling a composition, orientation, and/or ordering of modulator 4100 or element thereof. For example, changing materials making up transport may change the ‘influencibility’ of the transport or alter the degree to which the influencer ‘influences’ any particular propagating wave_component. This is but one example of a composition attenuation profile. Modulator 4100 of the preferred embodiment enables attenuation smoothing in which different waveguiding channels have different attenuation profiles. For example in some implementations having attenuation profiles dependent on polarization handedness, modulator 4100 may provide transport 4105 for left handed polarized wave_components with a different attenuation profile than the attenuation profile used for the complementary waveguiding channel of second transport 905 for right handed polarized wave_components.

There are additional mechanisms for adjusting attenuation profiles in addition to the discussion above describing provision of differing material compositions for the transports. In some embodiments wave_component generation/modification may not be strictly ‘commutative’ in response to an order of modulator 4100 elements that the propagating radiation traverses from WAVE_IN to WAVE_OUT. In these instances, it is possible to alter an attenuation profile by providing a different ordering of the non-commutative elements. This is but one example of a configuration attenuation profile. In other embodiments, establishing differing ‘rotational bias’ for each waveguiding channel creates different attenuation profiles. As described above, some transports are configured with a predefined orientation between an input polarizer and an output polarizer/analyzer. For example, this angle may be zero degrees (typically defining a ‘normally ON’ channel) or it may be ninety degrees (typically defining a ‘normally OFF’ channel). Any given channel may have a different response in various angular displacement regions (that is, from zero to thirty degrees, from thirty to sixty degrees, and from sixty to ninety degrees). Different channels may be biased (for example with default ‘DC’ influencer signals) into different displacement regions with the influencer influencing the propagating wave_component about this biased rotation. This is but one example of an operational attenuation profile. Reasons for having multiple waveguiding channels and tailoring/matching/complementing attenuation profiles for the channels include power saving, efficiency, and uniformity in WAVE_OUT.

Integrating Polarization Filtering into the Fiber Structure: Implementing in-fiber Polarization or Implementing Asymmetric Polarization (polarization specific) fiber structures. Integration of polarization filtering in optical fibers is known to the art, including the early art disclosed by U.S. Pat. No. 4,606,605. By this method, periodic perturbations of the fiber with period equal to the birefringence beat length acts to cumulatively convert the polarization of one polarization axis to another.

A preferred prior art method was to twist the fiber to effect the perturbations. But this twist is implemented to effect strain on the fiber, which weakens the fiber and introduces complications into the manufacturing of other elements of the integrated Faraday attenuator optical fiber device of the embodiments of the present invention. But since the aim of effecting the perturbations is to alter the birefringence at the beat lengths, other methods known to the art can currently be implemented.

According to currently known methods, including ion bombardment and doping of fibers with photorefractive material that may be effected by exposure of UV light to change the birefringence, and according to methods such as those disclosed in U.S. Pat. No. 6,467,313 (Method of controlling dopant profiles) and U.S. Pat. No. 6,542,665 (Grin fiber lenses), in which precision control over dopant areas and geometries of concentration are effected, allows an inline polarization filter to be fabricated in the input portion of the overall integrated Faraday attenuator optical fiber element by an efficient and precise method.

When the same method is implemented at the output end of the same integrated Faraday attenuator optical fiber element, but forming a polarization conversion beat structure corresponding to an analyzer with respect to the input polarizer, then integration of polarization filtering in-fiber is accomplished.

Alternatively to the method of converting incident light of two orthogonal polarizations into one selected polarization is to implement a polarization asymmetric waveguide. A method disclosed in a recent Lucent Technologies patent implements a polarization asymmetric active optical waveguide, that suppresses the propagation of certain polarizations. Reference U.S. Pat. No. 6,151,429. The utility of this method should be apparent in regard to the goal of further integrating functionality into a compound fiber structure and fiber fabrication processes.

A modified application of this method, with novel implementation to an integrated Faraday attenuator fiber optic component is disclosed as follows:

A periodic alteration is made to the compound fiber structure according to the Lucent methods, with its variants, previously disclosed, along a minimal initial portion of the fiber at its input end. Thus, in a long batch run, fiber is periodically doped and processed according to the Lucent process, such that, as light enters the input end, one polarization mode is supported and another suppressed. This polarization suppression process implements a polarization filter in the fiber structure, prior to the compound Faraday attenuator fiber structure.

Thus, only one polarization mode enters the Faraday attenuator fiber structure; after whatever desired magnitude of rotation is obtained, the resultant polarized light continues to a second polarization asymmetric segment of fiber, which suppresses oppositely to the first polarization asymmetric segment of fiber.

This integration of polarization filter into the fiber structure itself is a more compact method of implementing multiple, differently-polarized channels for each R, G, B subpixel. According to other embodiments of the present invention, a polarization thinfilm or coating may be applied to the input ends of individual fibers or semiconductor waveguides, per R, G, and B strip or ribbon structure, so that there are two strips of R, G and B, each channeling oppositely polarized light into the Faraday attenuator structure. Given a ratio of fiber size to subpixel dimensions, two fibers per subpixel may be practical.

A new method, commercially available from Nano-Opto corporation, employs sub-wavelength diffraction grids to achieve polarization filtering or splitting. As would be implemented for optical fiber structuring, in contrast to the semiconductor wafer applications, the sub-wavelength nano-scale grid structures would be fabricated by Nano-Opto's methods in the input and output sections of the fiber core.

In the present case, in which polarization filtering is implemented integrally in the fiber before and after the Faraday attenuator structures as a ‘polarizer’ and ‘analyzer,’ multiple polarization channels per subpixel is efficiently enabled.

RF excited gas bubbles in fiber for integral illumination—A final component of some embodiments of the present invention that may be advantageously integrated into the waveguide structure (fiber or semiconductor or other) is the illumination system.

Integration of the illumination source into the fiber structure is accomplished by a novel implementation of a type of illumination device known to the art in which illumination is achieved by excitation of a confined gas by an RF transmitter tuned to an appropriate wavelength. U.S. Pat. No. 6,476,565, Remote Powered Electrodeless Light Bulb, discloses a transmitter and independent bulb illumination system in which the bulb has no electrical connection and is simply a sealed vessel containing argon or other noble gas and a fluorescent material. Placing the bulb in proximity (range can be set anywhere from 1 to 25 feet remote from RF system) to the RF wave results in stimulation of the noble gas in the UV range, which in turn excites the fluorescent material.

Other remote, electrodeless illumination systems are known to the art, deriving back to Tesla, U.S. Pat. Nos. 454,622 and 455,069, June 1891, but U.S. Pat. No. 6,476,565 indicates a more advantageous configuration, although different in application and usage than the remote electrodeless illumination system disclosed following: As implemented as a component of an optical switching paradigm that has been disclosed by a preferred embodiment of the present invention, this configuration is compatible with any waveguide embodiments, whether fiber optic or semiconductor waveguide or other. The fiber optic version is disclosed in detail.

An RF transmitter or transmitters are implemented in the display or switching case. Periodically in the preform core/and or cladding, instead of being eliminated as is customary, a certain density of micro-gas bubbles are instead allowed to form through the injection of argon or other noble gas in the molten silica. These are injected in limited bursts. Considering that inert gas is a common element enabling practical rare-earth and other doping in optical fiber, the acceptance of some density of micro-bubbles that otherwise are systematically suppressed is a feasible design parameter modification. As the fiber is drawn, bubbles are suppressed as is customary, except for periodic bands corresponding to the input end of the periodic Faraday attenuator structure. The length of fiber containing the micro-bubbles is determined by the display brightness requirements and the output constraints of the RF transmitter(s). Also in the length of fiber in which a density of micro-bubbles containing argon or other noble gas is allowed to form, a fluorescent material is added as a dopant. This may be in addition to or instead of the dye doping otherwise preferable. The fluorescent material and gas are chosen for each RGB color subpixel element such that the excited noble gas in the micro-bubble emits a UV frequency at a proper frequency to then excite the fluorescent material in the solid-state core to emit either R, G, or B light at the proper frequency. Dye doping of the entire fiber helps ensure that the color is properly balanced. The integral illumination scheme may be implemented in the same section or just prior to the section of fiber at the input end in which asymmetric polarization is implemented. Alternatively, a fused-fiber faceplate with fused fibers of exactly matching dimensions as the Faraday attenuator fiber components, including silica fiber spacers when necessary or desirable to match the separation between the Faraday attenuator fiber components, is implemented with the integral illumination scheme. A polarization thin-film, as is specified elsewhere herein, is then adhered then to either the faceplate or mutually adhered to the faceplate and the switching matrix structure (if flexible, the integral illumination array of fibers may be woven or bonded with a flexible polymer matrix, and thus is not a faceplate per se but none-the-less matches in all structural dimensions to the switching matrix).

It should be evident to those skilled in the art of the various systems, components, methods and practices disclosed and referenced herein that the variety of optical fiber structural schemes for which implementations of the present invention are herein specified are not themselves mutually exclusive. More specifically, that complex, compound fiber structures are possible and that such combinations of standard core & cladding, photonic crystal with holes and channels, and helical-superficial channeled fiber may offer various advantages in implementing variants of the structures and methods disclosed by the present invention and of the optical fiber embodiments in particular. Such compound structures, in which periodic holes or channels may be formed by fusing of silica filaments or heating post-drawing, and cores thus formed may be further surrounded by cladding that itself is channeled with helical-superficial waveguide material, provide opportunities for functional integration of opto-electronic or electro-photonic devices or processes into the compound fiber structures themselves. Fibers or filaments that are part of compound fiber structures themselves may be twisted around their own cores or into helical channels or around unchanneled fiber claddings.

The more complex the structures, of course, the greater the likely cost per unit length of compound fiber so fabricated (although not necessarily, as co-doping and consolidation of processes may make additional ‘components’ or functionality relatively costless). But any cost increase may be offset by reduction in the number of separate fiber components or the implementation of complex structures that implement devices that otherwise may be more expensive fabricated separately, or only inefficiently implemented or impossible to otherwise implement at all.

And because these structures are fabricated for densely-packed three-dimensional switching matrixes, rather than fabricated in extremely large batches for fiber that must stretch under the ocean floor, the fiber fabrication paradigm effectively leverages the cost efficiencies of those high-volume, simpler fiber products by using the same or modified versions of the same machinery and materials. And by batch or volume manufacturing of these specialized fiber structures, which are needed in comparatively small quantities when cut or cleaved into separate components, the costs of such fiber-integrated components effectively benefit from volume production runs distinctly different from semiconductor or discrete component production processes for devices in the same general family.

‘Analyzer’ Polarization Mechanism Interposed Between Output end of Faraday Attenuator Fibers and Display Surface—A thinfilm polarizer, 90 degrees offset from the ‘input’ polarizer between the input ends of the optical fibers and the illumination source, is either deposited on the sol-filled output-end of the switching matrix/textile matte, or on an optical glass or optical glass sandwich structure that constitutes the outer display.

Alternatively, a thinfilm or coating may be applied to the output ends of the fibers individually, as part of the cleaving and modulation of the output ends woven into the ‘x’ ribbons, described above, or after the weaving of ribbons (all of which consist of fibers that will address the same color subpixel). Optionally, as disclosed above, the polarization filter or asymmetry may be integrated into the fiber structure itself.

Outer Optical Surface of Display, Optimization of Output From Fiber to Pixel—Depending on the size of the display, its resolution and the resulting dimensions of the pixels formed on the display surface, relative to the diameter of the optical fibers that integrate the Faraday attenuator system and color display mechanisms, several options regarding the final optics of the display may be employed:

The following discussion relates to a Large Display and corresponding Large Pixel Size, Relative to Fiber Diameter—The superior viewing angle characteristics of even flat-cleaved fiber ends is the starting point for further improvements to display performance. A large display itself naturally requires a proportionally greater source illumination. The optical channels, controlling and conveying the light from the illumination source and modulating that light through the integrated Faraday attenuator and color selection system, are not limited in the intensity of light they can channel.

Thus, even in the case of one fiber per color subpixel that is significantly smaller than the dimensions of a pixel area on a large HDTV display, the output intensity, combined with the dispersion angle of light emitted from the fiber end, effectively radiates light across the radius of the subpixel and pixel at a small dispersion angle relative to the plane of the display surface.

Additional forming and manipulation of the output fiber end, including changing the shape of that output end, introduction of random micro-surface abrasions to the surface of the output end, shrinking of the core dimensions by stretching and thus making possible light dispersion through the cladding itself, and other structural modifications can further increase the dispersion of light from the fiber ends. These modifications are specified as options that may be included in the cleaving process that separates the individual ‘x’ ribbons from the fabric woven of the optical fiber, etc.

An additional option for changing the optical characteristics of the fibers is implemented in the original fiber manufacturing process itself. A variable die may be employed during the fiber drawing, such that the die that controls the fiber to it standard diameter may be temporarily widened to effect period bulges in the fiber. These bulges are then the cleaving points for the output ends of the fibers. When the fibers are cleaved at the maximum diameter, the result is a fiber whose core dimension in particular is increasing rapidly up to the cleaving point. If this option is implemented, a separate cleave is made to eliminate the bulge section from the input section of the fiber.

Alternatively, instead of a variable die, a second die may be interposed while the original fixed-dimension die is simply unlocked. The second die (or, in principle, a variable die, although that may introduce too many mechanical complications) may then not only temporarily increase the diameter of the fiber at the output cleaving point, but may also temporarily introduce a non-circular shape to the fiber at that point. Square, ribbed, or other geometries may be introduced so that, combined with the increase in diameter, the cleaved output ends of the fiber may, when woven in a ribbon, come close to touching each other at the output ends, and may also, through their exterior cladding geometries, form a self-locking surface.

An increased diameter then not only increases the dispersion characteristics at the surface through widening of the core, but may decrease the difference between the diameter of the fiber and the subpixel dimensions of a large display.

Use of Wider-diameter Fibers in Cases of a Large Display with Relatively Large Pixels—This is a simple strategy for improving the viewing angle in cases of large displays with relatively large effective pixel areas.

In addition to these processes, a final optical glass may be employed and coatings added to the surfaces of that glass to further enhance the viewing angle, methods well established and known to the art.

Implementation of Multiple Fibers per Subpixel—Multiple fibers per subpixel, that is, multiple red, green, and blue light channels, may also be implemented to improve display performance in cases where the effective pixel dimensions are relatively large compared to optical fiber diameters.

In some implementations, stereographic or ‘multidimensional’ display systems (e.g., three-dimensional displays) are enabled by providing multiple fibers per subpixel/pixel—such as for example, providing two channels per pixel: a ‘left’ channel and a ‘right’ channel with each channel separately resolved/rendered/perceived such as for example, use of a stereographic goggle system compatible with the display. Staggering of the output ends of said multiple fibers per color, such that each end extends a slightly different distance relative to the display surface, may also further randomize the geometry of the display surface overall. Reflective coating of output ends in a staggered arrangement can further improve scattering from the output points. Spacer fibers may also be extended as far out as the light channel fibers, and by coating of these fibers with reflective material, further increase the scattering of light at the display surface.

These preferred embodiments of the present invention disclosed in the preceding is, by virtue of the system, its components, methods of fabrication and assembly, and advantageous modes of operation, extremely thin and compact, either rigid or flexible in structure, of extremely low cost of production, and possessing superior viewing angle, resolution, brightness, contrast, and in general, superior performance characteristics. It should be apparent to those skilled in the art of precision textile manufacturing that the construction and methods described do not exhaust the scope of this embodiment of the present invention, which includes all variants in textile manufacturing of a three-dimensional woven switching matrix as required to assemble the components, in textile-fashion, of a fiber-optic based magneto-optic display incorporating integrated Faraday attenuation and color selection in the optical fiber elements.

Application of Three-dimensional Textile Switching Structure Beyond the Field of the Present Invention—To expand on the previous observation made in regard to the inventive significance of the integrated optical-fiber opto-electronic component devices disclosed by the present invention, it is of great significance that the three-dimensional textile assembly of such integrated componentry proposes an alternative paradigm for integrated opto-electronic or electro-photonic computing. It has direct application as a switching matrix for wave division multiplexing (WDM) systems, and more broadly, as an alternative IC paradigm of LSI and VLSI scaling, optimally combining photonic and semiconductor electronic components.

As such, the disclosure of the apparatus of the preferred embodiment and the manufacturing method of same has intrinsically wide application. Indeed, this preferred embodiment may be restated in another way, with powerful implications:

Alternative Definition of the Present Fiber-optic Textile Embodiment of the FLAT invention—Textile-optical fiber matrix also defined as a ‘three-dimensional fiber-optic textile-structured integrated circuit device’ configured to form a display-output surface array.’ An example of an application of preferred embodiments of this invention outside of the strict field of displays would be a textile-optical fiber matrix configured as a field-programmable gate array and the like. The combined advantages of three-dimensional textile geometry for integrating elements; the optimized combination of photonics and electronics, each implemented according to its strengths; the IC potential of fiber as a high-tensile-strength self-substrate for semiconductor elements and photonic elements both, with multi-layer claddings and coatings implementing ‘monolithic’ structures in depth, wrapped around and forming continuous surfaces around a photonic core; all those efficiencies, along with the manufacturing cost advantages of textile-weaving to form electro-optic textile blocks, and the cost advantages of large-batch fabrication of fibers, suggest a significant alternative to the planar semiconductor wafer paradigm.

The new paradigm introduced by the preferred optical fiber embodiment of the present invention allows for combinations of fiber-optic and other conductive and IC-structured fibers and filaments in a three-dimensional micro-textile matrix. Larger diameter fibers, as disclosed elsewhere herein, may have integrally fabricated inter- and intra-cladding complete microprocessor devices; smaller fibers may have smaller IC devices; and as photonic crystal fibers and other optical fiber structures, especially single-mode fibers, approach nano-scale diameters, individual fibers may only integrate a few IC features/elements along their cylindrical length.

A complex micro-textile matrix may thus be woven with optical fibers of varying diameters, combined with other filaments, including nano-fibers, that are conductive or structural, which also may be fabricated with periodic IC elements inter- or intra-cladding. Fibers may be elements of larger photonic circulator structures, and may be fused or spliced back into the micro-optical network.

Fibers of such micro-textile matrices may also be fabricated with cores and claddings of equal indices of refraction, including transparent IC structures, including coilforms/field generation elements, electrodes, transistors, capacitors, etc. etc., such that the woven textile structure may be infused with a sol that when UV cured, possesses the requisite differential refractive index such that the inter-fiber/inter-filament sol becomes, when solidified, the replacement of individual claddings.

This procedure may be developed further by successive saturations of the micro-textile structure with baths of electrostatic self-assembly of nanoparticles. Looming action to separate filament strands can facilitate patterning of fibers and filaments while woven, although patterning prior to weaving or when fibers or filaments are in semi-parallel combination will be more flexible.

The potential, through these methods and others known to the art of materials processing, of controlling the structure of the inter-fiber sol, such that light-tapping and photonic band-gap switching between fiber junctions (see U.S. Pat. No. 6,278,105) will be greatly facilitated, should be evident. The functioning of the integrated Faraday attenuator optical fiber also as a memory element in such an IC structure has implications for cache implementation in LSI and VLSI-scale structures. Field Programmable Gate Arrays (FPGAs) present a fertile area of implementation for this IC architecture paradigm.

An “available” complexity of woven micro-textile structures with optical fibers and other micro-filaments will increase as the maximum angle of bending without destroying the wave guiding of optical fibers improves; recent reported research into the properties of thin capillary light fibers grown by deep-sea organisms revealed optical guiding structures that could be twisted and bent to the point of doubling back. Three-dimensional weaving of the micro-textile IC system type herein disclosed will thereby include non-rectilinear weaving—such as compound-curved three-dimensional weaving as is demonstrated by complex woven turbine structures known to the art—and in general the micro-textile device class and method of manufacturing herein disclosed encompasses the full range of precision three-dimensional weaving geometries known and to be developed.

Further development of the micro-textile paradigm, with small-diameter fibers and filaments, will be expected to advance through the use of commercially available nano-assembly methods, in particular from Zyvex Corporation, whose nano-manipulator technology may be implemented as a ‘nanoloom’ system, as well as from Arryx, whose nano-scaled optical tweezers are also well-suited to a micro-weaving manufacturing process, optionally in combination with the Zyvex nano-manipulators in an efficient mechanical/optical looming paradigm, whose operation would be patterned on a micro or nano-scale on the methods and equipment exemplified by Albany International Techniweave.

The known 1000:1 speed differential between light traveling in an optically transparent medium and electrons in a conductive medium implies degrees of freedom in structuring electronic and photonic elements, loosening some constraints on the sole focus on reducing the size of semiconductor features, which made possible by this micro-textile IC architecture—ultimately allowing for an optimum mixture of electronic and photonic switching and circuit-path elements. Thus, some fibers may be fabricated with larger diameters to support larger numbers of semiconductor elements inter- and intra-cladding, while other fibers may be of extremely small diameters, incorporating only a few electronic components, and some fibers with only ‘all-optical’ components. Maximizing the number of ‘path-elements’ that are photonic, and therefore allowing for smaller micro-processor structures fabricated in optimally-scaled fibers connected by photonic pathways, are a logical outcome of the optimization possibilities.

An implied micro-textile IC ‘cube’ (or other three-dimensional micro-textile structure) thus may consist of any number of combinations of larger and smaller optical fibers and other filaments, conductive, micro-capillary and filled with circulating fluid to provide cooling to the structure, and purely structural (or structural by micro-structured with semiconductor elements, and conductive (or conductive-coated with micro-structured inner claddings, electronic and photonic).

Transverse Faraday-attenuator Device—Switching inter-fiber in such a micro-textile architecture may be facilitated by a ‘transverse’ (vs. ‘in-line’) variant of the integrated micro-Faraday attenuator optical fiber element in the following way.

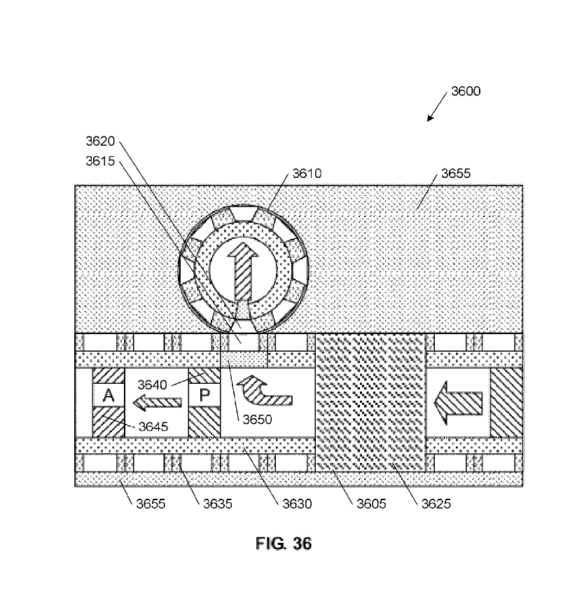

FIG. 36 is a general schematic diagram of a transverse integrated modulator switch/junction system 3600 according to a preferred embodiment of the present invention. System 3600 provides a mechanism for redirecting a propagation of radiation in one waveguide channel 3605 to another lateral waveguide channel 3610 using a pair of lateral ports (port 3615 in channel 3605 and port 3620 in channel 3610) in the waveguides as further described below. First channel 3605 is configured having influencer segment 3625 (e.g., the integrated coilform) and the optional first optional bounding region 3630 and second optional bounding region 3635 as described above and in the incorporated patent applications. Additionally, first channel 3605 includes a polarizer 3640 and corresponding analyzer 3645 (and may include an optional secondary influencer (not shown for clarity). First channel includes a lateral polarization analyzer port 3650 in a portion of the first bounding region 3630 proximate port 3615 provided in second bounding region 3630. An optional material 3655 is provided surrounding channel 3605 and channel 3610 at the junction to improve any lossiness through the junction. Material 3655 may be a cured sol, nano-self-assembled special material or the like having a desired index of refraction to decrease signal loss as well as helping to ensure the desired alignment of port 3615 and port 3620. Influencer 3625 controls a polarization of radiation propagating through first channel 3605 and an amount of radiation passing through port 3615 based upon a relative angle of polarization compared to a transmission axis of analyzer port 3650. Further structure and operation of system 3600 is described below.

Port 3615 and port 3620 are guiding structures in the bounding region(s) implemented through fused fiber starter method described below or the like and may include GRIN lens structures. These ports may be positioned in precise locations in the bounding regions or the ports may be disposed periodically along a length (or portion of a length) of the channels. In some embodiments, entire portions of one of the bounding regions may have the desired attribute (polarization or port) structure and one or more corresponding structures in the other bounding region at the junction location.

Polarizer 3640 and analyzer 3645 are optional structures that control an amplitude of radiation propagating further down channel 3605. Polarizer 3640 and analyzer, including any optional influencer element for this segment, in cooperation with influencer 3625 control radiation signal propagation between channel 3605 and 3610.

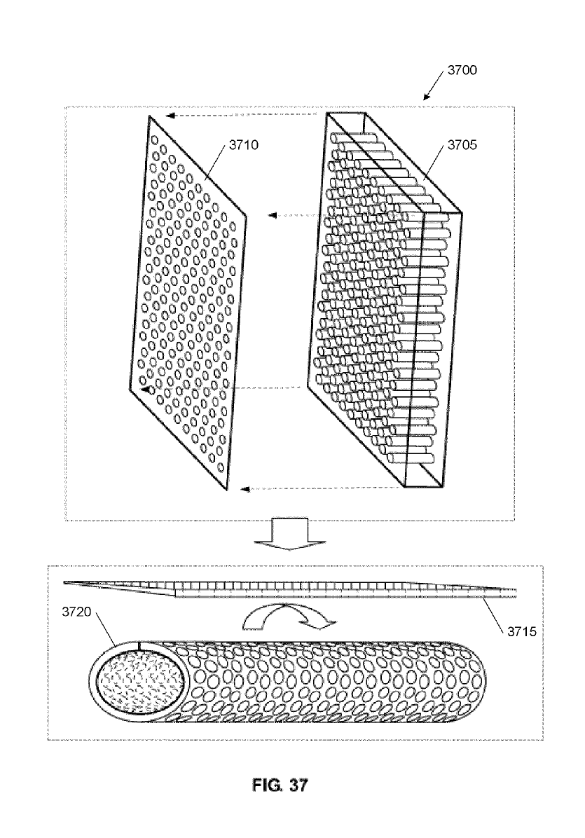

FIG. 37 is a general schematic diagram of a series of fabrication steps for transverse integrated modulator switch/junction 3600 shown in FIG. 36. Fabrication system 3700 includes formation of a block of material 3705 having many waveguiding channels (e.g., a fused-fiber faceplate as described in the incorporated provisional patent application and the like), with thin sections 3710 of block 3705 removed. A section 3710 is softened and prepared to form a starter wall sheet 3715. Sheet 3715 is rolled to form silica starter tube 3720 for producing a desired preform for drawing.

A junction point/contact point between orthogonally positioned fibers in a textile matrix is the locus of a new type of ‘light tap’ between fibers. In the cladding 1 of an optical fiber micro-Faraday attenuator according to a preferred embodiment of the present invention, the cladding (on the axis of the fiber external to multiple Faraday attenuator sections of the fiber) is micro-structured with periodic refractive index changes to be polarization-filtering (see fiber-integral polarization filtering previously disclosed herein and sub-wavelength nano-grids by Nano-Opto Corporation) or polarization asymmetric (referenced and disclosed previously). In the same sections, the index of refraction has been altered (by ion implantation, electrically, heating, photoreactively, or by other implementation known to the art) to be equal to that of the core. (Alternatively, the entire cladding 1 is so microstructured and of equal index of refraction).

It is of the essence of this variant of the integrated Faraday-attenuator disclosed herein that it is fundamentally distinguished from all other prior-art ‘light-taps,’ including those of Gemfire Corporation, in which the waveguide itself is collapsed in order to couple semiconductor optical waveguides. The collapse of the waveguiding structures meaning the destruction of a virtuous component of any photonic or electro-photonic switching paradigm or network, which ensures efficient transmission of an optical signal between channels. A ‘light-tap’ that does not need, as all other types of ‘light-tap’ do, additional and complicated compensations to control the unguided signal between core-regions, is simpler and more efficient by definition.

Thus, by contrast with other ‘light-taps’ in the prior art, the switching mechanism is not the activation of a poled region, or the activation of an array of electrodes, to effect a grating structure. It is, rather, the in-line Faraday attenuator switch which rotates the angle of polarization of light propagating through a core to, and by virtue of a combining that switch with section of cladding which is effectively a polarization filter, results in the diversion of a precisely controlled portion of signal through the transverse guiding structure in the claddings of the output and input fiber (or waveguide). The speed of the switch is the speed of the Faraday attenuator, as opposed to the speed of changing the chemical characteristics of a relatively extensive region covered by cathode and anode.

In the Cladding 2 with an index of refraction sufficiently different from core (and optionally also cladding 1) to implement total internal reflection in the core (and optionally cladding 1), (on the axis of the fiber external to the an integrated Faraday attenuator section), either one of two structures are fabricated:

a) a gradient index (GRIN) lens structure in the cladding and with optical axis at a right angles or close to a right angle to the axis of the fiber, and fabricated according to the methods referenced elsewhere herein. The focal path oriented either at right angles to the axis of the optical fiber, or offset slightly, such that light passing through the GRIN lens from the optical fiber 1 will couple at the contact point with optical fiber 2 and insert at right angles also to the axis of optical fiber 2, or will insert at an angle into the optical fiber 2 at a preferred direction.

b) A simpler optical channel of the same index of refraction as the core (and optionally cladding 1), fabricated by ion implantation, by application of a voltage between electrodes in the manufacturing process, by heating, photoreactively, or by other systems known to the art. The axis of this simple waveguiding channel may be at right angles or slightly offset, as in option a) above.

Operation of this micro-Faraday attenuator-based ‘light-tap,’ or more accurately defined, ‘transverse fiber-to-fiber (or waveguide-to-waveguide) Faraday attenuator switch’ is accomplished when the angle of polarization is rotated by passing through an activated integrated micro-Faraday attenuator section, and ‘leaks’ (according to known operation of a fiber ‘light-tap’) or, more accurately defined, is guided through the cladding 1 and into either the GRIN lens structure in cladding 2 or the simpler optical channel, and from either output channel, coupling into optical fiber 2.

Optical fiber 2 is fabricated to optimally couple the light received from optical fiber 1 by a parallel structure (GRIN lens or cladding waveguide channel in cladding 2) into the polarization-filtering or asymmetric cladding 1 and from there into the core of optical fiber 2.

Surrounding the fiber-to-fiber matrix, as previously indicated, is a cured sol which impregnates the textile-structure, and which possesses a differential index of refraction that confines the light guided between fibers (or waveguides) and ensures efficiency of coupling.

An advantageous alternative and novel method of micro-structuring the claddings may be accomplished by the specification of a novel modification of MCVD/PMCVD/PCVD/OVD preform fabrication methods.

Method of Fabricating Transverse Waveguiding Structures in a Preform—According to this novel method, the silica tube upon which soots are deposited to grow the preform takes the form of a cylinder fabricated from a rolled and fused thin sheet of fused-fiber cross-sections. That is, optical fibers, optionally of different characteristics chosen for appropriate doping characteristics in claddings and cores, alternating such differently-optimized fibers in order to implement grids of thin-fiber sections with different indices of refraction and different electro-optic properties, are fused, and sections of the fused fiber matrix are cut into thin sheets. These sheets are then uniformly heated and softened and bent around a heated shaping pin to accomplish a thin-walled cylinder suitable as a starter for fabricating a thin preform according to the known preform fabrication processes.

The dimensions of the fibers employed in the fused fiber sheets are chosen to result in the optimal dimensions of resulting transverse structures in claddings for fibers drawn therefrom. But in general, fibers for this purpose are of minimum possible fabrication dimension (cores and claddings), as structure diameters will effectively increase during the drawing from a preform fabricated thereby. Such fiber dimensions may in fact be, in cross-section, too small for even single-mode use as individual fibers. But combined with the appropriate choice of thickness for the fused-fiber section or slice, the dimensions of the continuously-patterned transverse waveguiding structures in the resulting drawn-fiber cladding may be controlled such that the transverse structures have the desired (single-mode, multi-mode) ‘core’ and ‘cladding’ dimensions.

To further ensure suitable dimensions to the micro-structures, smaller combinations of fibers may be fused and softened and drawn, and then fused again with other fibers, before the final array of fibers are fused in lengths and then cut into sheets for forming into cylinders.

To facilitate flexibility in the implementation of this fiber-to-fiber variant of the integrated Faraday attenuator device of the present invention, the polarization sections in the core and cladding 1 of optical fiber 1, both at the relative ‘input’ end and the relative ‘output’ end (which may hereby be reversible) may be switchably induced by electrode structures fabricated on or inter-/intra-cladding, according to methods referenced and disclosed elsewhere herein, or by UV excitation, according to known methods, such UV signal which may be generated by devices fabricated inter- or intra-cladding, according to forms and methods disclosed and referenced elsewhere herein. If by electrode structure, the switching of the polarization-filtering or asymmetry state may be described as elecro-optic, or if by UV signal, ‘all optical.’

The UV-activated variant disclosed herein is the most preferred embodiment for the switch with the other embodiments preferred in specific implementations. Such polarization filtering or asymmetric sections of core and cladding then may be termed ‘transient,’ see U.S. Pat. No. 5,126,874 (‘Method and apparatus for creating transient optical elements and circuits’), such that the filter or asymmetry elements may be activated or deactivated, switched ‘on’ or ‘off,’ along with the operation as a variable intensity switching element of the integrated Faraday attenuator.

Cladding 1 may be of the same index as the core, as indicated, with Cladding 2 possessing the differential index of refraction, such that confinement to the core of the ‘wrong’ polarization is achieved by the polarization filtering or asymmetry structure of the cladding alone. Thus, the default setting of cladding 1 may be either ‘on’, confining light to the core by polarization filter/asymmetry or ‘off,’ allowing light to be guided in core and cladding 1 and confined only by cladding 2, and then it may be in sections where the electrode or UV activation elements are structured, switchable to the setting opposite of the default.

One way to characterize the operation of the micro-textile three-dimensional IC would be that optical fibers, transversely structured with micro-guiding structures intra and inter-cladding, with IC elements and transistors integrating intra and inter-cladding with these channels, and with integrated in-line and transverse Faraday attenuator devices fabricated as periodic elements of the structure, may carry WDM-type multi-mode pulsed signals in the core as a bus, which are switched in-line or transverse by the integrated Faraday attenuator mechanism some or all of any signal pulse, through the transverse guiding structures in the claddings, to the semiconductor and photonic structures in the claddings, and also between fibers, serving as buses or as other electro-photonic components.

Some fibers may be nano-scale and single mode with single elements fabricated intra or inter-cladding, or may be larger diameter and multi or single-mode, and fabricated effectively with a very large (near micro-processor) number of semiconductor (electronic and photonic) elements between, in or on the claddings. Fibers may serve as buses or individual switching or memory elements, in any number of sizes and combinations with micro-structured IC elements in the fibers themselves, in combination in the overall micro-textile architecture. Switching, etc. thus occurs in the fiber cores, between cores and claddings, between elements in the claddings, and between fibers.

Demonstration by Eric Mazur, Limin Tong, and others at Harvard University of 50 nm ‘optical nanowires,’ which are fabricated, with surface smoothness at the atomic level and tensile strength two-to-five times that of spider silk, by a simple process of winding and heating glass fiber around a sapphire taper and then pulling a relative high-velocities, are extremely well-suited to implementation in a micro-textile structure. Visible to near-infrared wavelengths have been guided in this subwavelength diameter variant of the optical fiber waveguide type, but instead of confinement in a core, approximately have the guided light is carried internally and half evanescently along the surface. Significantly, light may be coupled with low loss by optical evanescent coupling between fibers.

Interposing, through injected sols or claddings and coatings of polarization boundaries/filters, as disclosed elsewhere herein or by any other mechanism, between such optical nano-wires, and then manipulating, through a transverse variant of the integrated Faraday attenuator devices disclosed elsewhere herein, provides a further simplified switching/junction device between paths.

The micro-textile IC structure is especially facilitated by properties of the optical nanowire due to the wire's flexibility, which allows them to be bent into right angles and in fact twisted or tied into knots.

Complementary work by Kerry Vahala at The California Institute of Technology, involving the fabrication of ‘optical wire’ in diameters of tens of microns, as well as related work under Vahala, demonstrating ultra-small, ultra-low threshold Raman lasers comprised of a silica micro-bead and the micron-scale optical wire, are also extremely useful for the micro-textile structure. Micro-beads interspersed in the micro-textile structure may be held in position by micro-textile structural elements and coupled to optical wires, implement further options for signal generation and manipulation in the 3D IC architecture.

Finally, the nature of the in-line and transverse Faraday attenuator switch/junctions, combined with optimal mixtures of photonic and electronic switching elements, inter-fiber, inter-cladding, and the like, suggests a novel method of implementing binary logic, by use of a constant optical signal but a changing polarization state only, as against an optical pulse regime. This binary logic system thereby incorporates ‘always-on’ optical paths whose logic state is manipulated and detected by use of the angle of polarization of the signal (sometimes exclusively based on the polarization angle), which may be varied at extremely high rates.

The disclosed variants of integrated Faraday attenuator devices, deployed in a mixed electro-photonic micro-textile IC architecture, may clearly implement such a binary logic scheme, introducing numerous possibilities for increases in speed and efficiency of micro-processor and optical communication operations.

These exemplary illustrations serve to establish the broad applicability of the novel textile-structure and switching architecture of the present display invention, including wave division multiplexing switching matrices and LSI and VLSI IC design optimizing photonic and semiconductor electronic elements, and those familiar with the art will recognize that the novel methods, components, systems, and architectures are not limited solely to the examples disclosed in detail.

An Alternate Preferred Embodiment: A ‘Component’ Optical Fiber-based—Display with Display Module Separate from Switching Module but linked by optical fiber bundles, with Switching Module Incorporating Fiber-bundles integrated with Semiconductor Addressing Wafer is disclosed following.

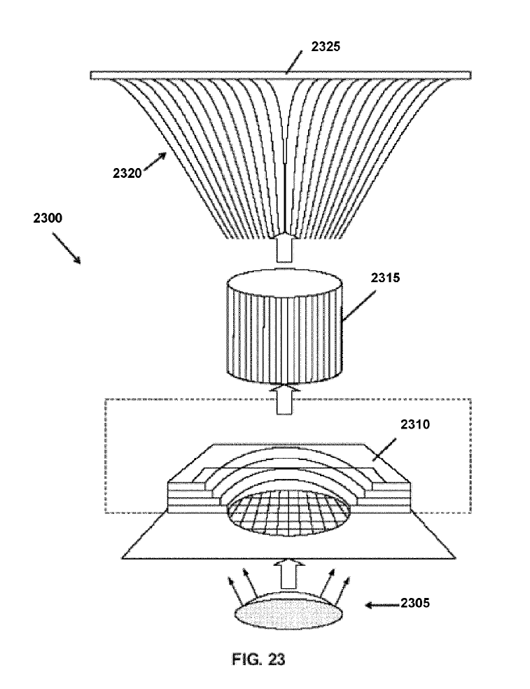

FIG. 23 is a schematic diagram of an preferred embodiment for an implementation of the componentized display system shown in FIG. 7. A componentized system 2300 includes an illumination module 2305 with a first communicating system 2310 (shown as a transparent silicon wafer in this embodiment) coupled to a modulating system 2315. Modulating system 2315 provides imaging information to a second communicating system 2320 coupled in turn to a display/projector surface 2325.

This preferred embodiment exploits the inherent potential of a magneto-optic display based on optical waveguiding, and in particular, employing optical fiber, to spatially separate the switching stage from the display or projection surface. The employment of optical fiber to channel light with negligible lossiness over long distances in fact makes possible very remote separation of the switching matrix or switching unit from the display face (or projection face). (This embodiment leverages improvements in precision alignment in the art, exemplified by the advances made by Steve Jacobsen at Sarcos and the University of Utah).

Taking the components of the overall system in structural order, in this case from a display surface to the source illumination, then:

A Loomed Display Surface Structure; rows of fibers woven with progressively reduced spacing; until fibers can be combined into single bundle or small number of smaller bundles, retaining relative position of display elements.

1. Display Surface and Output Ends of Fibers. The display surface is constructed as is specified in the previous preferred embodiment.

2. Textile Assembly of Fibers in Structural Matrix, Without ‘X’ and ‘Y’ Addressing Fibers. It is the absence of the switching component of the textile matte structure that is the point of departure of this embodiment from the previous embodiment.

3. In the looming of the ‘x’ ribbons, furthermore, instead of optical fibers that are cleaved at both ends to effectuate an extremely thin unitary display, only the output end is cleaved and shaped as in the previous embodiment.

4. The ribbons therefore remain as extensive pre-cleaved woven sheets, in the ‘z’ direction, with ‘x’ and ‘y’ filaments interwoven to fix the position of the fiber output ends. Thereafter, intermittent woven sections bind the fibers together in the same relative position, as at the display surface.

Fiber Bundle Retains relative Position of Fiber Output Ends at Display Surface—As shown and described herein, while the fibers woven with the ‘x’ and ‘Y’ structural elements, and filled with a UV-cured sol, are separated by an appropriate number of parallel spacing filaments, dictated by the relative diameter of fiber end and subpixel (and taking into account the options for improved output end/pixel performance already described), the spacing between optical channels is rapidly decreased from the dimensions required at the display face. As rows are woven together to form the display face as extensive sheets already woven together intermittently, it is only the ‘Y’ filaments that are added to the increasingly smaller woven squares that bind the extensive optical fibers together.

Thus, within the depth of a thin FPD case, the fibers will be close enough together to be bound by adhesive, retaining the relative position established at the display face. Therefore, the optical fiber bundle, bound with strapping and intermittent application of adhesive, may be inserted into a protective cable sleeve, emerging from the FPD case and then routed, by convenient means, to the remote switching unit.

In a similar manner to separate audio components in a stereo system, the switching matrix may be contained in a remote unit along with other audio/video equipment. The cable entering the switching unit, it is joined within that unit with a switching means, specified as follows:

Fiber Bundle Married to Silicon-Waver Addressing Grid on Fused-fiber Substrate—Bundled fibers butt-joined and bonded to transparent silicon wafer; wafer printed with addressing grid on fused-fiber substrate, bundled fibers precision-oriented and ‘locked’ into place by semiconductor-fabricated ‘socket’ structure mirroring external fiber-bundle topology, see for example system 2300 in FIG. 23.

The bundled fibers, inside the switching module casing, are butt-joined and bonded to a silicon wafer structure. To precision align the fiber bundle to the addressing grid fabricated on the surface of the wafer, around the addressing grid, a semiconductor mask process is employed to fabricate a precise socket-form to receive the bundle. That is, surrounding the addressing grid is an elevated superstrate, such that the addressing grid is found at the bottom of a cut-out that receives and aligns the fiber bundle. The socket-form has a graduated alignment structure, such that the socket begins larger than the diameter of the fiber-bundle, and then by steps progressively narrows until the final socket depth has a micro-alignment tolerance. To increase support for the fiber bundle, a precision-cut plate may be bonded to the surface of the wafer, and other alignment plates may be disposed in a columnar arrangement positioning the bundle and preventing stress on the bond between the bundle and the wafer structure. The bundle may be further joined to the columnar supporting die-cut plates by epoxy or other adhesive.

The substrate of the wafer is a fused-fiber structure in a bundle-geometry exactly the same dimension and fiber diameter, with spacing elements if required, as the bundle coming from the display face. The addressing grid fabricated on the transparent silicon layer(s) is precision positioned above the fused-fiber structure of the substrate.

One-to-one correspondence of the fiber-bundle, preserving the relative position of subpixel fibers from the display or projection face, to the addressing grid, may be ensured by cardinal-point striping of certain fibers. In a mechanical precision alignment apparatus, a typical laser-scanning device scans for the markings on the fibers, adjusting the position based on the reflection response.

In addition, a laser-positioning system may be employed that positions laser diode devices at the cardinal points of the display face and directly over an individual fiber output end, and specifically directs laser pulses down the fibers. A corresponding sensor array, positioned behind the transparent fused-fiber substrate of the silicon wafer, detects the laser pulses. The results of the detected positioning of the incident light allows the CCM positioning armature holding the fiber bundle to rotate the bundle to align the fiber input-ends appropriately with the addressing grid.

FIG. 24 is a schematic diagram of an addressing grid 2400 according to a preferred embodiment of the present invention. As discussed herein as well as in the incorporated patent application, an element of a display system of the preferred embodiments includes an influencer system for use in a modulation model. The preferred embodiment provides for a Faraday Effect as at least a part of the influencing system and to this end, the displays use coilforms for generation of the appropriate magnetic fields. As there may be hundreds, thousands, or more elements having a coilform structure, an efficient addressing system improves manufacturing and operational requirements. Addressing grid 2400 is an implementation of the preferred embodiment for an efficient addressing system.

Addressing grid 2400, which may be constructed as a passive or active matrix, is illustrated in both forms in FIG. 24. Grid 2400 includes an input contact 2405 and an output contact 2410 to produce an in-waveguide circuit path 2415 through the coilform/influencer element. An optional transparent transistor 2420 element is included for the active configuration (and absent in the passive mode). A four-quadrant schematic is but one of the possible embodiments of this approach. A consideration is a relative scaling of chip circuitry dimensions versus a diameter of the input fibers. The size of the circuitry dimensions should be small enough to pack enough conductive lines to individually address each fiber input-end. Spacing fibers may be retained all the way down through the fiber bundle in order to increase the spacing between fibers when necessary, or fibers of larger diameter may also be employed. The preferred choice will also depend on the size of the display or projection face.

In a passive matrix scheme illustrated, an ‘x’ addressing line contacts an inner conductive ring or point on the fiber input-end, while a ‘y’ addressing line contacts an outer conductive ring or point on the same fiber input end. The structure of the coilform or coil is preferably of the general principle as illustrated in FIG. 24, such that contact made on the inner ring or point is made to the coilform. Current then circulates through the windings or helical pattern around the core; then an outer thinfilm tape fabricated of sufficient insulating material and thickness and wound around the coilform is coated with conductive material as a thin margin on the interior contacting portion at the top edge of the coilform, and such coating continues around the edge of the thinfilm tape to the exterior face, down the face as a strip and terminating at the input end of the fiber. The resulting outer-ring contact point is insulated and spatially distinct from the inner-ring contact point.

The thinfilm tape is wound on fibers in the mass manufacturing process disclosed elsewhere herein. To provide selected conductive points from the outside of the thin film to the inside, the film is preferably perforated selectively with micro-perforations, achieved by mask-etching, laser, air-pressure perforation, or other methods known to the art before the printing or deposit of the conductive patterns. Thus, when the conductive material is deposited, in those regions with appropriately-sized perforations, the conductive material may be selectively-accessed or contacted through the perforations. Perforations may be circular or possess other geometries, including lines, squares, and more complicated combinations of shapes and shape-sizes.

An alternative, to provide selected conductive points from the outside layers of the fiber structure to the inside, the cladding or coating is preferably perforated selectively with micro-perforations, achieved by etching or other methods involving heating and stretching of a thin cladding and collapse of cavities resulting in oval holes disclosed elsewhere herein, or other methods known to the art before the printing or deposit of the conductive patterns. Thus, when the conductive material is deposited, in those regions with appropriately-sized perforations, the conductive material may be selectively-accessed or contacted through the perforations by the application of a conductor in liquid or powder form, which is then cured or annealed.

Also alternatively to the employment of printed thinfilms, an insulating coating is applied to the fiber during its bulk manufacture, but such coating is masked or the fiber is dipped in liquid polymer-type material only so far ‘up’ the input end of the fiber such that a thin terminating edge of the coilform is left uncoated. Then a second coating is applied that is conductive, extending in this instance all the way up to the exposed conductive terminus of the coilform.

Thus, logic external to the grid area joined to the fiber bundle switches current at a particular ‘x’ line and a particular ‘y’ line addressing a particular subpixel. Current switched at an ‘x’ coordinate, sends a pulse of appropriate current strength to the fiber subpixel element; that pulse passes ‘up’ the coilform or coil, and back ‘down’ the exterior conductive strip, continuing through the circuit down the ‘y’ conductive line and completing the circuit.

Variation on Fiber-bundle Handling—Instead of intermittent weaving to progressively narrow space between fibers and maintain their relative position as set at the display face: Randomly gathered from display surface and bundled as fibers, tight binding ensuring precise topology; fiber bundle bonded to silicon-wafer addressing matrix, employing calibration/programming of correspondence of addressing points on transparent silicon wafer on optical glass substrate.

This variant embodiment of the method disclosed above dispenses with the requirement of maintaining the relative position of the fibers from the display face. Instead, the fiber bundle, with or without spacing filaments, is inserted in a cable sleeve and routed to the switching module, as disclosed above. Then, in an extension to the positioning calibration method previously described, the randomly gathered bundle is butt-joined and bonded with clear optically pure adhesive, as above, to the silicon wafer on fused-fiber substrate without a pre-alignment process. Once bonded, a comprehensive process of identifying the display-face coordinate of each fiber is conducted, employing a laser emitter device at the display or projection face, and a detector array behind the clear wafer with fused-fiber substrate. The positioning data then obtained allows for individual programming of the controlling video chip that controls the addressing grid. Removing the constraint of physically ensuring consistent physical positioning of the fibers as they are woven or fixed at the display or projection face, and replacing that physical alignment with an individually calibrated chip that understands which subpixel fiber input-end corresponds to which subpixel fiber output point on the display face offers improvements in some implementations and applications.

Polarization Film Deposited on Bottom of Fused-Fiber Substrate After Calibration—After calibration, a polarization thinfilm is added to the bottom of the fused-fiber substrate.

A balanced white-light illumination source of sufficient luminosity is positioned ‘beneath’ the silicon wafer.

It should be apparent to those skilled in the art that the preceding specification of the present embodiment does not exhaust the scope of possibilities for separating a display or projection surface from a switching module, connected by means of optical fiber bundles.

Among the alternatives are the inclusion of fiber-bundle junctions, implementing the same micro-alignment socket or other convenient alignment systems employed in micro-mechanical alignment processes and in optical communications, in which a fiber bundle or bundles coming from a display or projector surface are connected in the junction to another bundle that is routed to the switching module. Such fiber-bundle junction or junctions can enable separate fabrication of the fibers woven or otherwise assembled in a display surface or projector array and the fibers that are combined in compact form and joined with a silicon wafer implementing the addressing system.

In addition, instead of one bundle bonded to one wafer, multiple smaller bundles, corresponding to sectors of the display or separating the colors of the display into three bundles of those subpixels, may be bonded to any number of smaller wafers. Smaller multiple bundles and smaller multiple wafers may possess optimal scaling in terms of manufacturing costs. Furthermore, in the event that larger-diameter fibers are advantageous to ensure ease of addressing inner and outer fiber components on the wafer surface by conveniently scaled circuitry, multiple bundles and wafers may be further indicated.

Display or Projector Versions Both Enabled:—A flat-panel display version according to the present embodiment may be implemented for any size display surface, from large flat panels to small display surfaces employed as binocular components of a virtual reality headset. In addition, the present embodiment equally lends itself to projector versions. There are two primary differences in implementation.

First, the source illumination intensity in a projection system is typically greater, depending on the type of projection system—ranging from a shallow-cabinet projection TV system to a large outdoor stadium theatrical projection system. (Although an outdoor unitary flat panel display system must be implemented with source illumination of sufficient intensity to make the FPD visible in bright daylight). Accommodation in the switching module for a substantial heatsink, for instance in the case in which xenon lamps, or other cooling system, may need to be provided.

The second difference is that instead of a relatively large textile-woven display surface, typically employing parallel spacing filaments and implementing other display surface performance enhancements as disclosed elsewhere herein, the fibers, while preferable still being fixed in position relative to each other by a woven structure, may be fixed by other means, including other means disclosed elsewhere herein, as well as binding by liquid polymer the UV cured.

Whatever positional fixing solution is employed, subsequent to that and immediately prior to the projector output surface, the fiber bundle should have no spacing elements between the fibers, and the fibers are then preferably fused by heating by standard methods known to the art, forming a fused-fiber faceplate.

Such fused-fiber faceplate is preferably fused for a sufficient length of the terminating fiber bundle to provide enough strength, combined optionally with a high-pressure banding of the bundle to prevent any relative movement of the fibers, to enable optical grinding of the fused fiber ends.

Such grinding and polishing of the fused fiber ends, forming for instance a concave output lens surface, while optional—a flat fused-fiber surface may be instead optimal, depending on the projector optics design—may be advantageous in realizing the most compact and optically-efficient projector optics array.

As a further improvement to projector face optics, which may also be advantageous for other embodiments disclosed elsewhere herein and otherwise encompassed by the present invention, is employment of a bulk micro-lens fabrication method as proposed by Eun-Hyun Park in the Journal of Korean Physical Society, Vol. 35, pp 21067˜s1070, published in 1999.

According to this method, a polymer microlens forms on a pedestal (preferably circular) by self-surface tension and by UV curing of the polymer so formed. This method lends itself very advantageously to exposed optical-fiber output ends in a projector or display surface, prior to inter-fiber ‘filling’ in which some exposed length of output-end fiber remains.

While the Park paper proposes insertion of the liquid polymer by micro-injection of the polymer on a prepared pedestal, the modification to the general method proposed in the paper for the purposes of the present invention is to batch-dip the output ends of the output ends of fibers by ribbon-row (or more generally, output row) or by entire display or projector face.

Such dipping may be with the ‘display’ or output end down precision dipped into a dip-tray filled with the polymer, such that a the micro-lens surface tension droplet forms on the fiber output ends functioning as the pedestals in the Kim paper.

Alternatively, the row or array may be raised to a thin film of liquid polymer saturating and adhering to electrostatically-charged porous micro-fabric or sponge, such that a tiny micro-droplet may be removed from the saturated fabric or sponge, leaving an appropriately formed micro-lens shape on the output end of each Faraday attenuator optical fiber element.

By either method or variations thereof, the liquid polymer adheres by self-surface tension and is cured by UV light.

This method of forming microlens elements for each output end may be employed in combination with another method for shaping a display or projector surface, such that an optically-efficient output structure is fabricated thereby.

In this method, elements of the structure supporting the fiber ends in the display or projector surface include niobium wires or thin perforated sheets of niobium (see methods for fabrication of displays with rigid perforated display structures disclosed elsewhere herein), which have previously been woven or formed around a optical lens shaping template when fabricated such that the original shape is ‘remembered’ by the niobium.

The curved or formed structure is then bent into linear shapes or wire, to be assembled with the Faraday attenuator optical fiber elements into a display or projector array, forming a planar display structure.

Thus, after the fibers are textile-woven along with niobium wire or inserted into the niobium sheets, and are dipped by the disclosed modification of the Park method to form microlens structures, the entire structure may then be heated so that the woven structure with niobium wire or perforated niobium sheet returns to the ‘original’ form of the optical shape desired. The microlenses then function as optical elements of a compound optical structure of utility in projector applications in particular, and other micro-display or image generation devices.

Alternatively to the formation of micro-lenses in this and similar fashion, is the fabrication of a GRIN fiber lens at the output end of the integrated Faraday attenuator optical fiber element. U.S. Pat. No. 6,252,665 reflects a relatively recent development, and is commercially available technology from Lucent Technologies. Precision control over dopant concentrations enables a refractive index whose value varies with radial distance from the axis of the lens, and thus obviates need for externally applied lens structures. This method is preferable also in that differing lens elements may be so fabricated, as required by the output optics demands of the display or projector system embodiment.

Any of the disclosed methods of shaping the a fused-fiber or densely-packed fiber array (display or projector) results in integrated optical output elements that may be employed in any of a number of digital optical printing and processing systems, ranging from digital film recording, lithography, and other digital print and recording applications.

While the preferred ‘all-fiber’ textile-woven fiber-optic embodiment represents a superlative leveraging of the structural and waveguiding advantages of a fiber-optic based magneto-optic display of the present invention, there are additional variations on the methods of assembling, fixing the position, and addressing the optical fiber Faraday attenuator elements that offer their own several advantages.

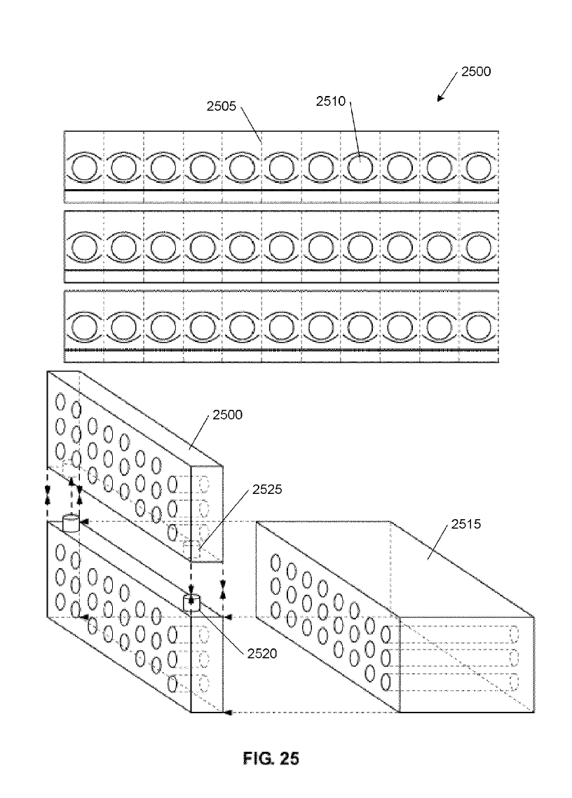

Fiber Unitary Flat Panel, Switching Matrix with Modular Components Assembled Mechanically—FIG. 25 is a schematic diagram of a preferred embodiment for a modular switching matrix 2500 used in the display shown in FIG. 5 and FIG. 6. Matrix 2500 includes one or more ‘gripper sheets’ 2505 holding and arranging a plurality of modulators 2510, preferably two or more facing sheets bonded or locked together to form a gripper block 2515. A gripper block 2515 includes a gripper-type stud connector 2520 for mating to a complementary receptacle 2525 also located in gripper block 2515. By stacking sheets 2505 to form blocks 2515 and arranging/locking multiple blocks 2515 an entire matrix 500 is formed, as further explained below. Blocks 2515 include embedded X/Y addressing matrix for coupling to the plurality of modulators 2510. In addition to the stud/receptacle mounting system, other inter-sheet/inter-block connecting systems may be employed, such as for example groove-flange and the like.

In this embodiment, commercially available Corning Gripper technology is modified thusly: (Corning introduced its Polymer Gripper technology at an Optical Fiber Conference in March 2002 that is a holding device that allows fibers to be snapped into place with sub-micron precision. Corning has extended the device's capabilities to include the holding and positioning of larger components such as ferrules, GRIN lenses and other optical elements with various geometry's.)

Optical fiber fabricated according to one of the novel methods previously disclosed is cleaved into convenient multi-element (multiple doped, coilformed, etc. segments fabricated in batch processes) lengths. Optionally, sheets of Corning Gripper are fabricated, but modified with the inclusion of a conductive filament (preferably wire, or stiff polymer) laid in the liquid polymer before curing, at right angles to the direction of the troughs and suspended so as to be exposed at the height of the bottom of each trough. Also, they are positioned so that when a fiber is laid in the trough, the filament contacts the coilform or coil at either the input end or output end of the Faraday attenuator element. Filaments are laid at distances in the corning gripper sheet corresponding precisely to the periodic formation of the integrated Faraday attenuator structures in the fibers. Holes are also left in the gripper by a wire that is later removed after curing; such holes are oriented at right angles at the opposite relative end of the Faraday attenuator optical fiber element.

In addition, on the back of the gripper sheets, on the side opposite the troughs, micro alignment tabs are formed in the Gripper material periodically, corresponding to the length of each Faraday attenuator fiber optic element. Also on the sides of each gripper sheet, in the same plane as the channels, will be alternating micro-ridges/grooves or tabs/indentations, such that if such sheets were positioned side-by-side, they could be locked together. Multiple optical fibers are loaded onto a Corning Gripper sheet and rolled by rubberized roller arrays into the Gripper channels until all channels are filled.

A mirror Corning Gripper Sheet is laid on top of the filled sheet and compressed to snap onto the fibers by a rubberized roller array. These gripper sheets have indentations formed in the backs periodically, to receive the tab structures fabricated on the backs of the bottom sheets. Multiple such Corning Gripper Sheet sandwiches are fabricated. The tabs on the backs of the ‘bottom’ sheets are inserted into the indentations in the backs of the ‘top sheets,’ implementing the same locking process effected by the trough structures on the fibers themselves.

These multiple Corning Gripper Sheets are further layered together and bonded with adhesive, supplementing the tab and indentation locking, forming blocks of two equal dimensions with hundreds or thousands of optical fiber elements per side, and a longer dimension corresponding to the axes of the fibers. Once a convenient stack of such sheets are assembled into said blocks, preferably in which the number of fibers laid in the sheet equals the number of sheets stacked and adhered, the stacks are cut periodically corresponding to the spaces between the periodic faraday attenuator structures in the batch-manufactured fibers. The sliced segments thus are in the form of ‘tiles,’ which are mechanically collected as sliced and then conveyed and stored for use in combination to structurally form the display.

Optionally, prior to the slicing of each ‘tile,’ in the case in which a conductive filament has been embedded in the gripper sheet, forming the ‘x’ addressing, an extremely thin, hollow needle, coated with a thin film of lubricant when necessary, will be punched at high velocity into and through the continuous hole originally formed by the wires left in each gripper sheet in their fabrication. A conductive filament has been inserted in the extremely thin needle and carried with it. The needle is removed from the hole, while the filament is held externally from the needle and remains with the needle retracted up its length and clear of the Gripper ‘block’. The filament is cut below the needle with slight pressure on the Gripper material, such that the resilient Gripper material rebounds making the cut exactly even with the surface of the Gripper at that point. The procedure is repeated alongside the next channel; in addition, multiple such needles may be employed in a single punch and fill mechanism, inserting filaments simultaneously in multiple channels. These conductive filaments form the ‘y’ addressing in this optional method.

The final switching matrix structure is completed with the laying and alignment of a sufficient number of square tiles to form the required display size. A laser sensor array positioned beneath a transparent laying-up pan may be employed to ensure precision alignment of the tiles, but the alternating micro-ridges/grooves or tabs/indentations originally formed on the sides of each original, pre-stacked, pre-sliced sheets now form a plurality of ridges/grooves or tabs/indentations on two opposite sides of each tile, allowing for self-micro-alignment of tiles on one axis. Additionally, the other two sides of each tile were also fabricated with self-locking elements, tabs/indentations, enabling self-locking/snapping together of the tiles on that axis.

The micro-alignment structures ensure continuous good contact between the embedded ‘x’ and ‘y’ addressing filaments, if optionally implemented. When embedded ‘x’ and ‘y’ addressing filaments have not been implemented as part of the Gripper-based structure, then a mesh or thin-film layer imprinted or having been deposited with a switching matrix may be implemented on the bottom (for the ‘x’ addressing’) and top (for the ‘y’ addressing), or a combination of ‘x’ and ‘y’ addressing on one layer (as in preferred embodiment #2, disclosed elsewhere herein). When on one layer, precision alignment of the thin film to the appropriate contact points on an integrated Faraday attenuator optical fiber element must be performed, also as disclosed in preferred embodiment #2. Transistors may also be printed, as specified elsewhere herein, on a selected layer along with addressing lines in order to implement active matrix switching.

Fiber Unitary Flat Panel, Switching Matrix with Solid Layer Filled Mechanically With Fiber Faraday Attenuator Segments—In this category of embodiments, a solid material, rigid or flexible, is implemented as the structural support for the optical fiber Faraday attenuator elements, and addressing may be made a part of the structure or a thinfilm or layer may be printed on the input and output faces, or both x and y addressing on one layer as specified in the previous embodiment. Transistors may also be printed a given layer to implement active-matrix switching.

In the case of a Flexible Solid Sheet with Holes, two alternatives of filling the holes with the Faraday attenuator optical fiber elements are practical. In one method, an array of hollow needles, filling multiple rows or squares of holes in batches but filling only alternating or every three holes each time, depending on the practical density tolerances of fitting a punch structure with multiple needs, is employed. That is, since the needle structure size is certainly larger than a hole, and since the needles must be filled with either fiber that is cut after punching or filled with pre-cut fiber segments, the space between needle structures and a superstructure filling the needles requires filling alternate holes. A batch of every other or every third etc. holes are filled, by punching and pressure insertion of fiber from spools through the needle, or air-pressure insertion of a pre-cut fiber segment through the needle. After a batch of skipped holes are filled, the computer controlled apparatus moves to the next array of holes. Once the display has been covered in this way in one pass, filling every other, every third, or every fourth hole, etc. the filling apparatus resets and starts with the row immediately next to the first row filled. And the process of batch filling and resetting is repeated, for as many times as holes are skipped in a batch filling.

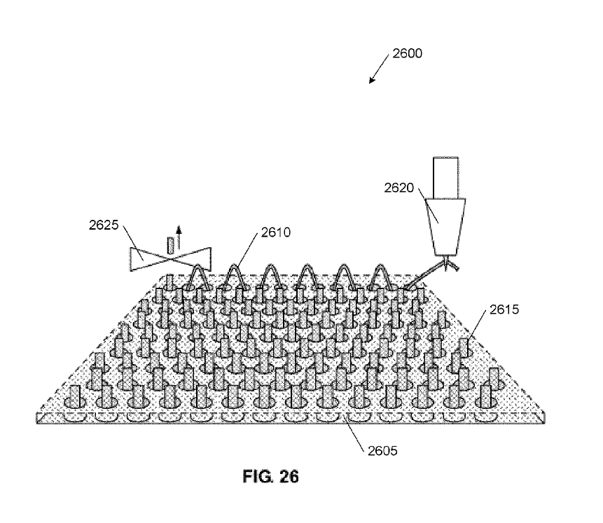

FIG. 26 is a schematic diagram of a first alternate preferred embodiment for a modular switching matrix 2600 used in the display shown in FIG. 5 and FIG. 6. Matrix 2600 includes a solid layer 2605 filled mechanically with a flexible waveguide channel 2610 having periodic sub-units each defining a modulator element 2615. One or more mechanical needles 2620 appropriately ‘sew’ a desired pattern onto layer 2605 and a shearing system 2625 (e.g., a precision mechanical optical fiber cleaver) subdivides the waveguide channel into the modular elements. An X/Y addressing matrix may be disposed within or on layer 2605 to couple to and control the individual modulators.

In a second method, a sewing apparatus is employed, in which a needle inserts a continuous thread of the batch-fabricated optical fiber. Here again, holes may be skipped and a display switching matrix sewn in multiple passes. But after each pass, a cutting mechanism is deployed as a bar and sharpened guillotine blade so that the continuously sewn fiber, passing under and over the solid sheet, is cut, leaving the optical fiber segments separated and vertically aligned with respect to the solid sheet. The flexible material of the solid sheet in this embodiment expands when the needle in either subtype is inserted, and rebounds to hold the fiber in place when the needle is removed. In the case of a Rigid Solid Sheet with Holes, a mechanical agitation process of filling holes with pre-cut Faraday attenuator optical fiber segments is employed.

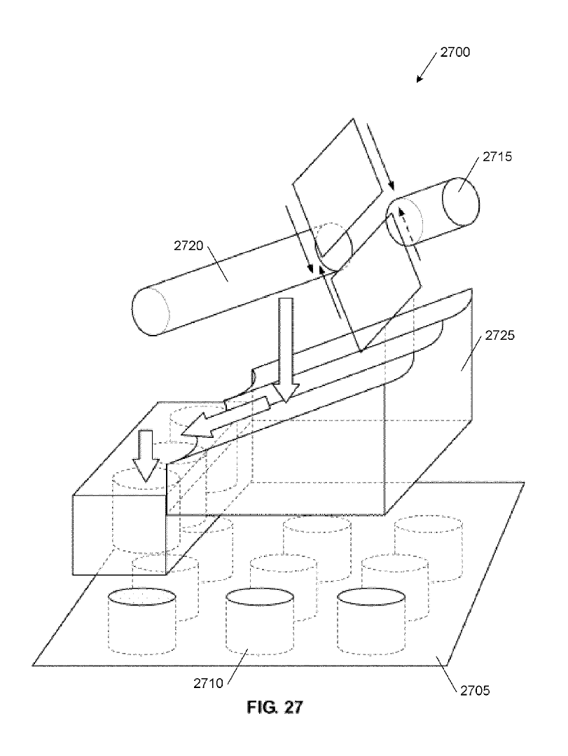

FIG. 27 is a schematic diagram of a second alternate preferred embodiment for a modular switching matrix 2700 used in the display shown in FIG. 5 and FIG. 6. Matrix 2700 includes a layer 2705 having preformed apertures/holes 2710 for receiving modulator segments. One or more extended waveguide channel resources 2715 each including periodic modulator structures is processed (e.g., by a precision cleaving system) to produce a plurality of modulator segments 2720. These segments 2720 are deposited into an alignment/inserting system 2725 that guides appropriate segments 2720 into desired locations and inserts them into appropriate apertures 2710 as further described below. Layer 2705 may include the X/Y addressing matrix as described herein.

In this method, color-subpixel rows are filled simultaneously, or if not by entire rows at the same time, in portions of a display row that are large batches processes optimally scaled. Multiple rows, alternating R, G, B, may be filled at the same time by the same process, outlined as follows:

Optical fiber fabricated according to the previously disclosed options or variants thereof is fed from multiple spools down into grooved trays set at an angle to thin feeder troughs, also grooved vertically. A cleaving device cuts the fiber in appropriate component segments, and the segments slide down the grooves and into the vertical grooves of the feeder trough. The spool array then shifts to the side to complete the filling of the adjacent set of grooves, until either the feeder trough is filled equal to the number of subpixels in a row, or until the optimal batch process-sized feeder trough is filled.

At the base of the feeder trough is a removable slot that exposes holes in the bottom of the trough. Multiple troughs may be part of one feeder trough batch process CCM device, and filled by the previous process. The filled feeder trough or series of troughs, with multiple optical fiber component segments in vertical slots, is positioned above the rigid sheet. Beneath the solid sheet are two arrays of extremely thin, movable positioning guide-wires or filaments, two layers of two ‘x’ and two ‘y’ wires per subpixel hole. They are held apart by spring-tension. They are positioned in such a way as to bracket a segment that may fall into the hole above. The hole is fabricated to be of a larger diameter than the optical fiber component segments, and indeed of a large enough diameter to facilitate the easy passage of a optical fiber segment into the hole. The loom-type device holding the guide-wires is set at the same diameter as the hole in the rigid sheet, but the wires are movable. The wires or filaments are in tension and coated with a resin to provide a secure grip on a fiber segment that may be held by mechanical side tension of squeezing guide-wires. Beneath the guide-wires is another solid sheet, transparent with a movable laser sensor array deployed beneath.

After positioning just above but almost touching the row or rows or portions of row or rows to be filled, the slot or flap is moved and the holes exposed, while at the same time the trough begins to agitate slightly side-to-side or with a slight circular motion. The fiber component segments thus agitated will drop from the slots in the feeder troughs and fill the holes beneath. Once the sensor array confirms the insertion of all fiber component segments into the holes to be filled by the batch process, the guide wires are released, and spring tension brings them into contact with the fiber, straightening the fibers and by virtue of being held just beneath the hole in the rigid material by an upper and lower guide wire, each coated in resin, positioning them at the center of the larger diameter holes in the rigid sheet.

Next the entire apparatus, holding the rigid perforated sheet, guide-wire system, and bottom transparent sheet, is rotated 180 degrees. Once the entire apparatus has been thus rotated, and the fiber components now suspended by the spring-tension guide-wires, a liquid polymer material is injected down onto the perforated solid sheet and flowed across the sheet to fill the gaps between optical fiber component segments and the sides of the perforations. This liquid polymer is then UV cured, fixing the position of the fibers at the center of the perforations. The guide-wires can now be disengaged.

The rigid sheet may have been previously imprinted with an addressing grid, passive or active matrix (without or with transistors adjacent to each perforation, preferably on the side opposite that on which the liquid polymer had been injected and flowed). Or, addressing circuitry may be printed or deposited by methods referenced or disclosed elsewhere herein.

Fiber Unitary Flat Panel, Switching Matrix with Mesh Structure Filled Mechanically with Fiber Faraday Attenuator Segments—In this embodiment, the assembly process is as disclosed under ‘Flexible Solid Sheet’ embodiment above. However, in the employment of a flexible mesh, the pre-woven mesh may also include addressing strips or filaments, that may additionally ‘band’ the optical fiber components and thereby form a multi-band field-generation structure or quasi-coilform.

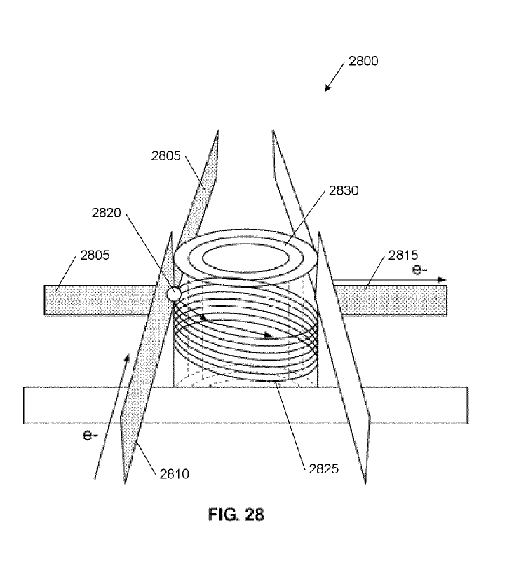

FIG. 28 is a schematic diagram of a third preferred embodiment for a modular switching matrix 2800 used in the display shown in FIG. 5 and FIG. 6. Matrix 2800 includes a mesh structure that is filled with individual waveguided modulator segments. Switching matrix 2800 includes a plurality of metalized bands 2805 forming the mesh structure. An ‘X’ band or filament of mesh 2810 and a ‘Y’ band or filament of mesh 2815 produce the X/Y addressing matrix. An input contact point 2820 provides input for the influencer mechanism (e.g., a coilform for example) of the transport component disposed within the spaces in the mesh structure.

The interstices between mesh bands, strips or filaments, which may be formed in multiple woven layers, are filled in the same method as in a Flexible Solid Sheet. Certain filaments or bands are formed of conductive polymer or are of a flexible synthetic material that has been metalized or coated with a conductive material. Bands of material are convenient in that once side may be coated distinctly from the other side. These filaments or bands may only be paired as a one pair of ‘x’ and ‘y’ addressing wires only, and the coilform in this case is fabricated according to one of the methods disclosed elsewhere herein, or variants thereof.

But optionally, addressing transistors at the ‘x’ and ‘y’ axis may switch current to parallel filaments or bands in a multi-layer mesh, as illustrated. The interleaving multiple ‘x’ and ‘y’ bands or filaments contact the fibers in roughly horizontal bands, implementing a plurality of current segments at right angles to the axis of the fiber. When the fiber is optionally fabricated with a square cladding, at least at this switching matrix stage (employing two dies or an adjustable die in the pulling process, as disclosed elsewhere herein), then the bands or strips making virtually continuous contact with the doped cladding.

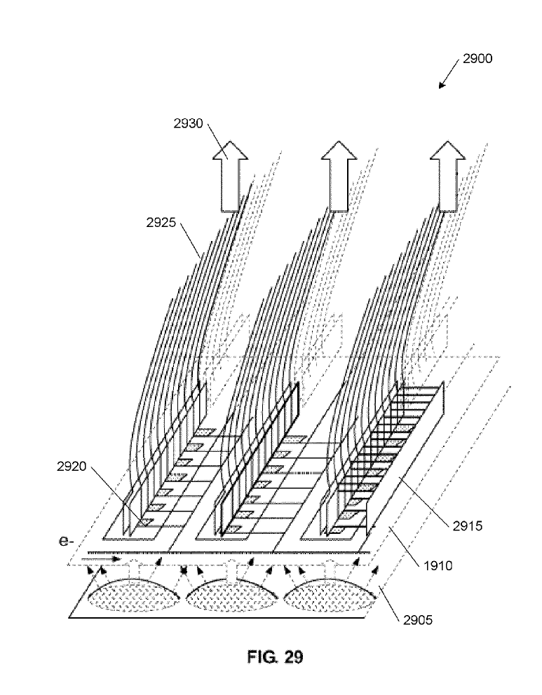

Variant of Preferred Embodiment: ‘Component’ Optical Fiber-based Display with Display Module Separate from Switching Module but linked by optical fiber bundles, with Switching Module Incorporating Fiber-bundles combined with Transistor Addressing Modules in Circuit-board Type Apparatus—FIG. 29 is a schematic diagram of a preferred embodiment for an implementation of the componentized display system shown in FIG. 7 and FIG. 8. A componentized system 2900 includes an illumination module 2905 with a polarization system 2910 coupled to a modulating system 2915 including an incorporated switching transistor 2920. Modulating system 2915 provides imaging information to a second communicating system 2925 coupled in turn to a display/projector surface 2930. Illumination source 2905 is provided in a base unit and produces wave_components that pass through a transparent substrate to polarization system 2910 for producing desired characteristics for the input wave components. As further explained below, second communicating system 2925 includes rows of sheets of optical elements formed by fusing arrays of flexible optical channels.

In this variation on one or more of the preferred embodiment above, optical fibers are maintained in their relative position at the display or projection surface in the same way as disclosed in one optional method of that preferred embodiment, but instead of combining all the fibers in a bundle, separate rows (thousands at a time) of fibers are kept together, having been previously marked for identification by striping before or after looming in a computer bar-coding process.

Instead of continually being woven together, but with less and less space between the fibers, individual bundles or bound rows of fibers are held together and fixed in relative position initially with the previously disclosed method of periodic weaving on the loom. Whatever spacing filaments required at the display face are tied off in the looming, and then the separated sheets of fibers are bonded by sheet (thousands of fibers together at a time) with a flexible polymer resin, and then the bonded sheets are rolled together lengthwise, tied, and inserted into a cable sheathing. At their extremity—just above the input ends of the fibers—another polymer resin is applied again, but in this case it is hardened by UV curing, resulting in a rigid, ruggedized structure.

The computer bar-coded (hundreds of such) rolled sheets of fibers, conveyed in the cable sheathing to the switching matrix, are then separated from each other inside that matrix. The input ends of such sheets of fibers are then inserted by CCM into grooved slot, fitted with fixing compression clamps. The input ends of each sheet of fibers facing optical glass or sheet of fused fiber; a polarized thin-film is applied epitaxially or by LPE on that glass or sheet of fused fiber. A laser-scanner reads the bar-coding printed on the sheets of fibers, ensuring that each sheet of fibers is inserted in the appropriate slot. The ruggedized polymer coated portion of the fiber sheets is secured by the compression clamps.

The Faraday attenuator structures fabricated near the input ends of the fibers, fabricated by one of the methods disclosed elsewhere herein or variants thereof that results in an exposed, for good contact, ‘bottom’ of a coilform and an exposed, for good contact, ‘top’ of the coilform, are contacted by an addressing circuit printed on the lower portion of a flange connected to the compression clamp. The addressing circuit, disposed parallel to the axis of the fiber sheet, may take the following form:

A bottom horizontal conductive strip and an individual transistor for each fiber, combined with a top conductive strip, (the top may alternatively incorporate the transistors instead of the bottom), both strips are connected to the drive circuit of the switching matrix by metal contacts that engage after the clamp is employed. The fabrication method of this printed-circuit clamp structure may be any of the established printed circuit-board or semiconductor methods. The resulting switching matrix is a relatively simple and rugged embodiment, although less compact and employing more discrete mechanical assembly processes.

Variant of Preferred Embodiment Number 1: Coilform implemented through textile banding, logic drives bands in parallel from display sides (X addressing combined with field generation)—This embodiment employs a similar method of implementing the coilform through the switching matrix structural elements as that disclosed for the ‘Flexible Mesh Structure’ embodiment. This case has the additional advantage, however, in that the weaving process effectively wraps the plurality of conductive elements snugly around the Faraday attenuator optical fiber components, ensuring close contact around a circular cladding fiber.

This method of course may be combined with one or more of the methods disclosed elsewhere herein for fabricating a coilform or coil integrally around a suitably fabricated optical fiber.

The optical-fiber embodiments of the present invention, as well as hybrid optical fiber-silicon wafer embodiments, possess the potential for new cost economies, new applications for what we call a video ‘display’ or projector, and improvements in the overall quality of the displayed image compared to any other display type. Some of the features of which are a result of a radically different manufacturing and fabrication paradigm, optical fiber-textile, as compared to the semiconductor-manufacturing derived processes characteristic of LCD, gas-plasma, and other established and nascent technologies.

However, the implementation of precision control over the path of and the characteristics of light different magneto-optic display, through the process of waveguiding in general and Faraday attenuator devices fabricated integrally to the waveguiding structures, provides waveguiding-based magneto-optic displays with advantages in all their embodiments and modes of manufacture as described herein, regardless of whether the manufacturing paradigm is semiconductor wafer or non-semiconductor wafer.

Within the semiconductor wafer fabrication paradigm, the semiconductor waveguide-based magneto-optic displays are particularly suited to miniature displays, including an ‘HDTV display on a chip,’ as well as projector embodiments and specialized embodiments that might be described as micro-thin display ‘appliqué.’ As solid-state semiconductor structures involving no liquids or pressure-sealed components in vacuo in their manufacture, semiconductor waveguide embodiments of the present invention may be both significantly cheaper and better-performing than LCD or gas plasma displays.

Of course, the choice of semiconductor waveguiding based FPDs for non-miniature displays may be, in virtually every case, significantly inferior to the choice of an optical-fiber based magneto-optic based FPD, due to the well-known cost limitations of semiconductor wafer manufacturing of, especially, very large displays.

But the significant advantages of semiconductor waveguide-based embodiments of the present invention for certain applications, including miniature display and projector applications, are implemented in the following disclosed specifications:

Reference is first made to conventional examples—including U.S. Pat. No. 5,598,492 and U.S. Pat. No. 6,103,010. Both examples are, as is typical of prior art in this area, planar semiconductor optical waveguide Faraday rotators. Examples such as these demonstrate feasibility of 90 degrees rotation in very short (microns) distances using the embodiments disclosed herein.

There are two basic variants of the semiconductor optical waveguide embodiment of the present invention: 1) an array of ‘vertically-formed’ semiconductor waveguides and Faraday attenuator structures fabricated on a transparent fused-fiber substrate, switched by either a passive or active matrix; and 2) a planar semiconductor waveguide incorporating the Faraday attenuator structure as an integrated planar component with the waveguide structure, combined with a ‘deflection mechanism,’ (examples shown are a 45 degrees reflective surface or photonic crystal defect producing a 90 degree bend), which deflect incident planar light into the vertical, forming a subpixel. The two examples disclosed do not however exhaust the range of possibilities engendered by the semiconductor waveguide embodiment of the present invention, nor is the invention in this embodiment or variants thereof limited by the examples given.

An alternative hybrid of the ‘vertical’ and planar versions is accomplished by fabricating laminated strips of planar waveguides in parallel arrays of up to thousand dye-doped Faraday attenuator waveguide channels each, each strip with R, G, or B dye-doped or color filtered channels, laminated together top-bottom so as to form a sheet of laminated strips with waveguide cores in a ‘vertical’ display structure. The laminated strips of such planar Faraday attenuator waveguide channels, without deflection, thus form a display array through their output ends, the display surface formed by viewing waveguide structures on-end, directed ‘outwards’; the thin-substrate and surrounding matrix are all that separate individual Faraday attenuator waveguide channels.

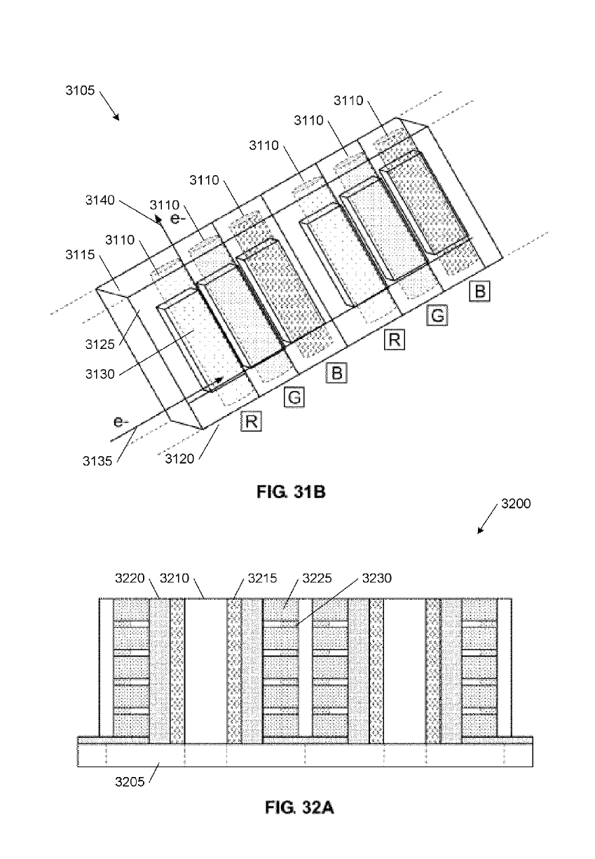

FIG. 31 (consisting of FIG. 31a and 31b) is a general schematic diagram of a preferred embodiment for a vertical-element semiconductor waveguide modulator array 3100. FIG. 31A is an exploded view of array 3100 illustrating an arrangement of modulator strips. Display system 3100 includes a plurality of wafer strips 3105, stacked vertically to produce a collective display surface 3110 from a matrix of pixels/subpixels produced from an edge of each strip 3105. Each pixel/subpixel is produced from a plurality of structured and ordered modulators coupled to transport channel segments, the transports and modulators integrated into each strip 3105, each transport and modulator having the functionality and arrangement possibilities as described herein and in the incorporated patent applications. Display system 3100 is a type of hybrid in that each strip 3105 is formed from a wafer having embedded waveguide channels parallel to the wafer surface, with these strips stacked vertically to produce the display system.

FIG. 31B is a detailed schematic diagram of a portion of one strip 3105 shown in FIG. 31A. The close-up of FIG. 31B illustrates a plurality of transport segments 3110 (shown as cylindrical elements) running laterally from an input edge 3115 to an output edge 3120, with each segment 3110 parallel to a surface 3125. An influencer element 3130 (shown as a rectilinear element) is coupled to each segment 3110 to produce a modulator, each responsive to an X-Y addressing grid (a single element shown as X 3135 and Y 3140). The portion of strip 3105 shown in FIG. 31B includes two pixels, each having three subpixels producing radiation signals of a preferred color model (in this case: R, G, and B subchannels).

Of utility to the efficient fabrication of semiconductor waveguide elements, both ‘vertical’ and planar, are the commercially available methods from Molecular Imprints corporation, referenced also elsewhere herein, a ‘step and flash’ micro-mold imprint method, and commercially available methods from NanoOpto corporation, likewise referenced also elsewhere herein, implementing nano-scale self-assembly fabrication methods. Both of these and similar commercially available ‘nano-technology’ fabrication methods are of preference for the semiconductor embodiments of the present invention.

Note that in terms of fabrication processes, reference is also made to U.S. Pat. No. 6,650,819 by Petrov, disclosing a multi-stage annealed proton exchange (APE) fabrication methodology that allows for optimization of different semiconductor waveguide components, differently composed, on a single substrate. This disclosure is indicative and enabling of the fabrication of the vertical and planar waveguide structures disclosed below, and unless otherwise indicated, the preferred method of fabrication in the masking/etching process is a commercial multi-stage annealed proton exchange process:

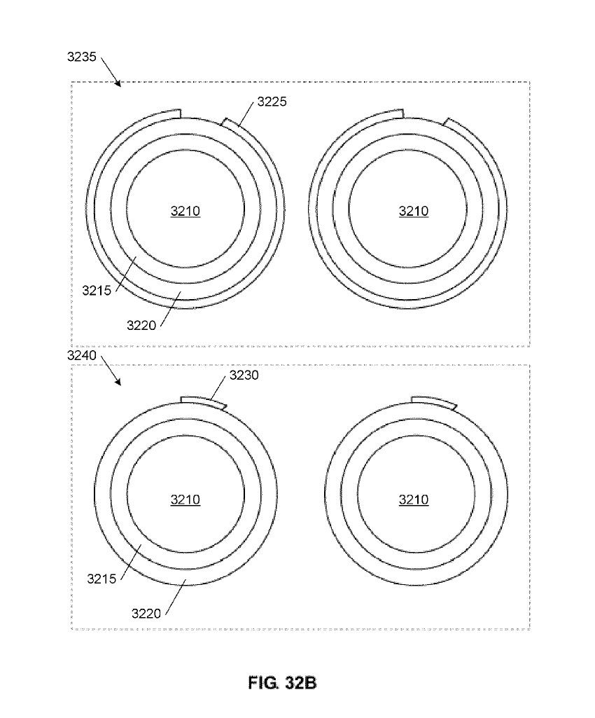

FIG. 32 (consisting of FIG. 32A and FIG. 32B) is vertical semiconductor waveguide influencer structure display system 3200. FIG. 32A is an alternate preferred embodiment for display system 3200 implementing a semiconductor waveguide display/projector as a vertical solution using vertical waveguide channels in the semiconductor structure. Display system 3200 includes a fused fiber transparent substrate 3205 upon which is disposed a plurality of vertical waveguide channels 3210. Each channel 3210, when implemented similar to conventional optical fibers, includes one or more bounding regions—specifically an optional first bounding region 3215 and a second bounding region 3220. Bounding region 3215 is, in the differential guiding example, a material having a differential refraction index and doped with permanent magnetic materials. Second bounding region 3220 is, in the differential index guiding example, a material having a differential refraction index and is doped with ferri/ferro-magnetic dopants. An assembled influencer element 3225 (e.g., a coilform or other appropriate magnetic field generating structure) is produced from coilform layers interconnected by a layer coupler 3230. An X-Y addressing grid 3235 is disposed for independent connection/control of each influencer element 3225. Additional details for the structure, function, and operation of the waveguide channel, the bounding regions, the coilform, and X/Y grid are as described above and in the incorporated patent applications.

FIG. 32B is an illustration showing the two-layers (a first layer 3235 and a second layer 3240) that successively alternatingly constitute the ‘coilform’ pattern: a partial circle, defining a cylinder wall, on the first layer, the terminus connecting vertically in the same conductive material to a very thin second layer deposited above.

Fabrication of the structure by standard semiconductor deposition, masking, and etching is as follows:

On a transparent fused-fiber substrate is deposited a doped-silica material. A first deposition of transparent material is made, doped with dye, one color of the RGB primaries, and with optically-active dopant as disclosed elsewhere herein for the optical fiber embodiments of the present invention; and a mask is then made such that rows of circular pillars remain; for every row left remaining, there are two rows between that are etched down to the substrate. Each pillar of doped material is positioned exactly above an optical fiber in the fused-fiber faceplate, such fibers themselves also dye-doped and with a core of the same dimensions as the silica pillars. The process of forming rows of pillars is repeated, so that sets of RGB rows are formed by sequence of deposition and etching.

Next, another set of depositions and etchings is performed to fabricate a cylinder of doped material surrounding each pillar that possesses an index of refraction differentiated from that of the original pillar, such that a waveguiding structure is thereby fabricated to confine light passing from the fused-fiber substrate into the transparent pillar. This ‘cladding’ may also be doped with a permanently magnetizable ferromagnetic material, single molecule magnets preferably, which after formation are exposed to a strong magnetic field set at right-angles to the axis of the light-channels. If not, it is doped with a ferri/ferromagnetic material that, as is previously disclosed in the fiber optic embodiments, will possess a remanent flux upon magnetization by a surrounding coilform.

In the event that the ‘cladding’ structure is doped with permanently magnetizable material, then a second ‘cladding’ cylinder is fabricated according to the description provided for the first ‘cladding’ cylinder, and this ‘cladding’ is doped as described previously with ferri/ferromagnetic material.

Next, a series of alternating depositions and etchings is performed to fabricate the ‘coilform’ surrounding the doped waveguide structure. Reference is made to FIG. 32B, showing the two-layers that constitute the ‘coilform’ pattern: a partial circle, defining a cylinder wall, on the first layer, the terminus connecting vertically in the same conductive material to a very thin second layer deposited above. On that second layer, only a very minimal segment of a circle (a tiny arc of a cylinder wall) of the conductive material is masked and remains after etching, and then an insulating very thin layer is deposited around it.

The process is repeated, depositing a partial circle on the next layer, virtually identical to the circle or ‘slice of a cylinder’ on the bottom-most layer. This new partial circle or ‘cylinder-wall slice’ is vertically connected to the layer below through the common conductive material of the tiny arc of the cylinder wall on that otherwise insulating layer. And by repetition of this process, alternating layers, one layer with an almost complete conductive ring around the waveguide-pillar, another layer above with only a tiny connecting segment of the same conductive material that maintains the current flow around the waveguide-pillar, up to the very thin tiny segment on the next layer, and up to the layer above that, again with an almost complete circle around the waveguide pillar.

As many ‘collar’ layers are fabricated, interspersed with thin insulating layers with only a ‘spot’ of conductive material to carry current between layers, as is needed to generate a field of sufficient strength to rotate the angle of polarization of light passing up through the fused-fiber substrate, at full power, a full 90 degrees. From established performance of current best-performing optically-active dopants, this may be achieved through only a small number of ‘windings’ or collar-layers only.

Next, a conductive grid is formed by standard methods, including newer methods such as dip-pen nanolithography, on the substrate to address the ‘base’ of each of the Faraday attenuator waveguide structures, contacting at the bottom-most circle at the input point of the partial circle.

Next, a black matrix is deposited in the thin gaps between the semiconductor-fabricated Faraday attenuator structures. If photonic crystal materials are employed, the difference is that the bandgap structure channels the light, and a differential-index of refraction ‘cladding’ is not necessary to confine light (but only as a doped cylinder of ferri/ferromagnetic material around the light channel, and, optionally, a first doped cylinder of permanently magnetizable material).

Finally, an ‘upper’ addressing grid, including, when required or useful by materials performance, is deposited on the black matrix between the waveguide structures.

When necessary, the black matrix is deposited only so high relative to the top of the vertical waveguide structure that a transistor addressed by the conductive addressing grid is formed as a vertically-aligned semiconductor component along side the waveguide structure, and fabricated advantageously between the alternating layers required for the coilform structure.

Next, additional black (opaque) matrix is deposited above the addressing grid and optional vertically-disposed transistors, so that the semiconductor wafer structure is flush.

Last, an optical scattering structure may be deposited directly at the ‘output’ point of the vertical waveguide structures, to improve the already superior angle of dispersion from the waveguide structure.

Semiconductor waveguides on continuous wafer parallel to surface of display; for each subpixel waveguide rotator element, there is a 45 degree mirror terminus or photonic crystal bend (demonstrated in 10 micron diameters) deflecting light from parallel to the display surface, to emerge outward from the surface, thus forming the subpixel

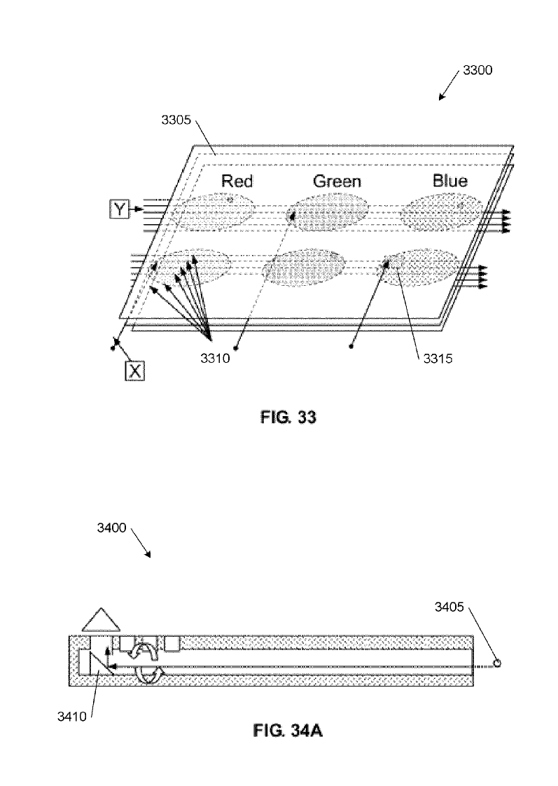

FIG. 33 is an alternate preferred embodiment for a display system 3300 implementing a semiconductor waveguide display/projector as a planar solution using planar waveguide channels in a semiconductor structure. System 3300 includes one or more illumination sources (not shown) at an edge of system 3300 that feed a large number of extremely narrow waveguide channels to supply uniform illumination to each subpixel. System 3300 includes a number of functional layers, including an input layer, a rotator layer, and a display layer. On bottom layers, each subpixel row (from X & Y axes) feeds a large number of extremely narrow waveguide channels to supply the uniform illumination to each subpixel. Thus in the preferred embodiment, from a Y-axis, each row has (for 3000 width) 1500 waveguide channels, each channel terminates in a subpixel on that row. X & Y axis address alternate subpixels. From the X-axis, each row contains about 1350 channels, with the X and Y axis each on a separate layer. In the preferred embodiment, the waveguide channels are photonic crystal structured waveguides fabricated at 0.02 microns or less. Each waveguide terminates at a subpixel location (in some implementations, multiple channels may illuminate a single subpixel location) and may define complex pathways to position an output location at the desired location for the subpixel. A deflecting mechanism is provided at the output location to redirect a propagated and amplitude-controlled radiation signal out of the propagation plane into the display plane. As shown, the display plane is perpendicular to the propagation plane. Along each waveguide channel, one or more influencer/modulator portions/layers are provided to produce the desired amplitude control of the propagated radiation signal. It is preferable that the output of waveguide channel, since the waveguide channel is so much smaller than the subpixel diameter, include a dispersion or optical element to increase an effective size.

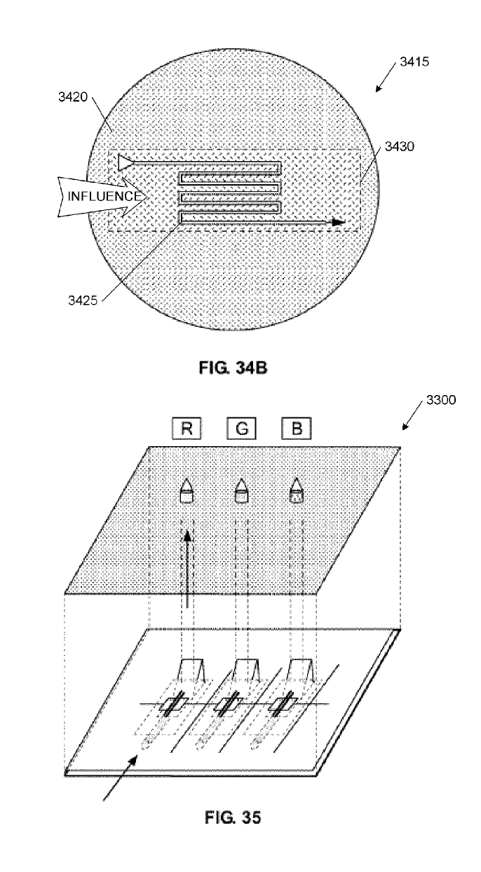

FIG. 35 is a schematic illustration of display system 3300 shown in FIG. 33 further illustrating three subpixel channels producing a single pixel. Each channel is independently controlled and deflected to be merged at the surface of system 3300.

FIG. 34A is a cross-section of a transport/influencer system 3400 integrated into the semiconductor structure for propagating a radiation signal 3405, combined with a deflecting mechanism 3410 that re-directs light ‘valved’ by the waveguide/influencer from the horizontal plane to the vertical. FIG. 34B illustrates a preferred embodiment for an optional implementation of a waveguide pathing structure in a system 3415. To compensate for the confined dimensions of a planar modulator scheme, in which rotation must be accomplished across the diameter of a pixel 3420, a novel ‘switchback’ strategy is employed for a waveguide 3425. Given that photonic crystal structures, by creation of defects (removal of periodic holes or other structures), achieves almost 90 degree bends in light-paths, a strategy for ‘folding’ a sub-micron-wide light-path in a series of switch-backs, increases increase the ‘d’ dimension in Eq. 1 in terms of the distance traveled by a light beam subjected to an influencing effect (e.g., a magnetic field) within an influencing zone 3430 without resulting in a device which is too long. In effect, a continuous deployment of rotator/attenuator elements along the switchbacks of the preferred embodiment, formed via standard semiconductor manufacturing processes, result in a device of very low power consumption by virtue of a much larger ‘d’ dimension than would be otherwise practical. Given that the dimensions of the channels are so small, the overall dimension of the rotator/attenuator device would be significantly smaller than prior art waveguide examples, and much smaller than the maximum dimensions of a subpixel. The dashed rectangle in FIG. 34B represents influencing zone 3430 containing the recursing waveguide 3425 wherein an influence is applied to the waveguide. In the case of a magnetic field, it is applied parallel to the long path lengths of the waveguide.

The preferred embodiments shown herein describe substrated waveguiding channels implementing the transport, modulation, and display structures, functions, and operation included in the incorporated patent applications. These embodiments emphasize a substitutability between waveguide channels formed/disposed/arranged in a substrate and independent/discrete waveguide channels such as optical fibers and photonic crystal fibers. One of those substitutions is use of the transverse switch shown in FIG. 36 and FIG. 37. While that preferred embodiment includes fiber-to-fiber switching, the principles of FIG. 36 may be applied to waveguide-to-waveguide switching, particularly between appropriately structured and arranged waveguides disposed in a common substrate. In some implementations, switching is between waveguides of different substrates arranged in appropriate relationships.

The utility of a planar semiconductor optical waveguide embodiment of a Faraday attenuator device, combined in a display array, is in fabricating an extremely thin superficial semiconductor-process display structure in which the illumination source is provided from the ‘sides’ in parallel to the planar optical waveguides. The illumination source so provided may be in an extremely compact form, such as parallel row of RGB semiconductor lasers, VCSEL or edge-emitting. Such that, in principle, the structure may be fabricated as thick-films, on a rigid or flexible substrate, including textile sealed with polymer. As a thick-film embodied display, the display may be applied as an ‘appliqué,’ in effect tiling curved geometric surfaces with thin display material.

The primary semiconductor-fabricated layer consists of a plurality of planer waveguides that channel light from side-illumination sources (versus illumination from an entire back cavity illumination source parallel to the display surface, as in flat panel display embodiments disclosed above). FIG. 38a is a vertical cross-section of the planar Faraday attenuator integrated into the waveguide structure, combined with a deflector that re-directs light ‘valved’ by the attenuator from the horizontal plane to the vertical.

A representative fabrication process may be detailed as follows:

A thick-film material is deposited on a substrate, such that the thick-film is robust enough in tensile strength to be self-substrative, and when removed from the working substrate, will retain its integrity. Through semiconductor lithographic processes (deposition or printing of material, masking and etching, etc., dip-pen nano-lithography), optically transparent but dye-doped material is deposited on the thickfilm substrate. This first deposition is also doped with optically-active material, such as YIG or Tb, or current best-performing dopant. All materials are preferably flexible, according to the same Young's modulus as the thick-film substrate.

Channels, as illustrated, are masked and the majority of the material deposited is removed, leaving the lines of material. Dip-pen nano-lithography is employed to stereo-print the 45 μl deflection element, out of the same or other material with an appropriate differential index of refraction to achieve reflection, (or QWI for fabricating photonic crystal bends). Alternatively, the ‘step and flash’ stereo-imprint method of Molecular Imprints may be employed. Other methods, relatively more complicated, are also known to the art.

Next, a column’ of the dye and optically-active doped material of the channel is deposited and etched to leave a column directly above the 45 degree deflection element, which in effect forms the exit point from the plane of the display surface, for the light switched by the Faraday attenuator device along the light channel adjacent and deflected by the 45 degree deflection element.

Next, a material is deposited with the same differential index of refraction, surrounding and covering the original lines and other fabricated elements. This is called the ‘cladding material.’ Above a segment of the waveguiding channel adjacent to the 45 degree deflection element or photonic crystal bend, space is etched from the previously deposited material for the following: allowing for conductive lines in parallel and above the light channels, to address the horizontal bands that will also be fabricated above the light channel and at right-angles to it axis; space for depositing the conductive material for the bands, as well as a layer of material beneath to be doped with ferri/ferro-magnetic material is also etched. Space below that material is optionally left for deposition of material doped with permanently magnetizable material, the function of which is detailed elsewhere herein.

In turn, the following material is deposited (with successive masking and etching and/or dip-pen nano-lithography: the conductive material in lines parallel to the light channels to address the field-generating bands; an optional layer of permanently magnetizable (and subsequently, magnetized) material above the ‘cladding’ material left above the light-channel; the ferri/ferro-magnetic material that will be temporarily magnetized by the field-generating elements and maintain rotation through remanent flux; and the bands of field generating conductive material disposed at right angles to the axis of the light channel. Only a few bands, based on current dopant performance, may be necessary.

Finally, more of the ‘cladding’ material is deposited such that the surface of the multi-thick-film, semi-conductor fabricated structure, is sealed and even. Optionally, a transistor may be fabricated in-line with the conductive addressing line, just prior to the addressing of the field-generating structure of the Faraday attenuator.

By appropriate choice of thick-film materials, the entire thick-film display structure may be formed on a robust polymer sealed textile substrate, or removed from a forming substrate and adhered by thick-film epitaxy to another (potentially geometrically complex) final supporting display surface.

Systems Operation, Performance and Testing—Some Relevant Background:

Increasing Verdet constant of new materials, rare-earth doped fibers and thin-film crystals continues to improve the performance, efficiencies, and operation of the disclosed embodiments.

Introduction of photonic crystal fibers. Crystal structure is doped and holes formed by heat-treatment of standard fiber, forming a photonic bandgap structure; effective doping and heat treating will yield solid-state surrounded holes containing very high Verdet constant alkaline gas, leached from surrounding doped crystal. Doped photonic thin-film stacks also used as rotator elements with close to 100% transmission, only 36 microns in length.

Introduction of QWI and other manufacturing technologies to realize reduced device dimensions, improved performance, and significant cost economies.

Overall miniaturization of Faraday rotator structures in semiconductor optical waveguides, application of same as elements for present invention, application of same techniques for miniaturization of fiber component version. Total dimensions of all elements, are 100 microns or less/side. Diameter of Faraday rotator device, including sufficient thickness and length of field-generating element around optically active material, can be 100 microns or less/side. Thus, dimensions are all significantly less than maximum dimensions for a subpixel in an approx. 1000/700 pixel 15′ display.

Techniques for achieving saturation of optically-active materials also contributes to improvements in the preferred embodiments.

Manufacturing economies of fiber pulling and doping continue to improve and further reduce costs and improve development.

Advances in AlGaAs/GaAs and InAlAs/InGaAs/InP families of materials and thin and thick film technologies improve aspects of the present invention.

The preferred embodiments offer improved waveguide-to-fiber connections, over conventional pigtail implementations.

The following discussion relates to expected system structure and performance metrics—Subpixel diameter, (including field generation elements adjacent to optically active material): <100 microns or better: <50 microns. (Note that in an alternative embodiment, referred to elsewhere herein, that multiple dye-doped light channels may be implemented in one composite waveguide structure, effecting a net reduction in RGB pixel dimensions).
Length of subpixel element: <100 microns or better: <50 microns
Drive current, to achieve 90 degree rotation, for a single sub-pixel: 0-50 m.Amps
Response time: Extremely high for Faraday rotators in general (i.e., 1 ns has been demonstrated).

Device Power Consumption Analysis and Systems Operation—In considering the power requirements of the preferred embodiments of the present invention, it is not necessary that the switching matrix be an ‘active matrix,’ requiring transistors at every sub-pixel, and that Faraday attenuator elements must be actively driven by continuous current throughout each video frame. (Each subpixel continuously supplied through the frame with current sufficient to ‘hold’ the angle rotation constant, as required for that frame).

‘Progressive Scan’ vs. ‘Continuously Addressed’ Displays

‘Continuously Addressed’ Display—While any assumption that any display based on Faraday attenuators must employ an ‘active matrix,’ is mistaken, that isn't to say that a ‘continuously addressed,’ low-power FLAT display device is not possible.

A ‘continuously addressed’ matrix for FLAT may be a practical configuration now, and increasingly so as the amperage and individual attenuator power requirements decrease. Once relevant variables favorable to FLAT are considered in detail, the essential practicalities of this form have advantages, even if a ‘progressive scan’ version is now, by many criteria, the superior of the two.

In regards to implementing an active matrix, with transistors at each sub-pixel, the fabrication problems and impact on subpixel area are not that of LCD's. In an LCD active-matrix, a transistor occludes a flat portion of each color subpixel area, reducing the efficiency of the display surface and the quality of displayed image. In a FLAT display employing an active matrix, the Transistor elements could be configured perpendicular to the display surface, and thus arranged ‘in depth’ as an additional element of the strip or wire structures in a fiber embodiment, or as elements fabricated in the waveguide composite structure.

As a base understanding of overall display power requirements, it is important to note that actual power requirements are not be calculated based on linear multiplication of the total number of subpixels times the maximum current required for 90 degree rotation. Actual average and peak power requirements must be calculated taking into account the following factors:

Gamma and Average Color Subpixel Usage Both Significantly Below 100%: Thus Average Rotation Significantly Less than 90 degrees:

Gamma: Even a computer-monitor displaying a white background, utilizing all subpixels, does not require maximum gamma for every subpixel, or for that matter, any subpixel. Space does not allow for a detailed review of the science of visual human perception. However, it is the relative intensity across the display, pixels and subpixels, (given a required base display luminance for viewing in varying ambient light levels), that is essential for proper image display.

Maximum gamma (or close to it), and full rotation (across whatever operating range, 90 degree or some fraction thereof—see below), would be required only in cases requiring the most extreme contrast, e.g., a direct shot into a bright light source, such as when shooting directly into the sun.

Thus, the average gamma for the display will statistically be at some fraction of the maximum gamma possible. That is why, for comfortable viewing of a steady ‘white’ background of a computer monitor, Faraday rotation will not be at a maximum, either. In sum, any given Faraday attenuator driving any given subpixel will rarely need to be at full rotation, thus rarely demanding full power.

Color: Since only pure white requires an equally intense combination of RGB subpixels in a cluster, it should be noted that for either color or gray-scale images, it is some fraction of the display's subpixels that will be addressed at any one time. Colors formed additively by RGB combination implies the following: some color pixels will require only one (either R, G, or B) subpixel (at varying intensity) to be ‘on’, some pixels will require two subpixels (at varying intensities) to be ‘on’, and some pixels will require three subpixels, (at varying intensities) to be ‘on’. Pure white pixels will require all three subpixels to be ‘on,’ with their Faraday attenuators rotated to achieve equal intensity. (Color and white pixels may be juxtaposed to desaturate color; in one alternative embodiment of the present invention, an additional subpixel in a ‘cluster’ may be balanced white-light, to achieve more efficient control over saturation).

In consideration of color and gray-scale imaging demands on subpixel clusters, it is apparent that, for the average frame, there will be some fraction of all display subpixels that actually need to be addressed, and for those that are ‘on’ to some degree, the average intensity will be significantly less than maximum. This is simply due to the function of the subpixels in the RGB additive color scheme, and is a factor in addition to the consideration of absolute gamma.

Conclusion: Statistical analysis is able to determine the power demand profile of a FLAT active-matrix/continuously-addressed device due to these considerations. It is, in any event, significantly less than an imaginary maximum of each subpixel of the display simultaneously at full Faraday rotation. By no means are all subpixels ‘on’ for any given frame, and intensities for those ‘on’ are, for various reasons, typically at some relatively small fraction of maximum.

0-50 m.amps for 0-90 degree Rotation a Minimum Spec—It is also important to note that an example current range for 0-90 degree rotation has been given (0-50 m.amps) from performance specs of existing Faraday attenuator devices, but this performance spec is provided as a minimum, already clearly being superceded and surpassed by the state-of-the-art of reference devices for optical communications.

It most importantly does not reflect the novel embodiments specified in the present invention, including the benefits from improved methods and materials technology. Performance improvements have been ongoing since the achievement of the specs cited, and if anything have been and will continue to be accelerating. (See the detailed review of using gas vapor as a rotating medium below).

Additional Strategies and Factors to Reduce Power Requirements of a Continuously-addressed FLAT display include:
a) Use Partial Range of Rotation, with Precision Fractional Angles, vs. full 90═ Rotation Range.
b) Use the Superior Verdet Constant of Vapor Gases, Contained in micro-bubbles with in solid-state elements vs. Transparent Solids. (linear Macaluso-Corbino effect).

The next discussion focuses here on two strategies that positively impact power consumption of the present invention, particularly in consideration of an active-matrix embodiment. As stated above, these are by no means the only novel and improved methods and materials specified by the present invention which will increase device efficiency.

a) Partial Range Rotation:—While the in-principle focus of many of the preferred embodiments has been on complete rotation of polarized light by a Faraday attenuator through a full 90 degrees, the fundamental requirement for the present invention is that the intensity of the light is attenuated through a sufficient number of increments to achieve a satisfactory intensity gradient (and satisfy video broadcast standards). For example, in a typical CRT display, each electron gun has a total of 256 (calibrated) voltage settings, to excite the corresponding color phosphors through the same range. (N.B., however, that human visual perception studies indicate that the human eye can only detect differences in a smaller range, when combined with detection of other factors).

Considering the degree of precision and reproducibility of Faraday rotators in general, a strategy to achieve variable intensity of light through a given range while reducing the current required by the Faraday attenuator would be, for example, to specify an operating range of rotation from 0-45 degrees, with a sufficient number of angular increments within that range to satisfy video imaging requirements.

To equal the maximum subpixel intensity of a 0-90 degree setup, the source illumination of the 0-45 degree system might be up to two times the intensity of the source illumination of the default setup. However, since light from a source illuminator is ‘distributed’ across all the channels of the display uniformly, and may be expected to at any time be in excess of the maximum display luminance (given any lossiness from decomposition into linear polarizations and attenuation itself), source illumination may not need to increase in power to the same degree that the operating range of rotation is reduced from 90 degrees.

Conclusion: By reducing the range of rotation, and increasing the precision of rotation (smaller angular increments), the power requirement per attenuator at maximum is correspondingly reduced.

b) Using Vapor Gases In Micro-bubble Fiber (or channeled material)—This strategy would be optimally implemented in conjunction with the employment of photonic crystal material (fiber, waveguide, channeled material, and the like.)

Reference is made in the main text and later detail sections of the performance improvements to be expected from the use of gas vapor as a rotation medium. Significant advances have been recently published in research by Budker (Lawrence Berkeley National Laboratory) et al (Jun. 4, 2002).

Investigating a variant of Faraday rotation in gas vapor (a resonant magneto-optic effect, or ‘linear Macaluso-Corbino effect’), the researchers demonstrated an orders-of-magnitude higher Verdet constant in the vapor, as opposed to solid flint glass reference:

Verdet constant, flint glass: 3×10\hat{ }−5 Vs. Verdet constant, Resonant rubidium vapor: 10\hat{ }4.

Budker et. al. conclude that the effective improvement in Verdet constant (‘per atom’), between the use of transparent, optically-active solids, and a gas vapor, (taking into account the difference in density), is on the order of 10\hat{ }20. Implementation of gas vapor in hollow, partial vacuum fiber (standard or photonic crystal), or sealed channels in photonic crystal would then be expected to reduce the required.

Considering again the formula for Faraday rotation set forth above as Eq. 1—Then an increase in effective Verdet constant from 3×10\hat{ }−5 to 10\hat{ }4 means a reduction in the required length ‘d’ and/or the required field or flux intensity, by a combined factor of, conservatively, 10\hat{ }−8. Conclusion: Implementation of gas vapor as the rotating medium thus can reduce, for instance, the input current range to rotate 0-90 degrees, from 0-50 milliamps to 0-5 microamps, (10\hat{ }−6 amps) and required length of rotator element from mm's or tens of microns, to fractions of microns.

2) ‘Progressive Scan’ Display—The factors considered above also apply to this preferred embodiment of the present invention, a passive-matrix/‘progressive scan’ display. Strategies that reduce power requirements, including reducing the operating range of rotation and employing gas vapor as a rotating medium, are equally applicable to the preferred embodiment.

Hysteresis, Remanent Flux, and Progressive Scan—It has been pointed out elsewhere that the phenomenon of remanent (or remnant) flux is a characteristic that acts to reduce power requirements, and in fact ‘sustains’ the rotation after the field generating material reaches saturation and the magnitude of rotation is achieved.

In fact, consideration of the ‘decay’ portion of an hysteresis curve shows that, once the medium reaches saturation, and power to the field generating element is cut, the magnitude of rotation will track with the slope of the curve, diminishing in strength slowly and then more quickly, finally stopping at the a degree of permanent magnetization called the ‘remanent flux.’

It is important to note, with respect to the present invention, that to eliminate the ‘remanent flux’, current to the field generating element must be reversed and the field-generating element effectively de-magnetized. The field strength required to do so for a given element is called the ‘coercivity.’

Thus, once the rotating element is turned ‘on,’ it must be completely turned ‘off.’ A pulse must be initially delivered to the element to achieve the desired rotation; once the desired rotation is achieved, the pulse terminates, but magnetization remains, ‘decaying’ according to the hysteresis curve of the field-generating element. Some residual magnetization will remain as relatively permanent, unless an opposite current flows through the element and demagnetizes it.

This process of ‘decay’ from the peak flux to a ‘remanent flux’ is clearly a virtue of the Faraday attenuator scheme. It is the analogue of phosphor decay in a CRT. It is what makes an analogue to ‘progressive’ scan, and a passive matrix, possible.

A field-generating element must be chosen carefully for its hysteresis curve, just as the optically-active material is chosen for its own characteristics. The flatter the hysteresis curve of the field-generating element, and the higher the remanent flux relative to the saturation flux, the more constant the magnitude of rotation of the rotating medium.

The curve may be short or tall. A tall hysteresis curve, however, would reflect a higher saturation flux and higher coercivity, thus requiring more power for both the ‘on’ and ‘off’ pulse. A ‘short’ curve, that is also ‘wide’ and ‘flat,’ would be optimum for the field-generating element. Some choice of materials between ferrimagnetics and ferromagnetics is suggested.

(As discussed above, some existing attenuators used for communications employ permanent magnets in order to magnetize the domains of the rotating medium perpendicular to the direction of propagation of the light beam. This is to improve the response curve of the attenuation in the initial response portion of the curve. Other techniques are possible, some demonstrated in other attenuators for communications, to achieve the desired performance characteristics of the rotating medium).

Given an optimum hysteresis curve, one that keeps the Faraday attenuator light-valve ‘on’ at the desired level, the other design variable for the switch is the time between the initial, ‘rotating’ pulse, and the second, ‘coercive’ pulse. In other words, how long the light-valve is on is able to be determined precisely with discrete, relatively low power pulses, according to the device requirements.

Note also that it is the possibility of designing for an appropriately-shaped curve that may obviate completely the need for a ‘continuously addressed’, active-matrix display. Even in such a display, the current would need to be reversed to eliminate remanent flux and switch the element completely ‘off.’

Faraday Rotators Are Fast: Progressive Scan with Passive Matrix at 60 fps or >Given the spec cited earlier in this document, (switching speeds with Faraday rotation at 1 ns), it is clear that, on a single circuit, that a passive-matrix, ‘progressive scan’ display is able to deliver 60 fps or faster.

Consider a 1080×1920 HDTV display, with 2.1 million pixels and 6.2 million subpixels. Given the switching speeds already achieved, a passive-matrix, ‘progressive-scan’ display could effectively switch 16 million subpixels/frame. Thus, even at a frame rate twice the 30 fps standard, such a display could deliver both the ‘rotation’ pulse, as well as the ‘coercivity’ pulse, within a single frame, and allow for almost a ‘third-of-a-frame’ duration in which a subpixel is rotated and ‘open’ to the extent required. Combined with advantageous characteristics of human visual perception, including ‘persistence of vision,’ such a scheme would result in superior display characteristics, (and would not require buffering ‘black’ frames).

Additional factors and strategies exist that can further improve the performance of a passive-matrix, ‘progressive scan’ FLAT display:

a) Display Area Subdivision Into Separate Circuits—To increase the duration between the ‘rotation’ pulse and the ‘coercivity’ pulse, a strategy similar to a use of separate electron guns in CRTs may be employed. For instance, all the red subpixels may be on one circuit, all the green subpixels on another, and all the blue on another. Thus, each circuit will ‘fire’ simultaneously as a ‘progressive scan’ of each color for the entire display.

Alternatively, the display area itself may be subdivided into regions. For instance, into 3×5 rectangular sections. In any such scheme, the total power requirement of the display is determined by the number of sections times the power required by the rotation of any subpixel. Thus, in an RGB subdivision, the peak current requirement at any one time would be (based on the reference spec) 3×50=150 m.amps. (An implementation of gas vapor as a rotating medium would result in, perhaps, a peak current of 150 microamps). In the 3×5 arrangement, the peak would be (according to our reference figures) 750 m.amps (or 750 microamps).

Even in the RGB subdivision scheme, subtracting the time required to address every subpixel (noting that this would not, on average, be required) in succession with a ‘rotation’ pulse, and then cancel the ‘remanent flux’ with a ‘coercivity’ pulse, the resulting increase in duration would mean each subpixel ‘at rotation’ for 75% of a frame. The 3×5 scheme would result in a subpixel being switched ‘on’ for 95% of a frame.

b) Compression Techniques: Delta Rotation vs. Reset Rotation—Data compression technologies are an essential method of enabling transmission of bandwidth-intensive applications such as HDTV. ‘Shannon-type’ compressions, such as JPEG, MPEG-2, Wavelets or Fractals are one category; ‘autosophy’ compression (viz., U.S. Pat. No. 5,917,948, Klaus Holtz), which is based on content information theory, operates on a higher order of ‘change analysis.’

In general, compression principles are relevant to the ‘rotation’ and ‘coercivity’ (‘on’/‘off’) steps in the present invention in that our default assumption has been that at the beginning of each frame, a subpixel that is rotated to achieve a required intensity, must afterwards be ‘reset’ to zero by application of a ‘reverse’ field strength equal to the ‘coercivity’ of the field-generating medium. In other words, the default assumption has been that each subpixel must be reset at the beginning of each frame.

However, by implementing compression-type software and hardware components, then any given subpixel may be addressed ‘intelligently.’ (Optimally, the components would ‘autosophy’-based: image buffer, change buffer, ‘hyperspace’ change library, 70-bit superpixel cluster codes; using memory chips and a CAM or CAROM—see Holtz).

In general, a ‘delta rotation’ current value (+ or −) is switched to the subpixel, rather than an absolute value starting from a reset ‘off’ position. The ‘remanent flux’ value is then either increased or decreased by the next pulse.

According to a preferred compression scheme, there need be only one pulse per frame—the initial ‘rotation’ pulse. Only if a subpixel that had been turned ‘on’ to some degree in one frame needs to be fully ‘off’ during the next, does the pulse need to generate a ‘reverse’ field equal to ‘coercivity’ of the field-generating element.

Additional embodiments of the present invention will result in variations of the above strategies and methods. Some brief additional notes are provided here regarding novel testing procedures that are suggested by advantageous features of the present invention. These testing procedures by no means exhaust all the advantages of the invention in terms testing, or the possibilities for improvement, (nor do they cover all testing requirements for every component of every embodiment).

Fiber Embodiments: An advantage of using fiber sections as light channels is that bulk lengths of fiber may be tested for optical activity, before segmentation for insertion or ‘weaving’ into a switching matrix. Passing a test rotator device down a long fiber length, with output detectors to measure rotation characteristics, indicates the ‘bulk’ testing potential of this class of embodiments.

A ‘textile’ approach to assembling the display/switching matrix suggests that until bonding or epoxying occurs, ‘strands’ may be removed or adjusted if defects or faults are detected in testing circuits.

Waveguides:—In addition to improvements in semiconductor waveguide manufacturing, testing, an repair, it is also noted that in the variation of this embodiment in which waveguide strips are perpendicular to the display surface, and are bonded or epoxied together, prior to bonding, individual strips may be tested and replaced if necessary.

All Embodiments:—A virtue of some embodiments of the present invention is that, once a matrix is assembled, the fact that subpixels (without diffusion optics in an outer display surface) are discrete and well-separable suggests efficiencies in testing and detecting defective subpixels.

By Comparison with Other Display Technologies—These possibilities for efficient and cheap testing, as well as replacement and/or repair of defective elements, should be considered in contrast to the still high defect rate in LCD displays, for instance, especially in large displays, as well as in PDPs.

The injection of the LC material in the sandwich structure of a LCD display, as well as the fabrication of InP active-matrix circuitry on optical glass, suggests the inherent limitations of testing and repairing defects in competing FPD technologies.

Conclusion on testing, with focus on fiber-optic based embodiments: fibers, with the integrated Faraday attenuator structures, are fabricated, employing the various optional methods, in long batch runs, and periodic formations that are the Faraday Attenuator structures are tested by passed of a laser test signal down the length of the fiber; a test probe is deployed to make contact with the contact points on the coilform, and rotation is effected through the entire range. Deficient Faraday attenuator structures in the long batch run are marked with computer bar-coding on the fiber and defective components simply skipped when textile weaving or cleaving occurs; a spindle threading a loom continues spooling to skip any defective element, etc. The result is a display matrix, in which 100% of subpixels are tested and determined functional, unlike LCD, gas-plasma, etc., with their extremely high defect rates, which result in entire displays being discarded, while the ‘acceptable’ ones still have a few percentage of subpixels that are defective.

Some representative examples of alternative implementations of embodiments of the present invention:

1. Specialized Subtype of Component Embodiment: Lightweight, High-resolution and Bright Display Face for VR Goggles—Many types of a display systems are possible given the thin, small, and lightweight display systems, including, for example, specialized high-resolution and bright display face for electronic goggles and goggle assemblies, such as used in nightvision and virtual reality goggles. As disclosed in the provisional patent application and the componentization patent application incorporated herein, it is also a feature of a preferred embodiment to further lighten a goggle and reduce its dimensions by componentizing the electronic goggle system.

By virtue of the fiber and fiber/waveguide integration schemes, a display face of an electronic goggle system of the preferred embodiment may be separated from the modulating/switching matrix, thus allowing for a high-intensity image to be conveyed from a remote location, such as for example within a helicopter's electronics package, via waveguides such as fiber-optic bundles to a fused fiber-optic faceplate in a VR goggle device or devices (sharing source). Thus night-vision flying capabilities may be improved.

Fiber-optic faceplates have been in the past employed in conjunction with other display sources, such as CRT or LCD, but such sources were limited in either resolution or brightness, due to the imprecise interfacing of the fiber to a phosphor screen in the first instance and the brightness limitations of LCD in the second instance. LCOS, while resulting in greater brightness, poses significant integration problems with fiber. The present invention, including a preferred embodiment including an integral fiber-to-fiberoptic faceplate solution in this context, or a waveguide-to-fiber solution, overcomes the limitations of prior approaches.

Alternatively to the faceplate approach, an extremely thin semiconductor sandwich scheme, as detailed in this section above, may be employed with side-illumination from optical fibers in a virtual reality goggle design wherein the switching matrix is contained in or near the display face. A brightness, speed, viewing angle, and optical qualities of the display face in either approach offer significant improvements in the performance and cost of nightvision and virtual reality headgear in general, for all applications.

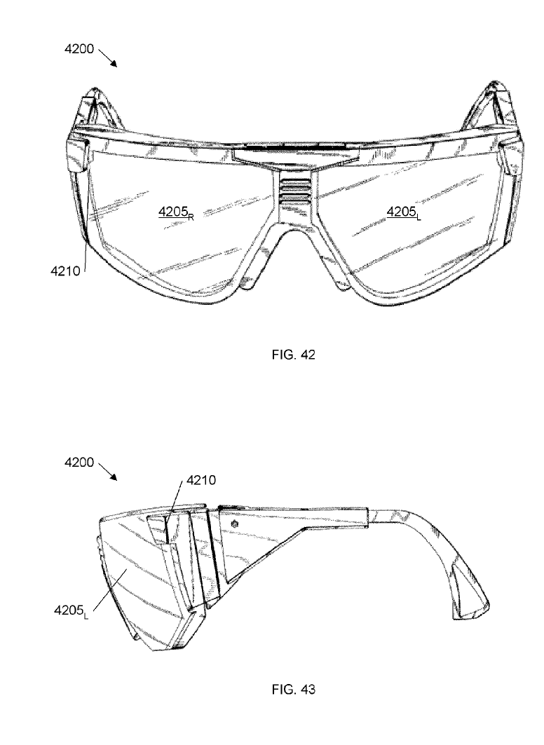

FIG. 42 is a front perspective view of a preferred embodiment for an electronic goggle system 4200 using substrated waveguide display systems. As shown, the substrated waveguide system is shown as a stereoscopic pair of substrated waveguide display systems 4205 as described above. Additionally, system 4200 includes a port 4210 for communication of power/data. FIG. 43 is a side perspective view of electronic goggle system 4200 shown in FIG. 42.

The brightness, speed, viewing angle, and optical qualities of the display face in either approach will make possible significant improvements in the performance and cost of VR headgear in general, for all applications.

2. Clothing Fabricated from Textile Display Material—This is an application derived from the woven-textile flat plane display paradigm. The subsidiary application for this invention will include details of continuously woven junctions between textile-switching ‘cloth’ sections.

3. A Central Distributed Switching System with Multiple Remote Display or Projection Units—This relatively straightforward extension of the modular embodiments will additionally encompass ‘display’ elements that do not receive complex TV video signals, but form wallpaper and other ‘programmable’ display elements, with many display devices of different kinds controlled by a central switching module.

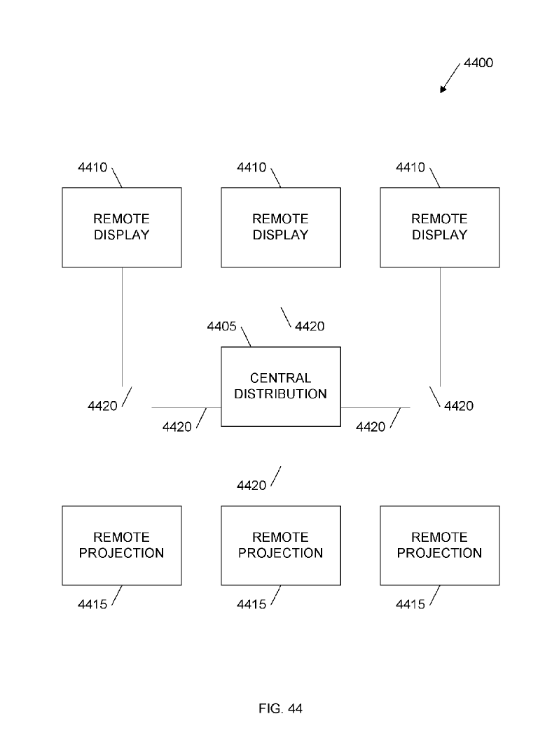

FIG. 44 is a general schematic block diagram of a preferred embodiment of the present invention for a macroscopic component system 4400. System 4400 is a relatively straightforward extension of the modular embodiments disclosed above to include a central distribution 4405 interconnected with remote display elements 4410 and remote projection systems 4415. These ‘display’ elements (display 4410 and projector 4415) preferably do not receive complex TV video signals; instead they receive direct imaging signals over waveguide bundles 4420, with illumination source(s) and/or control/tuning features are in central distribution 4405. The display elements may take the form of extremely thin structures (e.g., ‘wallpaper’ or ‘appliqué’ sections) and ‘programmable’ display elements, with many display devices of different kinds controlled by central switching module 4405. Each display element may present the same image signals or, with multiple independent channel features, independent image signals. Bundles 4420 may be combined with audio channels in some implementations, and may include two-way communication features for transmitting control signals to central distribution 4405 from the display elements. In this context, imaging signals refer to direct optical signals that may be rendered by the display element to reproduce the signals. Remote displays may be passive and include optical elements. An imaging signal, carried by optical waveguides, is contrasted to video signals that represent imaging signals and typically require electronics and power to convert from an electronic representation to an image. In the preferred embodiment, illumination sources and image control are in central distribution system 4405 providing a display element with minimal processing requirements. Thus, the display element may be simply a faceplate to properly order the waveguide channels into the appropriate presentation matrix.

In general, the invention is not limited to these and improvements not yet known to the efficiency and consistency of the Faraday rotation scheme or modified Faraday rotation scheme. Any such improvements only build on the inherent advantage magneto-optic switches have already demonstrated and widely commented on in speed, scalability, image quality (intensity, viewing angle, and the like) over, for instance, LCD.

In addition to these improvements not shown exhaustively in the main text or this addendum, it should be noted that the variables of the formula for the Faraday Effect, Eq. 1 above, imply various strategies to reduce the magnitude of the field required to achieve a given rotation. Higher Verdet constants continue to be achieved, for instance, through improvements in materials technology, such Tb-doped fibers and TBB thin-films (over YIG).

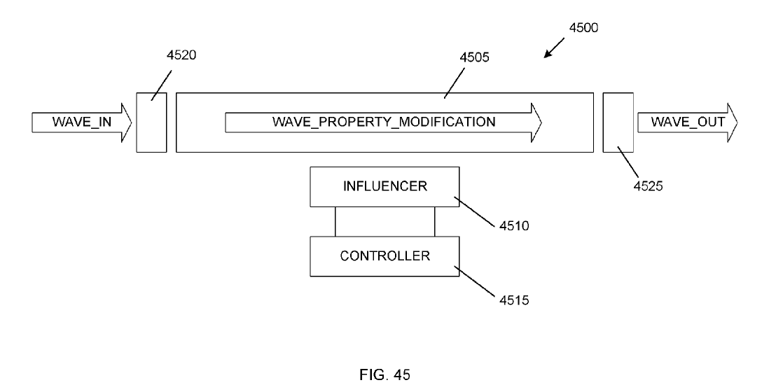

FIG. 45 is a general schematic plan view of a preferred embodiment of the present invention for a Faraday structured waveguide modulator 4500. Modulator 4500 includes an optical transport 4505, a property influencer 4510 operatively coupled to transport 4505, a first property element 4520, and a second property element 4525.

Transport 4505 may be implemented based upon many well-known optical waveguide structures of the art. For example, transport 4505 may be a specially adapted optical fiber (conventional or PCF) having a guiding channel including a guiding region and one or more bounding regions (e.g., a core and one or more cladding layers for the core), or transport 4505 may be a waveguide channel of a bulk device or substrate having one or more such guiding channels. A conventional waveguide structure is modified based upon the type of radiation property to be influenced and the nature of influencer 4510.

Influencer 4510 is a structure for manifesting property influence (directly or indirectly such as through the disclosed effects) on the radiation transmitted through transport 4505 and/or on transport 4505. Many different types of radiation properties may be influenced, and in many cases a particular structure used for influencing any given property may vary from implementation to implementation. In the preferred embodiment, properties that may be used in turn to control an output amplitude of the radiation are desirable properties for influence. For example, radiation polarization angle is one property that may be influenced and is a property that may be used to control a transmitted amplitude of the radiation. Use of another element, such as a fixed polarizer will control radiation amplitude based upon the polarization angle of the radiation compared to the transmission axis of the polarizer. Controlling the polarization angle varies the transmitted radiation in this example.

However, it is understood that other types of properties may be influenced as well and may be used to control output amplitude, such as for example, radiation phase or radiation frequency. Typically, other elements are used with modulator 4500 to control output amplitude based upon the nature of the property and the type and degree of the influence on the property. In some embodiments another characteristic of the radiation may be desirably controlled rather than output amplitude, which may require that a radiation property other than those identified be controlled, or that the property may need to be controlled differently to achieve the desired control over the desired attribute.

A Faraday Effect is but one example of one way of achieving polarization control within transport 4505. A preferred embodiment of influencer 4510 for Faraday polarization rotation influence uses a combination of variable and fixed magnetic fields proximate to or integrated within/on transport 4505. These magnetic fields are desirably generated so that a controlling magnetic field is oriented parallel to a propagation direction of radiation transmitted through transport 105. Properly controlling the direction and magnitude of the magnetic field relative to the transport achieves a desired degree of influence on the radiation polarization angle.

It is preferable in this particular example that transport 4505 be constructed to improve/maximize the ‘influencibility’ of the selected property by influencer 4510. For the polarization rotation property using a Faraday Effect, transport 4505 is doped, formed, processed, and/or treated to increase/maximize the Verdet constant. The greater the Verdet constant, the easier influencer 4510 is able to influence the polarization rotation angle at a given field strength and transport length. In the preferred embodiment of this implementation, attention to the Verdet constant is the primary task with other features/attributes/characteristics of the waveguide aspect of transport 4505 secondary. In the preferred embodiment, influencer 4510 is integrated or otherwise ‘strongly associated’ with transport 105 through the waveguide manufacturing process (e.g., the preform fabrication and/or drawing process), though some implementations may provide otherwise.

Element 4520 and element 4525 are property elements for selecting/filtering/operating on the desired radiation property to be influenced by influencer 4510. Element 4520 may be a filter to be used as a ‘gating’ element to pass wave components of the input radiation having a desired state for the appropriate property, or it may be a ‘processing’ element to conform one or more wave components of the input radiation to a desired state for the appropriate property. The gated/processed wave components from element 4520 are provided to optical transport 4505 and property influencer 4510 controllably influences the transported wave components as described above.

Element 4525 is a cooperative structure to element 4520 and operates on the influenced wave components. Element 4525 is a structure that passes WAVE_OUT and controls an amplitude of WAVE_OUT based upon a state of the property of the wave component. The nature and particulars of that control relate to the influenced property and the state of the property from element 4520 and the specifics of how that initial state has been influenced by influencer 4510.

For example, when the property to be influenced is a polarization property/polarization rotation angle of the wave components, element 4520 and element 4525 may be polarization filters. Element 4520 selects one specific type of polarization for the wave component, for example right hand circular polarization. Influencer 4510 controls a polarization rotation angle of radiation as it passes through transport 4505. Element 4525 filters the influenced wave component based upon the final polarization rotation angle as compared to a transmission angle of element 4525. In other words, when the polarization rotation angle of the influenced wave component matches the transmission axis of element 4525, WAVE_OUT has a high amplitude. When the polarization rotation angle of the influenced wave component is ‘crossed’ with the transmission axis of element 4525, WAVE_OUT has a low amplitude. A cross in this context refers to a rotation angle about ninety degrees misaligned with the transmission axis for conventional polarization filters.

Further, it is possible to establish the relative orientations of element 4520 and element 4525 so that a default condition results in a maximum amplitude of WAVE_OUT, a minimum amplitude of WAVE_OUT, or some value in between. A default condition refers to a magnitude of the output amplitude without influence from influencer 4510. For example, by setting the transmission axis of element 4525 at a ninety degree relationship to a transmission axis of element 4520, the default condition would be a minimum amplitude for the preferred embodiment.

Element 4520 and element 4525 may be discrete components or one or both structures may be integrated onto or into transport 4505. In some cases, the elements may be localized at an ‘input’ and an ‘output’ of transport 4505 as in the preferred embodiment, while in other embodiments these elements may be distributed in particular regions of transport 4505 or throughout transport 4505.

In operation, radiation (shown as WAVE_IN) is incident to element 4520 and an appropriate property (e.g., a right hand circular polarization (RCP) rotation component) is gated/processed to pass an RCP wave component to transport 4505. Transport 4505 transmits the RCP wave component until it is interacted with by element 4525 and the wave component (shown as WAVE_OUT) is passed. Incident WAVE_IN typically has multiple orthogonal states to the polarization property (e.g., right hand circular polarization (RCP) and left hand circular polarization (LCP)). Element 4520 produces a particular state for the polarization rotation property (e.g., passes one of the orthogonal states and blocks/shifts the other so only one state is passed). Influencer 4510, in response to a control signal, influences that particular polarization rotation of the passed wave component and may change it as specified by the control signal. Influencer 4510 of the preferred embodiment is able to influence the polarization rotation property over a range of about ninety degrees. Element 4525 then interacts with the wave component as it has been influenced permitting the radiation amplitude of WAVE_IN to be modulated from a maximum value when the wave component polarization rotation matches the transmission axis of element 4525 and a minimum value when the wave component polarization is ‘crossed’ with the transmission axis. By use of element 4520, the amplitude of WAVE_OUT of the preferred embodiment is variable from a maximum level to an extinguished level.

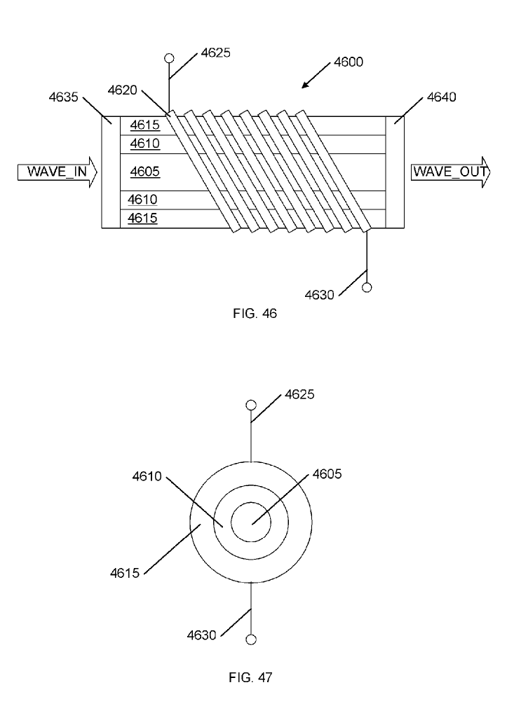

FIG. 46 is a detailed schematic plan view of a specific implementation of the preferred embodiment shown in FIG. 45. This implementation is described specifically to simplify the discussion, though the invention is not limited to this particular example. Faraday structured waveguide modulator 4500 shown in FIG. 1 is a Faraday optical modulator 4600 shown in FIG. 46.

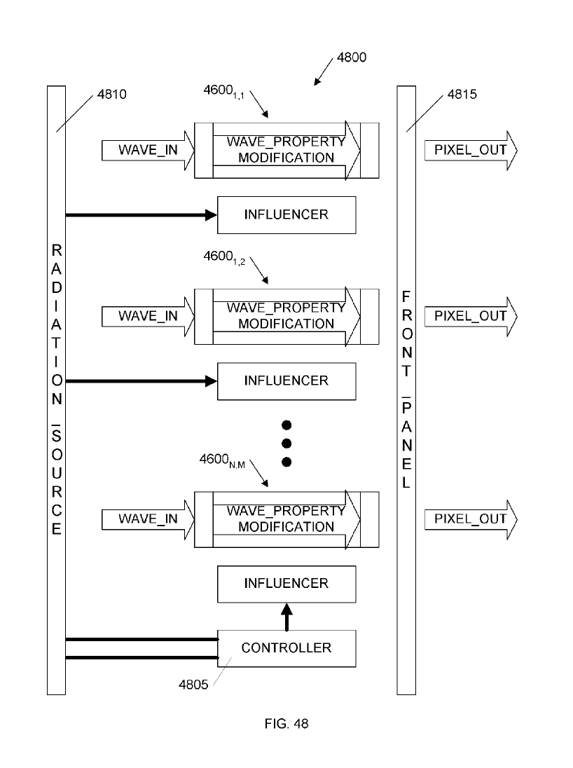

Modulator 4600 includes a core 4605, a first cladding layer 4610, a second cladding layer 4615, a coil or coilform 4620 (coil 4620 having a first control node 4625 and a second control node 4630), an input element 4635, and an output element 4640. FIG. 47 is a sectional view of the preferred embodiment shown in FIG. 46 taken between element 4635 and element 4640 with like numerals showing the same or corresponding structures.

Core 4605 may contain one or more of the following dopants added by standard fiber manufacturing techniques, e.g., variants on the vacuum deposition method: (a) color dye dopant (makes modulator 4600 effectively a color filter alight from a source illumination system), and (b) an optically-active dopant, such as YIG/Bi—YIG or Tb or TGG or other dopant for increasing the Verdet constant of core 4605 to achieve efficient Faraday rotation in the presence of an activating magnetic field. Heating or applying stress to the fiber during manufacturing adds holes or irregularities in core 4605 to further increase the Verdet constant and/or implement non-linear effects.

Much silica optical fiber is manufactured with high levels of dopants relative to the silica percentage (this level may be as high as fifty percent dopants). Current dopant concentrations in silica structures of other kinds of fiber achieve about ninety-degree rotation in a distance of tens of microns. Conventional fiber manufacturers continue to achieve improvements in increasing dopant concentration (e.g., fibers commercially available from JDS Uniphase) and in controlling dopant profile (e.g., fibers commercially available from Corning Incorporated). Core 4605 achieves sufficiently high and controlled concentrations of optically active dopants to provide requisite quick rotation with low power in micron-scale distances, with these power/distance values continuing to decrease as further improvements are made.

First cladding layer 4610 (optional in the preferred embodiment) is doped with ferro-magnetic single-molecule magnets, which become permanently magnetized when exposed to a strong magnetic field. Magnetization of first cladding layer 4610 may take place prior to the addition to core 4605 or pre-form, or after modulator 4600 (complete with core, cladding, coating(s) and/or elements) is drawn. During this process, either the preform or the drawn fiber passes through a strong permanent magnet field ninety degrees offset from a transmission axis of core 4605. In the preferred embodiment, this magnetization is achieved by an electro-magnetic disposed as an element of a fiber pulling apparatus. First cladding layer 4610 (with permanent magnetic properties) is provided to saturate the magnetic domains of the optically-active core 4605, but does not change the angle of rotation of the radiation passing through fiber 4600, since the direction of the magnetic field from layer 4610 is at right-angles to the direction of propagation. The incorporated provisional application describes a method to optimize an orientation of a doped ferromagnetic cladding by pulverization of non-optimal nuclei in a crystalline structure.

As single-molecule magnets (SMMs) are discovered that may be magnetized at relative high temperatures, the use of these SMMs will be preferable as dopants. The use of these SMMs allow for production of superior doping concentrations and dopant profile control. Examples of commercially available single-molecule magnets and methods are available from ZettaCore, Inc. of Denver, Colo.

Second cladding layer 4615 is doped with a ferrimagnetic or ferromagnetic material and is characterized by an appropriate hysteresis curve. The preferred embodiment uses a ‘short’ curve that is also ‘wide’ and ‘flat,’ when generating the requisite field. When second cladding layer 4615 is saturated by a magnetic field generated by an adjacent field-generating element (e.g., coil 4620), itself driven by a signal (e.g., a control pulse) from a controller such as a switching matrix drive circuit (not shown), second cladding layer 4615 quickly reaches a degree of magnetization appropriate to the degree of rotation desired for modulator 4600. Further, second cladding layer 4615 remains magnetized at or sufficiently near that level until a subsequent pulse either increases (current in the same direction), refreshes (no current or a +/−maintenance current), or reduces (current in the opposite direction) the magnetization level. This remanent flux of doped second cladding layer 4615 maintains an appropriate degree of rotation over time without constant application of a field by influencer 4510 (e.g., coil 4620).

Appropriate modification/optimization of the doped ferri/ferromagnetic material may be further effected by ionic bombardment of the cladding at an appropriate process step. Reference is made to U.S. Pat. No. 6,103,010 entitled ‘METHOD OF DEPOSITING A FERROMAGNETIC FILM ON A WAVEGUIDE AND A MAGNETO-OPTIC COMPONENT COMPRISING A THIN FERROMAGNETIC FILM DEPOSITED BY THE METHOD’ and assigned to Alcatel of Paris, France in which ferromagnetic thin-films deposited by vapor-phase methods on a waveguide are bombarded by ionic beams at an angle of incidence that pulverizes nuclei not ordered in a preferred crystalline structure. Alteration of crystalline structure is a method known to the art, and may be employed on a doped silica cladding, either in a fabricated fiber or on a doped preform material. The '010 patent is hereby expressly incorporated by reference for all purposes.

Similar to first cladding layer 4610, suitable single-molecule magnets (SMMs) that are developed and which may be magnetized at relative high temperatures will be preferable as dopants in the preferred embodiment for second cladding layer 4615 to allow for superior doping concentrations.

Coil 4620 of the preferred embodiment is fabricated integrally on or in fiber 4600 to generate an initial magnetic field. This magnetic field from coil 4620 rotates the angle of polarization of radiation transmitted through core 4605 and magnetizes the ferri/ferromagnetic dopant in second cladding layer 4615. A combination of these magnetic fields maintains the desired angle of rotation for a desired period (such a time of a video frame when a matrix of fibers 4600 collectively form a display as described in one of the related patent applications incorporated herein). For purposes of the present discussion, a ‘coilform’ is defined as a structure similar to a coil in that a plurality of conductive segments are disposed parallel to each other and at right-angles to the axis of the fiber. As materials performance improves—that is, as the effective Verdet constant of a doped core increases by virtue of dopants of higher Verdet constant (or as augmented structural modifications, including those introducing non-linear effects)—the need for a coil or ‘coilform’ surrounding the fiber element may be reduced or obviated, and simpler single bands or Gaussian cylinder structures will be practical. These structures, when serving the functions of the coilform described herein, are also included within the definition of coilform.

When considering the variables of the equation specifying the Faraday Effect: field strength, distance over which the field is applied, and the Verdet constant of the rotating medium, one consequence is that structures, components, and/or devices using modulator 4600 are able to compensate for a coil or coilform formed of materials that produce less intense magnetic fields. Compensation may be achieved by making modulator 4600 longer, or by further increasing/improving the effective Verdet constant. For example, in some implementations, coil 4620 uses a conductive material that is a conductive polymer that is less efficient than a metal wire. In other implementations, coil 4620 uses wider but fewer windings than otherwise would be used with a more efficient material. In still other instances, such as when coil 4620 is fabricated by a convenient process but produces coil 4620 having a less efficient operation, other parameters compensate as necessary to achieve suitable overall operation.

There are tradeoffs between design parameters—fiber length, Verdet constant of core, and peak field output and efficiency of the field-generating element. Taking these tradeoffs into consideration produces four preferred embodiments of an integrally-formed coilform, including: (1) twisted fiber to implement a coil/coilform, (2) fiber wrapped epitaxially with a thinfilm printed with conductive patterns to achieve multiple layers of windings, (3) printed by dip-pen nanolithography on fiber to fabricate a coil/coilform, and (4) coil/coilform wound with coated/doped glass fiber, or alternatively a conductive polymer that is metallically coated or uncoated, or a metallic wire. Further details of these embodiments are described in the related and incorporated provisional patent application referenced above.

Node 4625 and node 4630 receive a signal for inducing generation of the requisite magnetic fields in core 4605, cladding layer 4615, and coil 4620. This signal in a simple embodiment is a DC (direct current) signal of the appropriate magnitude and duration to create the desired magnetic fields and rotate the polarization angle of the WAVE_IN radiation propagating through modulator 4600. A controller (not shown) may provide this control signal when modulator 4600 is used.

Input element 4635 and output element 4640 are polarization filters in the preferred embodiment, provided as discrete components or integrated into/onto core 4605. Input element 4635, as a polarizer, may be implemented in many different ways. Various polarization mechanisms may be employed that permit passage of light of a single polarization type (specific circular or linear) into core 4605; the preferred embodiment uses a thin-film deposited epitaxially on an ‘input’ end of core 4605. An alternate preferred embodiment uses commercially available nano-scale microstructuring techniques on waveguide 4600 to achieve polarization filtering (such as modification to silica in core 4605 or a cladding layer as described in the incorporated Provisional Patent Application.) In some implementations for efficient input of light from one or more light source(s), a preferred illumination system may include a cavity to allow repeated reflection of light of the ‘wrong’ initial polarization; thereby all light ultimately resolves into the admitted or ‘right’ polarization. Optionally, especially depending on the distance from the illumination source to modulator 4600, polarization-maintaining waveguides (fibers, semiconductor) may be employed.

Output element 4640 of the preferred embodiment is a ‘polarization filter’ element that is ninety degrees offset from the orientation of input element 4635 for a default ‘off’ modulator 4600. (In some embodiments, the default may be made ‘on’ by aligning the axes of the input and output elements. Similarly, other defaults such as fifty percent amplitude may be implemented by appropriate relationship of the input and output elements and suitable control from the influencer.) Element 4640 is preferably a thin-film deposited epitaxially on an output end of core 4605. Input element 4635 and output element 4640 may be configured differently from the configurations described here using other polarization filter/control systems. When the radiation property to be influenced includes a property other than a radiation polarization angle (e.g., phase or frequency), other input and output functions are used to properly gate/process/filter the desired property as described above to modulate the amplitude of WAVE_OUT responsive to the influencer.

FIG. 48 is a schematic block diagram of a preferred embodiment for a display assembly 4800. Assembly 4800 includes an aggregation of a plurality of picture elements (pixels) each generated by a waveguide modulator 4600_{i,j} such as shown in FIG. 46. Control signals for control of each influencer of modulators 4600ᵢⱼ are provided by a controller 4805. A radiation source 4810 provides source radiation for input/control by modulators 4600ᵢⱼ and a front panel may be used to arrange modulators 4600ᵢⱼ into a desired pattern and or optionally provide post-output processing of one or more pixels.

Radiation source 4810 may be unitary balanced-white or separate RGB/CMY tuned source or sources or other appropriate radiation frequency. Source(s) 4810 may be remote from input ends of modulator 4600ᵢⱼ, adjacent these input ends, or integrated onto/into modulator 4600ᵢⱼ. In some implementations, a single source is used, while other implementations may use several or more (and in some cases, one source per modulator 4600ᵢⱼ).

As discussed above, the preferred embodiment for the optical transport of modulator 4600ᵢⱼ includes light channels in the form of special optical fibers. But semiconductor waveguide, waveguiding holes, or other optical waveguiding channels, including channels or regions formed through material ‘in depth,’ are also encompassed within the scope of the present invention. These waveguiding elements are fundamental imaging structures of the display and incorporate, integrally, amplitude modulation mechanisms and color selection mechanisms. In the preferred embodiment for an FPD implementation, a length of each of the light channels is preferably on the order of about tens of microns (though the length may be different as described herein).

It is one feature of the preferred embodiment that a length of the optical transport is short (on the order of about 20 mm and shorter), and able to be continually shortened as the effective Verdet value increases and/or the magnetic field strength increases. The actual depth of a display will be a function of the channel length but because optical transport is a waveguide, the path need not be linear from the source to the output (the path length). In other words, the actual path may be bent to provide an even shallower effective depth in some implementations. The path length, as discussed above, is a function of the Verdet constant and the magnetic field strength and while the preferred embodiment provides for very short path lengths of a few millimeters and shorter, longer lengths may be used in some implementations as well. The necessary length is determined by the influencer to achieve the desired degree of influence/control over the input radiation. In the preferred embodiment for polarized radiation, this control is able to achieve about a ninety degree rotation. In some applications, when an extinguishing level is higher (e.g., brighter) then less rotation may be used which shortens the necessary path length. Thus, the path length is also influenced by the degree of desired influence on the wave component.

Controller 4805 includes a number of alternatives for construction and assembly of a suitable switching system. The preferred implementation includes not only a point-to-point controller, it also encompasses a ‘matrix’ that structurally combines and holds modulators 4600_{i,j}, and electronically addresses each pixel. In the case of optical fibers, inherent in the nature of a fiber component is the potential for an all-fiber, textile construction and appropriate addressing of the fiber elements. Flexible meshes or solid matrixes are alternative structures, with attendant assembly methods.

It is one feature of the preferred embodiment that an output end of one or more modulators 4600ᵢⱼ may be processed to improve its application. For example, the output ends of the waveguide structures, particularly when implemented as optical fibers, may be heat-treated and pulled to form tapered ends or otherwise abraded, twisted, or shaped for enhanced light scattering at the output ends, thereby improving viewing angle at the display surface. Some and/or all of the modulator output ends may be processed in similar or dissimilar ways to collectively produce a desired output structure achieving the desired result. For example, various focus, attenuation, color or other attribute(s) of the WAVE_OUT from one or more pixels may be controlled or affected by the processing of one or more output ends/corresponding panel location(s).

Front panel 4815 may be simply a sheet of optical glass or other transparent optical material facing the polarization component or it may include additional functional and structural features. For example, panel 4815 may include guides or other structures to arrange output ends of modulators 4600ᵢⱼ into the desired relative orientation with neighboring modulators 4600ᵢⱼ. FIG. 49 is a view of one arrangement for output ports 4900_{x,y} of front panel 4815 shown in FIG. 48. Other arrangements are possible are also possible depending upon the desired display (e.g., circular, elliptical or other regular/irregular geometric shape) When an application requires it, the active display area does not have to be contiguous pixels such that rings or ‘doughnut’ displays are possible when appropriate. In other implementations, output ports may focus, disperse, filter, or perform other type of post-output processing on one or more pixels.

An optical geometry of a display or projector surface may itself vary in which waveguide ends terminate to a desired three-dimensional surface (e.g., a curved surface) which allows additional focusing capacity in sequence with additional optical elements and lenses (some of which may be included as part of panel 4815). Some applications may require multiple areas of concave, flat, and/or convex surface regions, each with different curvatures and orientations with the present invention providing the appropriate output shape. In some applications, the specific geometry need not be fixed but may be dynamically alterable to change shapes/orientations/dimensions as desired. Implementations of the present invention may produce various types of haptic display systems as well.

In projection system implementations, radiation source 4810, a ‘switching assembly’ with controller 4805 coupled to modulators 4600ᵢⱼ, and front panel 4815 may benefit from being housed in distinct modules or units, at some distance from each other. Regarding radiation source 4810, in some embodiments it is advantageous to separate the illumination source(s) from the switching assembly due to heat produced by the types of high-amplitude light that is typically required to illuminate a large theatrical screen. Even when multiple illumination sources are used, distributing the heat output otherwise concentrated in, for instance, a single Xenon lamp, the heat output may still be large enough that the separation from the switching and display elements may be desirable. The illumination source(s) thus would be housed in an insulated case with heat sink and cooling elements. Fibers would then convey the light from the separate or unitary source to the switching assembly, and then projected onto the screen. The screen may include some features of front panel 4815 or panel 4815 may be used prior to illuminating an appropriate surface.

The separation of the switching assembly from the projection/display surface may have its own advantages. Placing the illumination and switching assembly in a projection system base (the same would hold true for an FPD) is able to reduce the depth of a projection TV cabinet. Or, the projection surface may be contained in a compact ball at the top of a thin lamp-like pole or hanging from the ceiling from a cable, in front projection systems employing a reflective fabric screen.

For theatrical projection, the potential to convey the image formed by the switching assembly, by means of waveguide structures from a unit on the floor, up to a compact final-optics unit at the projection window area, suggests a space-utilization strategy to accommodate both a traditional film projector and a new projector of the preferred embodiment in the same projection room, among other potential advantages and configurations.

A monolithic construction of waveguide strips, each with multiple thousands of waveguides on a strip, arranged or adhered side by side, may accomplish hi-definition imaging. However, ‘bulk’ fiber optic component construction may also accomplish the requisite small projection surface area in the preferred embodiment. Single-mode fibers (especially without the durability performance requirements of external telecommunications cable) have a small enough diameter that the cross-sectional area of a fiber is quite small and suitable as a display pixel or subpixel.

In addition, integrated optics manufacturing techniques are expected to permit attenuator arrays of the present invention to be accomplished in the fabrication of a single semiconductor substrate or chip, massively monolithic or superficial.

In a fused-fiber projection surface, the fused-fiber surface may be then ground to achieve a curvature for the purpose of focusing an image into an optical array; alternatively, fiber-ends that are joined with adhesive or otherwise bound may have shaped tips and may be arranged at their terminus in a shaped matrix to achieve a curved surface, if necessary.

For projection televisions or other non-theatrical projection applications, the option of separating the illumination and switching modules from the projector surface enables novel ways of achieving less-bulky projection television cabinet construction.

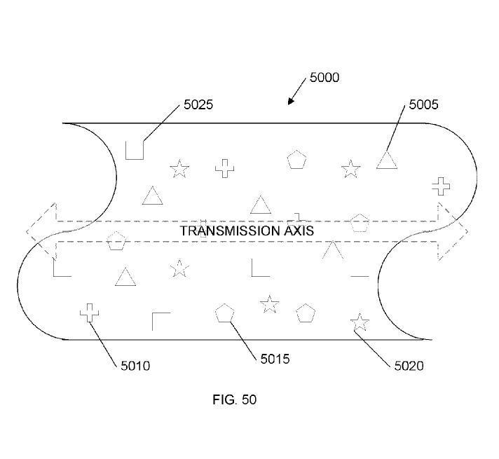

FIG. 50 is a schematic representation of a preferred embodiment of the present invention for a portion 5000 of the structured waveguide 4605 shown in FIG. 46. Portion 5000 is a radiation propagating channel of waveguide 4605, typically a guiding channel (e.g., a core for a fiber waveguide) but may include one or more bounding regions (e.g., claddings for the fiber waveguide). Other waveguiding structures have different specific mechanisms for enhancing the waveguiding of radiation propagated along a transmission axis of a channel region of the waveguide. Waveguides include photonic crystal fibers, special thin-film stacks of structured materials and other materials. The specific mechanisms of waveguiding may vary from waveguide to waveguide, but the present invention may be adapted for use with the different structures.

For purposes of the present invention, the terms guiding region or guiding channel and bounding regions refer to cooperative structures for enhancing radiation propagation along the transmission axis of the channel. These structures are different from buffers or coatings or post-manufacture treatments of the waveguide. A principle difference is that the bounding regions are typically capable of propagating the wave component propagated through the guiding region while the other components of a waveguide do not. For example, in a multimode fiber optic waveguide, significant energy of higher-order modes is propagated through the bounding regions. One point of distinction is that the guiding region/bounding region(s) are substantially transparent to propagating radiation while the other supporting structures are generally substantially opaque.

As described above, influencer 4510 works in cooperation with waveguide 4605 to influence a property of a propagating wave component as it is transmitted along the transmission axis. Portion 5000 is therefore said to have an influencer response attribute, and in the preferred embodiment this attribute is particularly structured to enhance the response of the property of the propagating wave to influencer 4510. Portion 5000 includes a plurality of constituents (e.g., rare-earth dopants 5005, holes, 5010, structural irregularities 5015, microbubbles 5020, and/or other elements 5025) disposed in the guiding region and/or one or more bounding regions as desirable for any specific implementation. In the preferred embodiment, portion 5000 has a very short length, in many cases less than about 25 millimeters, and as described above, sometimes significantly shorter than that. The influencer response attribute enhanced by these constituents is optimized for short length waveguides (for example as contrasted to telecommunications fibers optimized for very long lengths on the order of kilometers and greater, including attenuation and wavelength dispersion). The constituents of portion 5000, being optimized for a different application, could seriously degrade telecommunications use of the waveguide. While the presence of the constituents is not intended to degrade telecommunications use, the focus of the preferred embodiment on enhancement of the influencer response attribute over telecommunications attribute(s) makes it possible for such degradation to occur and is not a drawback of the preferred embodiment.

The present invention contemplates that there are many different wave properties that may be influenced by different constructions of influencer 4510; the preferred embodiment targets a Faraday-effect-related property of portion 5000. As discussed above, the Faraday Effect induces a polarization rotation change responsive to a magnetic field parallel to a propagation direction. In the preferred embodiment, when influencer 4510 generates a magnetic field parallel to the transmission axis, in portion 5000 the amount of rotation is dependent upon the strength of the magnetic field, the length of portion 5000, and the Verdet constant for portion 5000. The constituents increase the responsiveness of portion 5000 to this magnetic field, such as by increasing the effective Verdet constant of portion 5000.

One significance of the paradigm shift in waveguide manufacture and characteristics by the present invention is that modification of manufacturing techniques used to make kilometer-lengths of optically-pure telecommunications grade waveguides enables manufacture of inexpensive kilometer-lengths of potentially optically-impure (but optically-active) influencer-responsive waveguides. As discussed above, some implementations of the preferred embodiment may use a myriad of very short lengths of waveguides modified as disclosed herein. Cost savings and other efficiencies/merits are realized by forming these collections from short length waveguides created from (e.g., cleaving) the longer manufactured waveguide as described herein. These cost savings and other efficiencies and merits include the advantages of using mature manufacturing techniques and equipment that have the potential to overcome many of the drawbacks of magneto-optic systems employing discrete conventionally produced magneto-optic crystals as system elements. For example, these drawbacks include a high cost of production, a lack of uniformity across a large number of magneto-optic crystals and a relatively large size of the individual components that limits the size of collections of individual components.

The preferred embodiment includes modifications to fiber waveguides and fiber waveguide manufacturing methodologies. At its most general, an optical fiber is a filament of transparent (at the wavelength of interest) dielectric material (typically glass or plastic) and usually circular in cross section that guides light. For early optical fibers, a cylindrical core was surrounded by, and in intimate contact with, a cladding of similar geometry. These optical fibers guided light by providing the core with slightly greater refractive index than that of the cladding layer. Other fiber types provide different guiding mechanisms—one of interest in the context of the present invention includes photonic crystal fibers (PCF) as described above.

Silica (silicon dioxide (SiO₂)) is the basic material of which the most common communication-grade optical fibers are made. Silica may occur in crystalline or amorphous form, and occurs naturally in impure forms such as quartz and sand. The Verdet constant is an optical constant that describes the strength of the Faraday Effect for a particular material. The Verdet constant for most materials, including silica is extremely small and is wavelength dependent. It is very strong in substances containing paramagnetic ions such as terbium (Tb). High Verdet constants are found in terbium doped dense flint glasses or in crystals of terbium gallium garnet (TGG). This material generally has excellent transparency properties and is very resistant to laser damage. Although the Faraday Effect is not chromatic (i.e. it doesn't depend on wavelength), the Verdet constant is quite strongly a function of wavelength. At 632.8 nm, the Verdet constant for TGG is reported to be −134 radT-1 whereas at 1064 nm, it has fallen to −40radT-1. This behavior means that the devices manufactured with a certain degree of rotation at one wavelength, will produce much less rotation at longer wavelengths.

The constituents may, in some implements, include an optically-active dopant, such as YIG/Bi—YIG or Tb or TGG or other best-performing dopant, which increases the Verdet constant of the waveguide to achieve efficient Faraday rotation in the presence of an activating magnetic field. Heating or stressing during the fiber manufacturing process as described below may further increase the Verdet constant by adding additional constituents (e.g., holes or irregularities) in portion 5000. Rare-earths as used in conventional waveguides are employed as passive enhancements of transmission attributes elements, and are not used in optically-active applications.

Since silica optical fiber is manufactured with high levels of dopants relative to the silica percentage itself, as high as at least 50% dopants, and since requisite dopant concentrations have been demonstrated in silica structures of other kinds to achieve 90 degree rotation in tens of microns or less; and given improvements in increasing dopant concentrations (e.g., fibers commercially available from JDS Uniphase) and improvements in controlling dopant profiles (e.g., fibers, commercially available from Corning Incorporated), it is possible to achieve sufficiently high and controlled concentrations of optically-active dopant to induce rotation with low power in micron-scale distances.

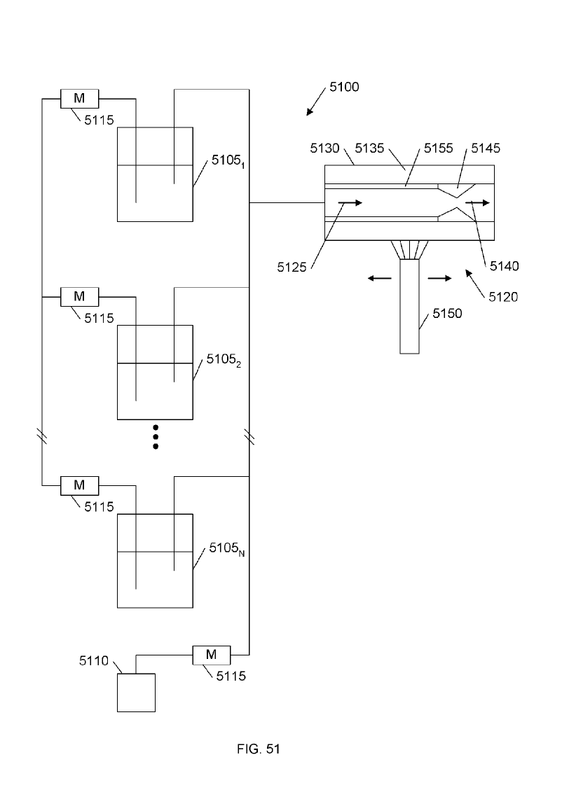

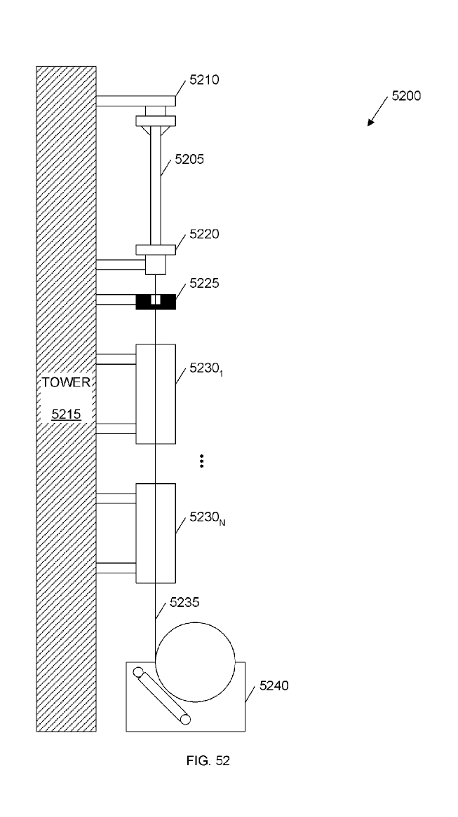

FIG. 51 is a schematic block diagram of a representative waveguide manufacturing system 5100 for making a preferred embodiment of a waveguide preform of the present invention. System 5100 represents a modified chemical vapor deposition (MCVD) process to produce a glass rod referred to as the preform. The preform from a conventional process is a solid rod of ultra-pure glass, duplicating the optical properties of a desired fiber exactly, but with linear dimensions scaled-up two orders of magnitude or more. However, system 5100 produces a preform that does not emphasize optical purity but optimizes for short-length optimization of influencer response. Preforms are typically made using one of the following chemical vapor deposition (CVD) methods: 1. Modified Chemical Vapor Deposition (MCVD), 2. Plasma Modified Chemical Vapor Deposition (PMCVD), 3. Plasma Chemical Vapor Deposition (PCVD), 4. Outside Vapor Deposition (OVD), 5. Vapor-phase Axial Deposition (AVD). All these methods are based on thermal chemical vapor reaction that forms oxides, which are deposited as layers of glass particles called soot, on the outside of a rotating rod or inside a glass tube. The same chemical reactions occur in these methods.

Various liquids (e.g., starting materials are solutions of SiCl₄, GeCl₄, POCl₃, and gaseous BCl₃) that provide the source for Si and dopants are heated in the presence in oxygen gas, each liquid in a heated bubbler 5105 and gas from a source 5110. These liquids are evaporated within an oxygen stream controlled by a mass-flow meter 5115 and, with the gasses, form silica and other oxides from combustion of the glass-producing halides in a silica-lathe 5120. Chemical reactions called oxidizing reactions occur in the vapor phase, as listed below:
GeCl₄+O₂=>GeO₂+2Cl₂
SiCl₄+O₂=>SiO₂+2Cl₂
4POCl₃+3O₂=>2P₂O₅+6Cl₂
4BCl₃+3O₂=>2B₂O₃+6Cl₂

Germanium dioxide and phosphorus pentoxide increase the refractive index of glass, a boron oxide—decreases it. These oxides are known as dopants. Other bubblers 5105 including suitable constituents for enhancing the influencer response attribute of the preform may be used in addition to those shown.

Changing composition of the mixture during the process influences a refractive index profile and constituent profile of the preform. The flow of oxygen is controlled by mixing valves 5115, and reactant vapors 5125 are blown into silica pipe 5130 that includes a heated tube 5135 where oxidizing takes places. Chlorine gas 5140 is blown out of tube 5135, but the oxide compounds are deposited in the tube in the form of soot 5145. Concentrations of iron and copper impurity is reduced from about 10 ppb in the raw liquids to less than 1 ppb in soot 5145.

Tube 5135 is heated using a traversing H₂O₂ burner 5150 and is continually rotated to vitrify soot 5145 into a glass 5155. By adjusting the relative flow of the various vapors 5125, several layers with different indices of refraction are obtained, for example core versus cladding or variable core index profile for GI fibers. After the layering is completed, tube 5135 is heated and collapsed into a rod with a round, solid cross-section, called the preform rod. In this step it is essential that center of the rod be completely filled with material and not hollow. The preform rod is then put into a furnace for drawing, as will be described in cooperation with FIG. 52.

The main advantage of MCVD is that the reactions and deposition occur in a closed space, so it is harder for undesired impurities to enter. The index profile of the fiber is easy to control, and the precision necessary for SM fibers can be achieved relatively easily. The equipment is simple to construct and control. A potentially significant limitation of the method is that the dimensions of the tube essentially limit the rod size. Thus, this technique forms fibers typically of 35 km in length, or 20-40 km at most. In addition, impurities in the silica tube, primarily H₂ and OH—, tend to diffuse into the fiber. Also, the process of melting the deposit to eliminate the hollow center of the preform rod sometimes causes a depression of the index of refraction in the core, which typically renders the fiber unsuitable for telecommunications use but is not generally of concern in the context of the present invention. In terms of cost and expense, the main disadvantage of the method is that the deposition rate is relatively slow because it employs indirect heating, that is tube 735 is heated, not the vapors directly, to initiate the oxidizing reactions and to vitrify the soot. The deposition rate is typically 0.5 to 2 g/min.

A variation of the above-described process makes rare-earth doped fibers. To make a rare-earth doped fiber, the process starts with a rare-earth doped preform—typically fabricated using a solution doping process. Initially, an optical cladding, consisting primarily of fused silica, is deposited on an inside of the substrate tube. Core material, which may also contain germanium, is then deposited at a reduced temperature to form a diffuse and permeable layer known as a ‘frit’. After deposition of the frit, this partially-completed preform is sealed at one end, removed from the lathe and a solution of suitable salts of the desired rare-earth dopant (e.g., neodymium, erbium, ytterbium etc.) is introduced. Over a fixed period of time, this solution is left to permeate the frit. After discarding any excess solution, the preform is returned to the lathe to be dried and consolidated. During consolidation, the interstices within the frit collapse and encapsulate the rare-earth. Finally, the preform is subjected to a controlled collapse, at high temperature to form a solid rod of glass—with a rare-earth incorporated into the core. Generally inclusion of rare-earths in fiber cables are not optically-active, that is, respond to electric or magnetic or other perturbation or field to affect a characteristic of light propagating through the doped medium. Conventional systems are the results of ongoing quests to increase the percentage of rare-earth dopants driven by a goal to improve ‘passive’ transmission characteristics of waveguides (including telecommunications attributes). But the increased percentages of dopants in waveguide core/boundaries is advantageous for affecting optical-activity of the compound medium/structure for the preferred embodiment. As discussed above, in the preferred embodiment the percentage of dopants vs. silica is at least fifty percent.

FIG. 52 is a schematic diagram of a representative fiber drawing system 5200 for making a preferred embodiment of the present invention from a preform 5205, such as one produced from system 5100 shown in FIG. 51. System 5200 converts preform 5205 into a hair-thin filament, typically performed by drawing. Preform 5205 is mounted into a feed mechanism 5210 attached near a top of a tower 5215. Mechanism 5210 lowers preform 5205 until a tip enters into a high-purity graphite furnace 5220. Pure gasses are injected into the furnace to provide a clean and conductive atmosphere. In furnace 5220, tightly controlled temperatures approaching 1900° C. soften the tip of preform 5205. Once the softening point of the preform tip is reached, gravity takes over and allows a molten gob to ‘free fall’ until it has been stretched into a thin strand.

An operator threads this strand of fiber through a laser micrometer 5225 and a series of processing stations 5230x(e.g., for coatings and buffers) for producing a transport 5235 that is wound onto a spool by a tractor 5240, and the drawing process begins. The fiber is pulled by tractor 5240 situated at the bottom of draw tower 5215 and then wound on winding drums. During the draw, preform 5205 is heated at the optimum temperature to achieve an ideal drawing tension. Draw speeds of 10-20 meters per second are not uncommon in the industry.

During the draw process the diameter of the drawn fiber is controlled to 125 microns within a tolerance of only 1 micron. Laser-based diameter gauge 5225 monitors the diameter of the fiber. Gauge 5225 samples the diameter of the fiber at rates in excess of 750 times per second. The actual value of the diameter is compared to the 125 micron target. Slight deviations from the target are converted to changes in draw speeds and fed to tractor 5240 for correction.

Processing stations 5230x typically include dies for applying a two layer protective coating to the fiber—a soft inner coating and a hard outer coating. This two-part protective jacket provides mechanical protection for handling while also protecting a pristine surface of the fiber from harsh environments. These coatings are cured by ultraviolet lamps, as part of the same or other processing stations 5230x. Other stations 230x may provide apparatus/systems for increasing the influencer response attribute of transport 5235 as it passes through the station(s). For example, various mechanical stressors, ion bombardment or other mechanism for introducing the influencer response attribute enhancing constituents at the drawing stage.

After spooled, the drawn fiber is tested for suitable optical and geometrical parameters. For transmission fibers, a tensile strength is usually tested first to ensure that a minimal tensile strength for the fiber has been achieved. After the first test, many different tests are performed, which for transmission fibers includes tests for transmission attributes, including: attenuation (decrease in signal strength over distance), bandwidth (information-carrying capacity; an important measurement for multimode fiber), numerical aperture (the measurement of the light acceptance angle of a fiber), cut-off wavelength (in single-mode fiber the wavelength above which only a single mode propagates), mode field diameter (in single-mode fiber the radial width of the light pulse in the fiber; important for interconnecting), and chromatic dispersion (the spreading of pulses of light due to rays of different wavelengths traveling at different speeds through the core; in single-mode fiber this is the limiting factor for information carrying capacity).

The patents, applications, publications, and other references disclosed herein are each expressly incorporated by reference in their entireties for all purposes.

The system, method, computer program product, and propagated signal described in this application may, of course, be embodied in hardware; e.g., within or coupled to a Central Processing Unit (‘CPU’), microprocessor, microcontroller, System on Chip (‘SOC’), or any other programmable device. Additionally, the system, method, computer program product, and propagated signal may be embodied in software (e.g., computer readable code, program code, instructions and/or data disposed in any form, such as source, object or machine language) disposed, for example, in a computer usable (e.g., readable) medium configured to store the software. Such software enables the function, fabrication, modeling, simulation, description and/or testing of the apparatus and processes described herein. For example, this can be accomplished through the use of general programming languages (e.g., C, C++), GDSII databases, hardware description languages (HDL) including Verilog HDL, VHDL, AHDL (Altera HDL) and so on, or other available programs, databases, nanoprocessing, and/or circuit (i.e., schematic) capture tools. Such software can be disposed in any known computer usable medium including semiconductor, magnetic disk, optical disc (e.g., CD-ROM, DVD-ROM, etc.) and as a computer data signal embodied in a computer usable (e.g., readable) transmission medium (e.g., carrier wave or any other medium including digital, optical, or analog-based medium). As such, the software can be transmitted over communication networks including the Internet and intranets. A system, method, computer program product, and propagated signal embodied in software may be included in a semiconductor intellectual property core (e.g., embodied in HDL) and transformed to hardware in the production of integrated circuits. Additionally, a system, method, computer program product, and propagated signal as described herein may be embodied as a combination of hardware and software.

One of the preferred implementations of the present invention, for example for the switching control, is as a routine in an operating system made up of programming steps or instructions resident in a memory of a computing system during computer operations. Until required by the computer system, the program instructions may be stored in another readable medium, e.g. in a disk drive, or in a removable memory, such as an optical disk for use in a CD ROM computer input or in a floppy disk for use in a floppy disk drive computer input. Further, the program instructions may be stored in the memory of another computer prior to use in the system of the present invention and transmitted over a LAN or a WAN, such as the Internet, when required by the user of the present invention. One skilled in the art should appreciate that the processes controlling the present invention are capable of being distributed in the form of computer readable media in a variety of forms.

Any suitable programming language can be used to implement the routines of the present invention including C, C++, Java, assembly language, etc. Different programming techniques can be employed such as procedural or object oriented. The routines can execute on a single processing device or multiple processors. Although the steps, operations or computations may be presented in a specific order, this order may be changed in different embodiments. In some embodiments, multiple steps shown as sequential in this specification can be performed at the same time. The sequence of operations described herein can be interrupted, suspended, or otherwise controlled by another process, such as an operating system, kernel, etc. The routines can operate in an operating system environment or as stand-alone routines occupying all, or a substantial part, of the system processing.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

A ‘computer-readable medium’ for purposes of embodiments of the present invention may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory.

A ‘processor’ or ‘process’ includes any human, hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in ‘real time,’ ‘offline,’ in a ‘batch mode,’ etc. Portions of processing can be performed at different times and at different locations, by different (or the same) processing systems.

Reference throughout this specification to ‘one embodiment’, ‘an embodiment’, ‘a preferred embodiment’ or ‘a specific embodiment’ means that a particular feature, structure, or characteristic described in connection with the embodiment is included in at least one embodiment of the present invention and not necessarily in all embodiments. Thus, respective appearances of the phrases ‘in one embodiment’, ‘in an embodiment’, or ‘in a specific embodiment’ in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Embodiments of the invention may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of the present invention can be achieved by any means as is known in the art. Distributed, or networked systems, components and circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term ‘or’ as used herein is generally intended to mean ‘and/or’ unless otherwise indicated. Combinations of components or steps will also be considered as being noted, where terminology is foreseen as rendering the ability to separate or combine is unclear.

As used in the description herein and throughout the claims that follow, ‘a’, ‘an’, and ‘the’ includes plural references unless the context clearly dictates otherwise. Also, as used in the description herein and throughout the claims that follow, the meaning of ‘in’ includes ‘in’ and ‘on’ unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

Thus, the scope of the invention is to be determined solely by the appended claims.

1. An apparatus, comprising:
an optical transport for receiving an electromagnetic wave having a first property, said transport having a waveguiding region and one or more guiding regions coupled to said waveguiding region; and
a transport influencer, operatively coupled to said optical transport and having at least a portion integrated with one or more guiding regions of said one or more guiding regions, for affecting a second property of said transport, wherein said second property influences said first property of said wave.

2. A method, comprising:
receiving an electromagnetic wave having a first property at an optical transport, said transport having a waveguiding region and one or more guiding regions coupled to said waveguiding region; and
affecting a second property of said transport using a transport influencer coupled to said optical transport and having at least a portion integrated with one or more guiding regions of said one or more guiding regions, wherein said second property influences said first property of said wave.

3. A radiation wave intensity modulator, comprising:
a first element for producing a wave component from a radiation wave, said wave component having a polarization property wherein said polarization property is one polarization from a set of orthogonal polarizations;
an optical transport for receiving said wave component, said transport having a waveguiding region and one or more guiding regions coupled to said waveguiding region;
a transport influencer, operatively coupled to said optical transport and having at least a portion integrated with one or more guiding regions of said one or more guiding regions, for affecting said polarization property of said wave component responsive to a control signal; and
a second element for interacting with said affected wave component wherein an intensity of said wave component is varied responsive to said control signal.

4. A radiation wave intensity modulating method, the method comprising:
producing a wave component from a radiation wave, said wave component having a polarization property wherein said polarization property is one polarization from a set of orthogonal polarizations;
receiving said wave component by a transport having a waveguiding region and one or more guiding regions coupled to said waveguiding region;
affecting said polarization property of said wave component responsive to a control signal using an influencer having at least a portion integrated with one or more guiding regions of said one or more guiding regions; and
interacting with said affected wave component wherein an intensity of said wave component is varied responsive to said control signal.

5. A display assembly, comprising:
a plurality of radiation wave modulators, each modulator including:
a first element for producing a wave component from a radiation wave, said wave component having a polarization property wherein said polarization property is one of a set of orthogonal polarizations;
an optical transport for receiving said wave component;
a transport influencer, operatively coupled to said optical transport, for affecting said polarization property of said wave component responsive to a control signal; and
a second element for interacting with said affected wave component wherein an intensity of said wave component is varied responsive to said control signal;
a radiation source for producing said radiation wave for each said modulator; and
a controller, coupled to said modulators, for selectively asserting each said control signal to independently control said intensity of each said modulator.

6. A display method, the method comprising:
producing a radiation wave for each of a plurality of modulators, each modulator including:
a first element for producing a wave component from said radiation wave, said wave component having a polarization property wherein said polarization property is one of a set of orthogonal polarizations;
an optical transport for receiving said wave component;
a transport influencer, operatively coupled to said optical transport, for affecting said polarization property of said wave component responsive to a control signal; and
a second element for interacting with said affected wave component wherein an intensity of said wave component is varied responsive to said control signal; and
asserting selectively each said control signal to independently control said intensity of each said modulator.

7. A transport, comprising:
a waveguide including a guiding region and one or more bounding regions for enhancing containment of transmitted radiation within said guiding region; and
a plurality of constituents disposed in said waveguide for enhancing an influencer response attribute of said waveguide.

8. A transport manufacturing method, the method comprising:
(a) forming a waveguide having a guiding region and one or more bounding regions for enhancing containment of transmitted radiation within said guiding region; and
(b) disposing a plurality of constituents in said waveguide for enhancing an influencer response attribute of said waveguide.

9. A radiation switching array, comprising:
a first radiation wave modulator and a second radiation wave modulator proximate said first modulator, each said modulator including:
a transport for receiving a wave component, said transport including a waveguide having a guiding region and one or more bounding regions; and a plurality of constituents disposed in said waveguide for enhancing an influencer response in said waveguide; and
an influencer, operatively coupled to said transport and responsive to a control signal, for affecting a radiation-amplitude-controlling property of said wave component by inducing said influencer response in said waveguide as said wave component travels through said transport; and
a controller, coupled to said modulators, for selectively asserting each said control signal to independently control said amplitude-controlling property of each said modulator.

10. A switching method, the method comprising:
(a) receiving a wave component at each of a plurality of transports proximate each other, each transport including a waveguide having a guiding region and one or more bounding regions with a plurality of constituents disposed in said waveguide for enhancing an influencer response in said waveguide; and
(b) affecting independently a radiation-amplitude-controlling property of each said wave component as it travels through each said waveguide.

11. A waveguide, comprising:
a waveguide including a channel region defining a waveguide axis and one or more bounding regions; and
a plurality of magnetic constituents disposed in at least one of said regions for producing a magnetic field substantially perpendicular to said waveguide axis.

12. A method for operating a waveguide to transmit a radiation signal, the method comprising:
(a)transmitting the radiation signal through the waveguide, the waveguide including a channel region defining a waveguide axis and one or more bounding regions; and
(b) producing a magnetic field substantially perpendicular to said waveguide axis using a plurality of magnetic constituents disposed in at least one of said regions.

13. A waveguide, comprising:
a waveguide including a channel region defining a transmission axis and one or more bounding regions; and
a plurality of magnetic constituents disposed in at least one of said regions for producing a holding magnetic field substantially parallel to said transmission axis.

14. A method for operating a waveguide, the method comprising:
(a)propagating a radiation signal through the waveguide generally along a transmission axis, the waveguide including a channel region defining said transmission axis and one or more bounding regions; and
(b) inducing a holding magnetic field substantially perpendicular to said transmission axis using a plurality of magnetic constituents disposed in at least one of said regions wherein said holding magnetic field influences a polarization rotational change of said propagating radiation signal.

15. A multicolor picture element for a display, comprising:
a number N of radiation sources for producing N number of input wave components, at least one input wave component for each primary color in a color model;
a number M of modulators proximate one another, where M is greater than or equal to N, each said modulator including:
a transport for receiving one of said input wave components, said transport including a waveguide having a guiding region and one or more bounding regions; and a plurality of constituents disposed in said waveguide for enhancing an influencer response in said waveguide; and
a transport influencer, operatively coupled to said transport and responsive to a control signal, for affecting a radiation-amplitude-controlling property of said input wave component by inducing said influencer response in said waveguide as said input wave component travels through said transport;
a controller, coupled to said modulators, for selectively asserting each said control signal to independently control said amplitude-controlling property of each said modulator; and
an amplitude-modulating system, coupled to said modulators, for producing an output wave component from each said input wave component, said output wave component having an amplitude varying responsive to an interaction of said amplitude-controlling-property and said amplitude modulating system.

16. A method, the method comprising:
a) producing an N number of input wave components, at least one input wave component for each primary color in a color model; and
b) producing a plurality of output wave components from said input wave components, each said output wave component provided from a number M of modulators proximate one another, where M is greater than or equal to N, each said modulator including:
a transport for receiving one of said input wave components, said transport including a waveguide having a guiding region and one or more bounding regions; and a plurality of constituents disposed in said waveguide for enhancing an influencer response in said waveguide; and
a transport influencer, operatively coupled to said transport and responsive to a control signal, for affecting a radiation-amplitude-controlling property of said input wave component by inducing said influencer response in said waveguide as said input wave component travels through said transport.

17. An influencer structure, comprising:
a conductive element disposed in one or more radiation-propagating dielectric structures of a waveguide having a guiding region and one or more bounding regions, said conductive element responsive to an influencer signal to influence an amplitude-controlling property of said waveguide; and
a coupling system for communicating said influencer signal to said conductive element.

18. A method of operating a waveguide, the method comprising:
a) communicating an influencer signal to a conductive element disposed in one or more radiation-propagating dielectric structures of a waveguide having a guiding region and one or more bounding regions; and
b) influencing, responsive to said influencer signal, an amplitude-controlling property of said waveguide.

19. A transport, comprising:
a waveguide including a guiding region and one or more bounding regions for enhancing containment of transmitted radiation within said guiding region, said waveguide including an input region and an output;
a plurality of constituents disposed in said waveguide for enhancing an influencer response attribute of said waveguide; and
a polarization system coupled to said input region, said input polarizer system producing a wave component having a supported polarization disposed at a predetermined angular orientation at said input from an input radiation source including a set of source wave components each having one of a set orthogonal polarizations wherein said input polarizing system operates on said source wave components to pass source wave components having polarizations matching said supported polarization.

20. A transport manufacturing method, the method comprising:
a) forming a waveguide having a guiding region and one or more bounding regions for enhancing containment of transmitted radiation within said guiding region, said waveguide including an input region and an output;
b) disposing a plurality of constituents in said waveguide for enhancing an influencer response attribute of said waveguide; and
c) coupling a polarization system to said input region, said input polarizer system producing a wave component having a supported polarization disposed at a predetermined angular orientation at said input from an input radiation source including a set of source wave components each having one of a set orthogonal polarizations wherein said input polarizing system operates on said source wave components to pass source wave components having polarizations matching said supported polarization.

21. A transport, comprising:
a waveguide including a guiding region and one or more bounding regions for enhancing containment of transmitted radiation within said guiding region, said waveguide including an input region and an output; and
a plurality of constituents disposed in said waveguide for enhancing an influencer response attribute of said waveguide,
wherein said output is configured to enhance a viewing angle of emitted radiation.

22. A transport manufacturing method, the method comprising:
a) forming a waveguide having a guiding region and one or more bounding regions for enhancing containment of transmitted radiation within said guiding region, said waveguide including an input region and an output;
b) disposing a plurality of constituents in said waveguide for enhancing an influencer response attribute of said waveguide; and
c) altering said output to enhance a viewing angle of emitted radiation.

23. A faceplate for an optical system including a plurality of waveguided radiation channels, comprising:
a plurality of waveguide channels, at least one for each channel of the plurality of waveguided radiation channels; and
a support, coupled to each of said waveguide channels, for arranging each said waveguide channel in optical communication with one or more of the channels of the plurality of waveguided radiation channels.

24. A faceplate manufacturing method, the method comprising:
a) aggregating a plurality of waveguide channels, at least one for each channel of a plurality of waveguided radiation channels of an optical system; and
b) arranging each said waveguide channel in optical communication with one or more of said channels of said plurality of waveguided radiation channels.

25. An apparatus, comprising:
a waveguide having an outer surface layer, said waveguide including a structure underlying said outer surface layer and a waveguide portion proximate said structure, said waveguide portion including a contact region; and
an element disposed within said contact region and functionally communicated to said structure.

26. A manufacturing method, the method comprising:
a) locating a contact region relative to a waveguide portion of a waveguide, said waveguide having an outer surface layer and including a structure underlying said outer surface layer wherein said waveguide portion is proximate said structure;
b) disposing an element within said contact region; and
c) communicating said element to said structure.

27. A transport, comprising:
a waveguide including a guiding region and one or more bounding regions for enhancing containment of transmitted radiation within said guiding region, said waveguide including an input region and an output;
a plurality of constituents disposed in said waveguide for enhancing an influencer response attribute of said waveguide; and
an excitation system coupled to said guiding region, said excitation system increasing said influencer response attribute of said waveguide.

28. A transport manufacturing method, the method comprising:
a) forming a waveguide having a guiding region and one or more bounding regions for enhancing containment of transmitted radiation within said guiding region, said waveguide including an input region and an output;
b) disposing a plurality of constituents in said waveguide for enhancing an influencer response attribute of said waveguide; and
c) coupling an excitation system to said guiding region, said excitation system increasing said influencer response attribute of said waveguide.

29. A componentized display system, comprising:
an illumination module for generating a plurality of input wave_components;
a modulating system for receiving said input wave_components and producing a plurality of output wave_components collectively defining successive image sets; and
a first communicating system including one or more waveguiding channels propagating said input wave_components from said illumination module to said modulating system.

30. A display manufacturing method, the method comprising:
a) assembling an illumination module for generating a plurality of input wave_components;
b) assembling, discrete from said illumination module, a modulating system for receiving said input wave_components and producing a plurality of output wave_components collectively defining successive image sets; and
c) coupling said illumination module to said modulating system using a first communicating system including one or more waveguiding channels propagating said input wave_components from said illumination module to said modulating system.

31. A unitary display system, comprising:
an illumination system for generating a plurality of input wave_components in a first plurality of waveguide channels; and
a modulating system, integrated with said illumination system, for receiving said plurality of input wave_components in a second plurality of waveguide channels and producing a plurality of output wave_components collectively defining successive image sets.

32. A display manufacturing method, the method comprising:
a) forming an illumination system for generating a plurality of input wave_components in a first plurality of waveguide channels; and
b) forming a modulating system, integrated with said illumination system, for receiving said plurality of input wave_components in a second plurality of waveguide channels and producing a plurality of output wave_components collectively defining successive image sets.

33. A method of operating a switching matrix including a plurality of arranged waveguides each having an associated influencer structure for independently influencing an amplitude-effecting attribute of radiation propagating through a corresponding waveguide wherein the attribute includes a first mode for an “OFF” propagation mode with an exit amplitude substantially extinguished level and a second mode for an “ON” propagation mode with the exit amplitude at a substantially fully illuminated level, the method comprising:
a) establishing an “OFF” characteristic for the amplitude-effecting attribute to set the first mode;
b) setting an “ON” characteristic for the amplitude-effecting attribute that does not match said second mode and establishes an intermediate propagation mode between the OFF propagation mode and the ON propagation mode; and
c) adjusting a second attribute of radiation propagating through the waveguide so that the exit amplitude in said intermediate propagation mode substantially equals the fully illuminated level.

34. A method of operating a switching matrix including a plurality of arranged waveguides each having an associated influencer structure for independently influencing an amplitude-effecting attribute of radiation propagating through a corresponding waveguide wherein the attribute includes a first mode for an “OFF” propagation mode with an exit amplitude substantially extinguished level and a second mode for an “ON” propagation mode with the exit amplitude at a substantially fully illuminated level, the method comprising:
a) establishing an “OFF” characteristic for the amplitude-effecting attribute to set the first mode;
b) setting an “ON” characteristic for the amplitude-effecting attribute to set the second mode; and
c) adjusting the amplitude-effecting attribute of each waveguide between the OFF characteristic and the ON characteristic using a relative adjustment of each waveguide attribute from one video frame to a succeeding video frame.

35. A transport, comprising:
a waveguide including a guiding region and one or more bounding regions for enhancing containment of transmitted radiation within said guiding region, a portion of said waveguide defining a plurality of voids; and
a gas disposed in said plurality of voids to enhance an influencer response attribute of said waveguide.

36. A transport manufacturing method, the method comprising:
a) forming a waveguide having a guiding region and one or more bounding regions for enhancing containment of transmitted radiation within said guiding region, a portion of said waveguide defining a plurality of voids; and
b) disposing a gas in said plurality of voids to enhance an influencer response attribute of said waveguide.

37. An apparatus, comprising:
a first waveguiding channel having a guiding region and one or more bounding regions coupled to said guiding region, said first waveguiding channel including a first lateral guiding port in a portion of said bounding regions, said lateral guiding port responsive to an attribute of radiation propagating in said channel to selectively pass a portion of said radiation therethrough; and
an influencer, coupled to said first waveguiding channel, for controlling said attribute of said radiation.

38. A manufacturing method, the method comprising:
a) forming a first waveguiding channel having a guiding region and one or more bounding regions coupled to said guiding region, said first waveguiding channel including a first lateral guiding port in a portion of said bounding regions, said lateral guiding port responsive to an attribute of radiation propagating in said channel to selectively pass a portion of said radiation therethrough; and
b) disposing an influencer proximate to said first waveguiding channel for controlling said attribute of said radiation responsive to a control signal.

39. An apparatus, comprising:
a semiconductor substrate, said substrate supporting:
a plurality of integrated waveguide structures, each waveguide structure including a guiding channel and one or more bounding regions for propagating a radiation signal from an input to an output; and
an influencer system, responsive to a control and coupled to said waveguide structures for independently controlling an amplitude of said radiation signal at said output.

40. A manufacturing method, the method comprising:
a) disposing a plurality of waveguide structures into a substrate, each waveguide structure including a guiding channel and one or more bounding regions for propagating a radiation signal from an input to an output;
b) proximating an influencer system, responsive to a control, to said waveguide structures for independently controlling an amplitude of said radiation signal at said output; and
c) arranging said outputs of said plurality of waveguide structures into a presentation matrix.

41. An apparatus, comprising:
a semiconductor substrate including a waveguide having a guiding region and one or more bounding regions coupled to said guiding region;
a first PN junction disposed in said substrate and coupled to one or more of said one or more bounding regions; and
dopant atoms disposed within said semiconductor substrate at said PN junction.

42. A memory device, comprising:
a waveguide having a guiding region for propagating a radiation signal;
an influencer, coupled to said waveguide, for controlling a characteristic of said radiation signal propagating in said waveguide between a first mode and a second mode; and
a latching layer, coupled to said guiding region and responsive to said influencer, for retaining said characteristic of said radiation signal for a memory cycle.

43. A manufacturing method, the method comprising:
a) forming a semiconductor substrate including a waveguide having a guiding region and one or more bounding regions coupled to said guiding region;
b) disposing a first PN junction in said substrate and coupled to one or more of said one or more bounding regions; and
c) disposing dopant atoms within said semiconductor substrate at said PN junction.

44. An apparatus, comprising:
a plurality of waveguides disposed within a woven structure; and
an influencer system, coupled to said plurality of waveguides, for independently influencing a characteristic of radiation propagating through one or more of said plurality of waveguides.

45. A switching matrix, comprising:
a plurality of waveguides having generally parallel transmission axes, each waveguide including an integrated influencer responsive to a control signal applied to a first contact and a second contact of said influencer;
a conductive X addressing filament woven among said waveguides and electrically communicated to said first contacts; and
a conductive Y addressing filament disposed among said waveguides and electrically communicated to said second contacts wherein said addressing filaments provide an addressing grid to independently control any of said influencers.

46. A manufacturing method, the method comprising:
a) weaving a plurality of waveguides having integrated influencer elements and a plurality of conductive filaments to produce a textile fabric wherein said filaments produce an addressing grid coupled to each influencer; and
b) producing a planar matte from said fabric wherein said waveguides each have an output contributing to a collective presentation matrix established by an arrangement of said waveguides in said fabric.

47. An electronic goggle apparatus, comprising:
one or more semiconductor substrate, each said substrate supporting:
a plurality of integrated waveguide structures, each waveguide structure including a guiding channel and one or more bounding regions for propagating a radiation signal from an input to an output; and
an influencer system, responsive to a control and coupled to said waveguide structures for independently controlling an amplitude of each said radiation signal at said output;
a display system for arranging said outputs of said plurality of waveguide structures into a presentation matrix; and
a head-mounted eyewear structure for positioning said presentation matrix in a field-of-view of a user.

48. A manufacturing method, the method comprising:
a) disposing a plurality of waveguide structures into one or more substrates, each waveguide structure including a guiding channel and one or more bounding regions for propagating a radiation signal from an input to an output;
b) proximating an influencer system, responsive to a control, to said waveguide structures for independently controlling an amplitude of said radiation signal at said output;
c) arranging said outputs of said plurality of waveguide structures into a presentation matrix; and
d) positioning said presentation matrix in a field-of-view of a user.

49. A transport, comprising:
a semiconductor substrate, said substrate supporting:
an integrated waveguide structure, said waveguide structure including a guiding channel and one or more bounding regions for propagating a radiation signal from an input to an output; and
an influencer system, responsive to a control and coupled to said waveguide structure for independently controlling an amplitude-influencing attribute of said radiation signal within an influencing zone; and
a recursion system for periodically returning said radiation signal into said influencing zone for periodically influencing said amplitude influencing attribute of said radiation signal.

50. A manufacturing method, the method comprising:
a) disposing a waveguide structure into a substrate, said waveguide structure including a guiding channel and one or more bounding regions for propagating a radiation signal from an input to an output;
b) proximating an influencer system, responsive to a control, to said waveguide structure for independently controlling an amplitude influencing attribute of said radiation signal within an influencing zone; and
c) arranging a pathway of said waveguide structure to recurse said radiation signal through said influencing zone for periodically influencing said amplitude influencing attribute of said radiation signal.
